(19) United States
(12) Patent Application Publication
(10) Pub. No.: US 2021/0006824 A1
(43) Pub. Date: Jan. 7, 2021

(54) ENCODING AND DECODING METHOD FOR MOTION INFORMATION, AND ENCODING AND DECODING DEVICE FOR MOTION INFORMATION

(71) Applicant: SAMSUNG ELECTRONICS CO., LTD., Suwon-si (KR)

(72) Inventors: Seungsoo JEONG, Suwon-si (KR); Minwoo PARK, Suwon-si (KR)

(73) Assignee: SAMSUNG ELECTRONICS CO., LTD., Suwon-si (KR)

(21) Appl. No.: 16/960,588

(22) PCT Filed: Jan. 7, 2019
(86) PCT No.: PCT/KR2019/000196

§ 371 Date: Jul. 8, 2020

Related U.S. Application Data
(60) Provisional application No. 62/614,981, filed on Jan. 8, 2018.

(51) Int. Cl. H04N 19/567; H04N 19/105; H04N 19/139; H04N 19/184; H04N 19/176

(52) U.S. Cl. CPC H04N 19/567; H04N 19/105; H04N 19/176; H04N 19/184; H04N 19/139

(57) ABSTRACT

Provided is a method of decoding motion information, the method including: determining a first group of motion vector candidates by using at least one motion vector among a spatial neighboring block and a temporal neighboring block related to a current block; determining a second group of base motion vector candidates according to a result of template matching or bilateral matching based on each of the motion vector candidates included in the first group; selecting a base motion vector corresponding to the current block from the second group; and determining a motion vector of the current block by changing the base motion vector according to a variation distance and a variation direction.

### TECHNICAL FIELD

The present disclosure relates to encoding and decoding fields of an image. In particular, the present disclosure relates to a method and apparatus for encoding motion information and a method and apparatus for decoding the motion information used to encode and decode an image.

### BACKGROUND ART

In encoding and decoding of an image, one picture may be split into blocks, and each of the blocks may be prediction-encoded via inter prediction or intra prediction.

Inter prediction refers to a method of compressing an image by removing temporal redundancy between pictures, a representative example of which is motion estimation encoding. In the motion estimation encoding, blocks of a current picture are predicted by using at least one reference picture. A reference block most similar to a current block may be searched for in a certain search range by using a certain evaluation function. The current block is predicted based on the reference block, and a residual block is generated by subtracting a prediction block generated as a result of the prediction from the current block and then encoded. Here, to further accurately perform the prediction, interpolation is performed on a search range of reference pictures so as to generate pixels of sub pel units smaller than integer pel units and inter prediction may be performed based on the generated pixels of sub pel units.

In the codec such as H.264 advanced video coding (AVC) and high efficiency video coding (HEVC), a motion vector of pre-encoded blocks adjacent to a current block or blocks included in a pre-encoded picture is used as a prediction motion vector of the current block so as to predict a motion vector of the current block. A differential motion vector that is a difference between the motion vector of the current block and the prediction motion vector is signaled to a decoder via a certain method.

### DESCRIPTION OF EMBODIMENTS

### Technical Problem

Technical problems of methods of encoding and decoding motion information, and apparatuses for encoding and decoding motion information, according to an embodiment are to represent motion information with a small number of bits.

Also, technical problems of methods of encoding and decoding motion information, and apparatuses for encoding and decoding motion information, according to an embodiment are to signal further accurate motion information with a small number of bits.

### Solution to Problem

A method of decoding motion information, according to an embodiment of the present disclosure, includes: determining a first group of motion vector candidates by using at least one motion vector among a spatial neighboring block and a temporal neighboring block related to a current block; determining a second group of base motion vector candidates according to a result of template matching or bilateral matching based on each of the motion vector candidates included in the first group; selecting a base motion vector corresponding to the current block from the second group; and determining a motion vector of the current block by changing the base motion vector according to a variation distance and a variation direction.

### Advantageous Effects of Disclosure

Methods of encoding and decoding motion information, and apparatuses for encoding and decoding motion information, according to an embodiment can represent motion information with a small number of bits.

Also, methods of encoding and decoding motion information, and apparatuses for encoding and decoding motion information, according to an embodiment can signal a further accurate motion vector with a small number of bits.

However, effects achievable by methods of encoding and decoding motion information and apparatuses for encoding and decoding motion information are not limited to those mentioned above, and other effects that not mentioned could be clearly understood by one of ordinary skill in the art from the following description.

### BRIEF DESCRIPTION OF DRAWINGS

A brief description of each drawing is provided to better understand the drawings cited herein.

FIG. 1 is a block diagram of an image decoding apparatus according to an embodiment.

FIG. 2 is a block diagram of an image encoding apparatus according to an embodiment.

FIG. 3 illustrates a process, performed by an image decoding apparatus, of determining at least one coding unit by splitting a current coding unit, according to an embodiment.

FIG. 4 illustrates a process, performed by an image decoding apparatus, of determining at least one coding unit by splitting a non-square coding unit, according to an embodiment.

FIG. 5 illustrates a process, performed by an image decoding apparatus, of splitting a coding unit based on at least one of block shape information and split shape mode information, according to an embodiment.

FIG. 6 illustrates a method, performed by an image decoding apparatus, of determining a predetermined coding unit from among an odd number of coding units, according to an embodiment.

FIG. 7 illustrates an order of processing a plurality of coding units when an image decoding apparatus determines the plurality of coding units by splitting a current coding unit, according to an embodiment.

FIG. 8 illustrates a process, performed by an image decoding apparatus, of determining that a current coding unit is to be split into an odd number of coding units, when the coding units are not processable in a predetermined order, according to an embodiment.

FIG. 9 illustrates a process, performed by an image decoding apparatus, of determining at least one coding unit by splitting a first coding unit, according to an embodiment.

FIG. 10 illustrates that a shape into which a second coding unit is splittable is restricted when the second coding unit having a non-square shape, which is determined as an image decoding apparatus splits a first coding unit, satisfies a predetermined condition, according to an embodiment.

FIG. 11 illustrates a process, performed by an image decoding apparatus, of splitting a square coding unit when split shape mode information is unable to indicate that the square coding unit is split into four square coding units, according to an embodiment.

FIG. 12 illustrates that a processing order between a plurality of coding units may be changed depending on a process of splitting a coding unit, according to an embodiment.

FIG. 13 illustrates a process of determining a depth of a coding unit as a shape and size of the coding unit change, when the coding unit is recursively split such that a plurality of coding units are determined, according to an embodiment.

FIG. 14 illustrates depths that are determinable based on shapes and sizes of coding units, and part indexes (PIDs) that are for distinguishing the coding units, according to an embodiment.

FIG. 15 illustrates that a plurality of coding units are determined based on a plurality of predetermined data units included in a picture, according to an embodiment.

FIG. 16 illustrates a processing block serving as a criterion for determining a determination order of reference coding units included in a picture, according to an embodiment.

FIG. 17 illustrates coding units that may be determined for each picture when a combination of shapes into which a coding unit is splittable is different for each picture, according to an embodiment.

FIG. 18 illustrates various shapes of a coding unit that may be determined based on split shape mode information representable in a binary code, according to an embodiment.

FIG. 19 illustrates other shapes of a coding unit that may be determined based on split shape mode information representable in a binary code, according to an embodiment.

FIG. 20 is a block diagram of an image encoding and decoding system.

FIG. 21 is a block diagram of an image decoding apparatus according to an embodiment.

FIG. 22 is a diagram for describing a spatial neighboring block and a temporal neighboring block related to a current block.

FIG. 23 is a diagram for describing template matching according to an embodiment.

FIG. 24 is a diagram for describing bilateral matching according to an embodiment.

FIG. 25 is a diagram showing a plurality of variation distance candidates and a plurality of variation direction candidates, according to an embodiment.

FIG. 26 is a diagram showing points corresponding to the plurality of variation distance candidates and the plurality of variation direction candidates of FIG. 25.

FIG. 27 is a diagram showing a plurality of variation distance candidates and a plurality of variation direction candidates, according to another embodiment.

FIG. 28 is a diagram showing points corresponding to the plurality of variation distance candidates and the plurality of variation direction candidates of FIG. 27.

FIGS. 29 and 30 are diagrams showing points corresponding to a plurality of variation distance candidates and a plurality of variation direction candidates, according to other embodiments.

FIG. 31 is a diagram showing a plurality of variation distance candidates and a plurality of variation direction candidates, according to another embodiment.

FIG. 32 is a diagram showing points corresponding to the plurality of variation distance candidates and the plurality of variation direction candidates of FIG. 31.

FIGS. 33 and 34 are diagrams showing location relationships between a current picture and two reference pictures.

FIG. 35 illustrates a process by which an image decoding apparatus parses a bitstream, according to an embodiment.

FIG. 36 is a flowchart of an image decoding method according to an embodiment.

FIG. 37 is a block diagram of an image encoding apparatus according to an embodiment.

FIG. 38 is a flowchart of an image encoding method according to an embodiment.

### BEST MODE

A method of decoding motion information, according to an embodiment of the present disclosure, includes: determining a first group of motion vector candidates by using at least one motion vector among a spatial neighboring block and a temporal neighboring block related to a current block; determining a second group of base motion vector candidates according to a result of template matching or bilateral matching based on each of the motion vector candidates included in the first group; selecting a base motion vector corresponding to the current block from the second group; and determining a motion vector of the current block by changing the base motion vector according to a variation distance and a variation direction.

The determining of the second group may include: calculating a distortion value of each of the motion vector candidates included in the first group, according to the result of template matching or bilateral matching; and determining the second group including at least some of motion vector candidates selected based on the calculated distortion value among the motion vector candidates included in the first group.

The determining of the second group may include determining the second group of the base motion vector candidates by changing each of the motion vector candidates included in the first group, according to the result of template matching or bilateral matching.

The decoding method may further include, when a difference between a first base motion vector candidate and a second base motion vector candidate among the base motion vector candidates included in the second group is equal to or smaller than a pre-set value, excluding the second base motion vector candidate from the second group.

The decoding method may further include: changing the motion vector of the current block according to a result of template matching or bilateral matching; and reconstructing the current block based on the changed motion vector of the current block.

The decoding method may further include: obtaining information indicating the variation distance and variation direction from a bitstream, and determining the variation distance and variation direction for changing the base motion vector, based on the obtained information.

The determining of the variation distance and variation direction may include determining a variation distance candidate and a variation direction candidate corresponding to the obtained information among a plurality of variation distance candidates and a plurality of variation direction candidates as the variation distance and the variation direction for changing the base motion vector.

The plurality of variation distance candidates and the plurality of variation direction candidates corresponding to the current block may be determined differently from a plurality of variation distance candidates and a plurality of variation direction candidates corresponding to a previous block.

Variation distances of at least one variation distance candidate in an x-axis direction and y-axis direction among the plurality of variation distance candidates may be different from each other.

Among the plurality of variation distance candidates, an interval between a variation distance of a first variation distance candidate in an x-axis direction and a variation distance of a second variation distance candidate in an x-axis direction and an interval between a variation distance of the first variation distance candidate in a y-axis direction and a variation distance of the second variation distance candidate in a y-axis direction may be different from each other.

The determining of the variation distance and variation direction may include: determining whether to change the motion vector of the current block; when it is determined to change the motion vector of the current block, excluding at least some of variation distance candidates among the plurality of variation distance candidates; and determining a variation distance candidate and a variation direction candidate corresponding to the obtained information among remaining variation distance candidates as the variation distance and the variation direction for changing the base motion vector.

The determining of the motion vector of the current block may include: obtaining information about a prediction direction of the current block; when the prediction direction indicates bi-direction, changing one of a base motion vector in a first uni-direction and a base motion vector in a second uni-direction according to the variation distance and the variation direction; and determining the motion vector of the current block, based on a base motion vector changed according to the variation distance and variation direction, and a base motion vector not changed according to the variation distance and variation direction.

The decoding method may further include, when the base motion vector of the current block is the base motion vector in the first uni-direction, determining the base motion vector in the second uni-direction based on the base motion vector of the first uni-direction.

An apparatus for decoding motion information, according to an embodiment of the present disclosure, includes a motion information decoder configured to: determine a first group of motion vector candidates by using at least one motion vector among a spatial neighboring block and a temporal neighboring block related to a current block; determine a second group of base motion vector candidates according to a result of template matching or bilateral matching based on each of the motion vector candidates included in the first group; select a base motion vector corresponding to the current block from the second group; and determine a motion vector of the current block by changing the base motion vector according to a variation distance and a variation direction.

A method of encoding motion information, according to an embodiment of the disclosure, includes: determining a first group of motion vector candidates by using at least one motion vector among a spatial neighboring block and a temporal neighboring block related to a current block; determining a second group of base motion vector candidates according to a result of template matching or bilateral matching based on each of the motion vector candidates included in the first group; selecting a base motion vector corresponding to the current block from the second group; and generating a bitstream including information indicating the selected base motion vector and information indicating a variation distance and a variation direction for changing the base motion vector.

### MODE OF DISCLOSURE

As the disclosure allows for various changes and numerous examples, particular embodiments will be illustrated in the drawings and described in detail in the written description. However, this is not intended to limit the disclosure to particular modes of practice, and it will be understood that all changes, equivalents, and substitutes that do not depart from the spirit and technical scope of the disclosure are encompassed in the disclosure.

In the description of embodiments, certain detailed explanations of related art are omitted when it is deemed that they may unnecessarily obscure the essence of the disclosure. Also, numbers (for example, a first, a second, and the like) used in the description of the specification are merely identifier codes for distinguishing one element from another.

Also, in the present specification, it will be understood that when elements are “connected” or “coupled” to each other, the elements may be directly connected or coupled to each other, but may alternatively be connected or coupled to each other with an intervening element therebetween, unless specified otherwise.

In the present specification, regarding an element represented as a “unit” or a “module”, two or more elements may be combined into one element or one element may be divided into two or more elements according to subdivided functions. In addition, each element described hereinafter may additionally perform some or all of functions performed by another element, in addition to main functions of itself, and some of the main functions of each element may be performed entirely by another component.

Also, in the present specification, an ‘image’ or a ‘picture’ may denote a still image of a video or a moving image, i.e., the video itself.

Also, in the present specification, a ‘sample’ denotes data assigned to a sampling position of an image, i.e., data to be processed. For example, pixel values of an image in a spatial domain and transform coefficients on a transform region may be samples. A unit including at least one such sample may be defined as a block.

Also, in the present specification, a ‘current block’ may denote a block of a largest coding unit, coding unit, prediction unit, or transform unit of a current image to be encoded or decoded.

In the present specification, a motion vector in a list 0 direction may denote a motion vector used to indicate a block in a reference picture included in a list 0, and a motion vector in a list 1 direction may denote a motion vector used to indicate a block in a reference picture included in a list 1. Also, a motion vector in a uni-direction may denote a motion vector used to indicate a block in a reference picture included in a list 0 or list 1, and a motion vector in a bi-direction may denote that the motion vector includes a motion vector in a list 0 direction and a motion vector in a list 1 direction.

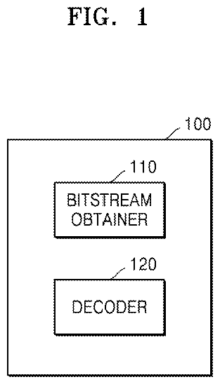

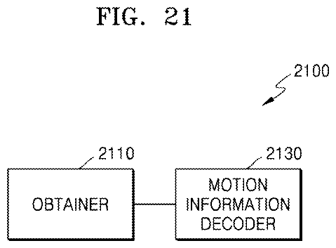

Hereinafter, an image encoding method and apparatus, and an image decoding method and apparatus based on coding units and transform units of a tree structure, according to an embodiment will be described with reference to FIGS. 1 through 20. An image encoding apparatus 200 and an image decoding apparatus 100, which will be described with reference to FIGS. 1 through 20, may respectively include an image encoding apparatus 3700 and an image decoding apparatus 2100, which will be described with reference to FIGS. 21 through 38.

FIG. 1 is a detailed block diagram of an image decoding apparatus 100 according to an embodiment.

The image decoding apparatus 100 may include a bitstream obtainer 110 and a decoder 120. The bitstream obtainer 110 and the decoder 120 may include at least one processor. Also, the bitstream obtainer 110 and the decoder 120 may include a memory storing instructions to be performed by the at least one processor.

The bitstream obtainer 110 may receive a bitstream. The bitstream includes information of an image encoded by the image encoding apparatus 200 described later. Also, the bitstream may be transmitted from the image encoding apparatus 200. The image encoding apparatus 200 and the image decoding apparatus 100 may be connected by wire or wirelessly, and the bitstream obtainer 110 may receive the bitstream by wire or wirelessly. The bitstream obtainer 110 may receive the bitstream from a storage medium, such as an optical medium or a hard disk. The decoder 120 may reconstruct an image based on information obtained from the received bitstream. The decoder 120 may obtain, from the bitstream, a syntax element for reconstructing the image. The decoder 120 may reconstruct the image based on the syntax element.

Regarding detailed operations of the image decoding apparatus 100, the bitstream obtainer 110 may receive the bitstream.

The image decoding apparatus 100 may perform an operation of obtaining, from the bitstream, a bin string corresponding to a split shape mode of a coding unit. Then, the image decoding apparatus 100 may perform an operation of determining a split rule of the coding unit. Also, the image decoding apparatus 100 may perform an operation of splitting the coding unit into a plurality of coding units, based on at least one of the bin string corresponding to the split shape mode and the split rule. The image decoding apparatus 100 may determine an allowable first range of a size of the coding unit, according to a ratio of the width and the height of the coding unit, so as to determine the split rule. The image decoding apparatus 100 may determine an allowable second range of the size of the coding unit, according to the split shape mode of the coding unit, so as to determine the split rule.

Hereinafter, splitting of a coding unit will be described in detail according to an embodiment of the disclosure.

First, one picture may be split into one or more slices. One slice may be a sequence of one or more largest coding units (coding tree units (CTUs)). There is a largest coding block (coding tree block (CTB)) conceptually compared to a largest coding unit (CTU).

The largest coding unit (CTB) denotes an N×N block including N×N samples (N is an integer). Each color component may be split into one or more largest coding blocks.

When a picture has three sample arrays (sample arrays for Y, Cr, and Cb components), a largest coding unit (CTU) includes a largest coding block of a luma sample, two corresponding largest coding blocks of chroma samples, and syntax structures used to encode the luma sample and the chroma samples. When a picture is a monochrome picture, a largest coding unit includes a largest coding block of a monochrome sample and syntax structures used to encode the monochrome samples. When a picture is a picture encoded in color planes separated according to color components, a largest coding unit includes syntax structures used to encode the picture and samples of the picture.

One largest coding block (CTB) may be split into M×N coding blocks including M×N samples (M and N are integers).

When a picture has sample arrays for Y, Cr, and Cb components, a coding unit (CU) includes a coding block of a luma sample, two corresponding coding blocks of chroma samples, and syntax structures used to encode the luma sample and the chroma samples. When a picture is a monochrome picture, a coding unit includes a coding block of a monochrome sample and syntax structures used to encode the monochrome samples. When a picture is a picture encoded in color planes separated according to color components, a coding unit includes syntax structures used to encode the picture and samples of the picture.

As described above, a largest coding block and a largest coding unit are conceptually distinguished from each other, and a coding block and a coding unit are conceptually distinguished from each other. That is, a (largest) coding unit refers to a data structure including a (largest) coding block including a corresponding sample and a syntax structure corresponding to the (largest) coding block. However, because it is understood by one of ordinary skill in the art that a (largest) coding unit or a (largest) coding block refers to a block of a predetermined size including a predetermined number of samples, a largest coding block and a largest coding unit, or a coding block and a coding unit are mentioned in the following specification without being distinguished unless otherwise described.

An image may be split into largest coding units (CTUs). A size of each largest coding unit may be determined based on information obtained from a bitstream. A shape of each largest coding unit may be a square shape of the same size. However, an embodiment is not limited thereto.

For example, information about a maximum size of a luma coding block may be obtained from a bitstream. For example, the maximum size of the luma coding block indicated by the information about the maximum size of the luma coding block may be one of 4×4, 8×8, 16×16, 32×32, 64×64, 128×128, and 256×256.

For example, information about a luma block size difference and a maximum size of a luma coding block that may be split into two may be obtained from a bitstream. The information about the luma block size difference may refer to a size difference between a luma largest coding unit and a largest luma coding block that may be split into two. Accordingly, when the information about the maximum size of the luma coding block that may be split into two and the information about the luma block size difference obtained from the bitstream are combined with each other, a size of the luma largest coding unit may be determined. A size of a chroma largest coding unit may be determined by using the size of the luma largest coding unit. For example, when a Y:Cb:Cr ratio is 4:2:0 according to a color format, a size of a chroma block may be half a size of a luma block, and a size of a chroma largest coding unit may be half a size of a luma largest coding unit.

According to an embodiment, because information about a maximum size of a luma coding block that is binary splittable is obtained from a bitstream, the maximum size of the luma coding block that is binary splittable may be variably determined. In contrast, a maximum size of a luma coding block that is ternary splittable may be fixed. For example, the maximum size of the luma coding block that is ternary splittable in an I-slice may be 32×32, and the maximum size of the luma coding block that is ternary splittable in a P-slice or a B-slice may be 64×64.

Also, a largest coding unit may be hierarchically split into coding units based on split shape mode information obtained from a bitstream. At least one of information indicating whether quad splitting is performed, information indicating whether multi-splitting is performed, split direction information, and split type information may be obtained as the split shape mode information from the bitstream.

For example, the information indicating whether quad splitting is performed may indicate whether a current coding unit is quad split (QUAD_SPLIT) or not.

When the current coding unit is not quad split, the information indicating whether multi-splitting is performed may indicate whether the current coding unit is no longer split (NO_SPLIT) or binary/ternary split.

When the current coding unit is binary split or ternary split, the split direction information indicates that the current coding unit is split in one of a horizontal direction and a vertical direction.

When the current coding unit is split in the horizontal direction or the vertical direction, the split type information indicates that the current coding unit is binary split or ternary split.

A split mode of the current coding unit may be determined according to the split direction information and the split type information. A split mode when the current coding unit is binary split in the horizontal direction may be determined to be a binary horizontal split mode (SPLIT_BT_HOR), a split mode when the current coding unit is ternary split in the horizontal direction may be determined to be a ternary horizontal split mode (SPLIT_TT_HOR), a split mode when the current coding unit is binary split in the vertical direction may be determined to be a binary vertical split mode (SPLIT_BT_VER), and a split mode when the current coding unit is ternary split in the vertical direction may be determined to be a ternary vertical split mode SPLIT_TT_VER.

The image decoding apparatus 100 may obtain, from the bitstream, the split shape mode information from one bin string. A form of the bitstream received by the image decoding apparatus 100 may include fixed length binary code, unary code, truncated unary code, pre-determined binary code, or the like. The bin string is information in a binary number. The bin string may include at least one bit. The image decoding apparatus 100 may obtain the split shape mode information corresponding to the bin string, based on the split rule. The image decoding apparatus 100 may determine whether to quad-split a coding unit, whether not to split a coding unit, a split direction, and a split type, based on one bin string.

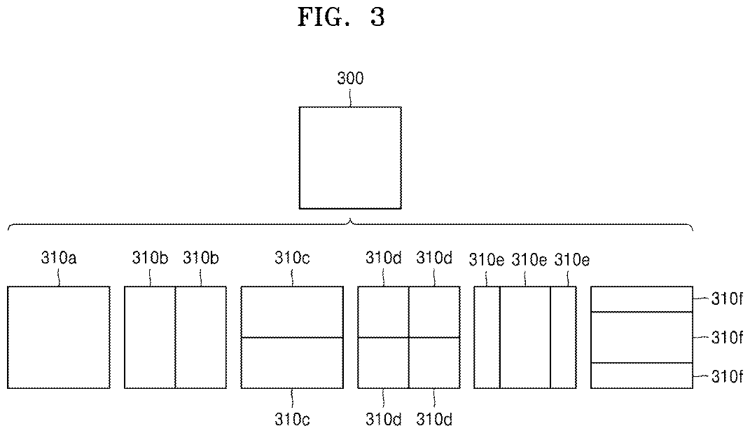

The coding unit may be smaller than or same as the largest coding unit. For example, because a largest coding unit is a coding unit having a maximum size, the largest coding unit is one of coding units. When split shape mode information about a largest coding unit indicates that splitting is not performed, a coding unit determined in the largest coding unit has the same size as that of the largest coding unit. When split shape code information about a largest coding unit indicates that splitting is performed, the largest coding unit may be split into coding units. Also, when split shape mode information about a coding unit indicates that splitting is performed, the coding unit may be split into smaller coding units. However, the splitting of the image is not limited thereto, and the largest coding unit and the coding unit may not be distinguished. The splitting of the coding unit will be described in detail with reference to FIGS. 3 through 16.

Also, one or more prediction blocks for prediction may be determined from a coding unit. The prediction block may be the same as or smaller than the coding unit. Also, one or more transform blocks for transform may be determined from a coding unit. The transform block may be the same as or smaller than the coding unit.

The shapes and sizes of the transform block and prediction block may not be related to each other.

In another embodiment, prediction may be performed by using a coding unit as a prediction unit. Also, transform may be performed by using a coding unit as a transform block.

The splitting of the coding unit will be described in detail with reference to FIGS. 3 through 16. A current block and a neighboring block of the disclosure may indicate one of the largest coding unit, the coding unit, the prediction block, and the transform block. Also, the current block of the current coding unit is a block that is currently being decoded or encoded or a block that is currently being split. The neighboring block may be a block reconstructed before the current block. The neighboring block may be adjacent to the current block spatially or temporally. The neighboring block may be located at one of the lower left, left, upper left, top, upper right, right, lower right of the current block.

FIG. 3 illustrates a process, performed by the image decoding apparatus 100, of determining at least one coding unit by splitting a current coding unit, according to an embodiment.

A block shape may include 4N×4N, 4N×2N, 2N×4N, 4N×N, N×4N, 32N×N, N×32N, 16N×N, N×16N, 8N×N, or N×8N. Here, N may be a positive integer. Block shape information is information indicating at least one of a shape, direction, a ratio of width and height, or size of a coding unit.

The shape of the coding unit may include a square and a non-square. When the lengths of the width and height of the coding unit are the same (i.e., when the block shape of the coding unit is 4N×4N), the image decoding apparatus 100 may determine the block shape information of the coding unit as a square. The image decoding apparatus 100 may determine the shape of the coding unit to be a non-square.

When the width and the height of the coding unit are different from each other (i.e., when the block shape of the coding unit is 4N×2N, 2N×4N, 4N×N, N×4N, 32N×N, N×32N, 16N×N, N×16N, 8N×N, or N×8N), the image decoding apparatus 100 may determine the block shape information of the coding unit as a non-square shape. When the shape of the coding unit is non-square, the image decoding apparatus 100 may determine the ratio of the width and height among the block shape information of the coding unit to be at least one of 1:2, 2:1, 1:4, 4:1, 1:8, 8:1, 1:16, 16:1, 1:32, and 32:1. Also, the image decoding apparatus 100 may determine whether the coding unit is in a horizontal direction or a vertical direction, based on the length of the width and the length of the height of the coding unit. Also, the image decoding apparatus 100 may determine the size of the coding unit, based on at least one of the length of the width, the length of the height, or the area of the coding unit.

According to an embodiment, the image decoding apparatus 100 may determine the shape of the coding unit by using the block shape information, and may determine a splitting method of the coding unit by using the split shape mode information. That is, a coding unit splitting method indicated by the split shape mode information may be determined based on a block shape indicated by the block shape information used by the image decoding apparatus 100.

The image decoding apparatus 100 may obtain the split shape mode information from a bitstream. However, an embodiment is not limited thereto, and the image decoding apparatus 100 and the image encoding apparatus 200 may determine pre-agreed split shape mode information, based on the block shape information. The image decoding apparatus 100 may determine the pre-agreed split shape mode information with respect to a largest coding unit or a smallest coding unit. For example, the image decoding apparatus 100 may determine split shape mode information with respect to the largest coding unit to be a quad split. Also, the image decoding apparatus 100 may determine split shape mode information regarding the smallest coding unit to be “not to perform splitting”. In particular, the image decoding apparatus 100 may determine the size of the largest coding unit to be 256×256. The image decoding apparatus 100 may determine the pre-agreed split shape mode information to be a quad split. The quad split is a split shape mode in which the width and the height of the coding unit are both bisected. The image decoding apparatus 100 may obtain a coding unit of a 128×128 size from the largest coding unit of a 256×256 size, based on the split shape mode information. Also, the image decoding apparatus 100 may determine the size of the smallest coding unit to be 4×4. The image decoding apparatus 100 may obtain split shape mode information indicating “not to perform splitting” with respect to the smallest coding unit.

According to an embodiment, the image decoding apparatus 100 may use the block shape information indicating that the current coding unit has a square shape. For example, the image decoding apparatus 100 may determine whether not to split a square coding unit, whether to vertically split the square coding unit, whether to horizontally split the square coding unit, or whether to split the square coding unit into four coding units, based on the split shape mode information. Referring to FIG. 3, when the block shape information of a current coding unit 300 indicates a square shape, the decoder 120 may determine that a coding unit 310a having the same size as the current coding unit 300 is not split, based on the split shape mode information indicating not to perform splitting, or may determine coding units 310b, 310c, 310d, 310e, or 310f split based on the split shape mode information indicating a predetermined splitting method.

Referring to FIG. 3, according to an embodiment, the image decoding apparatus 100 may determine two coding units 310b obtained by splitting the current coding unit 300 in a vertical direction, based on the split shape mode information indicating to perform splitting in a vertical direction. The image decoding apparatus 100 may determine two coding units 310c obtained by splitting the current coding unit 300 in a horizontal direction, based on the split shape mode information indicating to perform splitting in a horizontal direction. The image decoding apparatus 100 may determine four coding units 310d obtained by splitting the current coding unit 300 in vertical and horizontal directions, based on the split shape mode information indicating to perform splitting in vertical and horizontal directions. According to an embodiment, the image decoding apparatus 100 may determine three coding units 310e obtained by splitting the current coding unit 300 in a vertical direction, based on the split shape mode information indicating to perform ternary-splitting in a vertical direction. The image decoding apparatus 100 may determine three coding units 310f obtained by splitting the current coding unit 300 in a horizontal direction, based on the split shape mode information indicating to perform ternary-splitting in a horizontal direction. However, splitting methods of the square coding unit are not limited to the above-described methods, and the split shape mode information may indicate various methods. Predetermined splitting methods of splitting the square coding unit will be described in detail below in relation to various embodiments.

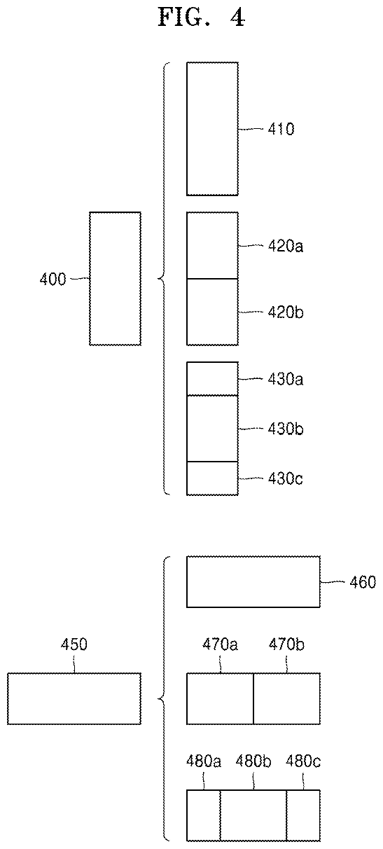

FIG. 4 illustrates a process, performed by the image decoding apparatus 100, of determining at least one coding unit by splitting a non-square coding unit, according to an embodiment.

According to an embodiment, the image decoding apparatus 100 may use block shape information indicating that a current coding unit has a non-square shape. The image decoding apparatus 100 may determine whether not to split the non-square current coding unit or whether to split the non-square current coding unit by using a predetermined splitting method, based on split shape mode information. Referring to FIG. 4, when the block shape information of a current coding unit 400 or 450 indicates a non-square shape, the image decoding apparatus 100 may determine that a coding unit 410 or 460 having the same size as the current coding unit 400 or 450 is not split, based on the split shape mode information indicating not to perform splitting, or determine coding units 420a and 420b, 430a to 430c, 470a and 470b, or 480a to 480c split based on the split shape mode information indicating a predetermined splitting method. Predetermined splitting methods of splitting a non-square coding unit will be described in detail below in relation to various embodiments.

According to an embodiment, the image decoding apparatus 100 may determine a splitting method of a coding unit by using the split shape mode information and, in this case, the split shape mode information may indicate the number of one or more coding units generated by splitting a coding unit. Referring to FIG. 4, when the split shape mode information indicates to split the current coding unit 400 or 450 into two coding units, the image decoding apparatus 100 may determine two coding units 420a and 420b, or 470a and 470b included in the current coding unit 400 or 450, by splitting the current coding unit 400 or 450 based on the split shape mode information.

According to an embodiment, when the image decoding apparatus 100 splits the non-square current coding unit 400 or 450 based on the split shape mode information, the image decoding apparatus 100 may consider the location of a long side of the non-square current coding unit 400 or 450 to split a current coding unit. For example, the image decoding apparatus 100 may determine a plurality of coding units by splitting a long side of the current coding unit 400 or 450, in consideration of the shape of the current coding unit 400 or 450.

According to an embodiment, when the split shape mode information indicates to split (ternary-split) a coding unit into an odd number of blocks, the image decoding apparatus 100 may determine an odd number of coding units included in the current coding unit 400 or 450. For example, when the split shape mode information indicates to split the current coding unit 400 or 450 into three coding units, the image decoding apparatus 100 may split the current coding unit 400 or 450 into three coding units 430a, 430b, and 430c, or 480a, 480b, and 480c.

According to an embodiment, a ratio of the width and height of the current coding unit 400 or 450 may be 4:1 or 1:4. When the ratio of the width and height is 4:1, the block shape information may be a horizontal direction because the length of the width is longer than the length of the height. When the ratio of the width and height is 1:4, the block shape information may be a vertical direction because the length of the width is shorter than the length of the height. The image decoding apparatus 100 may determine to split a current coding unit into the odd number of blocks, based on the split shape mode information. Also, the image decoding apparatus 100 may determine a split direction of the current coding unit 400 or 450, based on the block shape information of the current coding unit 400 or 450. For example, when the current coding unit 400 is in the vertical direction, the image decoding apparatus 100 may determine the coding units 430a to 430c by splitting the current coding unit 400 in the horizontal direction. Also, when the current coding unit 450 is in the horizontal direction, the image decoding apparatus 100 may determine the coding units 480a to 480c by splitting the current coding unit 450 in the vertical direction.

According to an embodiment, the image decoding apparatus 100 may determine the odd number of coding units included in the current coding unit 400 or 450, and not all the determined coding units may have the same size. For example, a predetermined coding unit 430b or 480b from among the determined odd number of coding units 430a, 430b, and 430c, or 480a, 480b, and 480c may have a size different from the size of the other coding units 430a and 430c, or 480a and 480c. That is, coding units which may be determined by splitting the current coding unit 400 or 450 may have multiple sizes and, in some cases, all of the odd number of coding units 430a, 430b, and 430c, or 480a, 480b, and 480c may have different sizes.

According to an embodiment, when the split shape mode information indicates to split a coding unit into the odd number of blocks, the image decoding apparatus 100 may determine the odd number of coding units included in the current coding unit 400 or 450, and in addition, may put a predetermined restriction on at least one coding unit from among the odd number of coding units generated by splitting the current coding unit 400 or 450. Referring to FIG. 4, the image decoding apparatus 100 may set a decoding process regarding the coding unit 430b or 480b located at the center among the three coding units 430a, 430b, and 430c or 480a, 480b, and 480c generated as the current coding unit 400 or 450 is split to be different from that of the other coding units 430a and 430c, or 480a or 480c. For example, the image decoding apparatus 100 may restrict the coding unit 430b or 480b at the center location to be no longer split or to be split only a predetermined number of times, unlike the other coding units 430a and 430c, or 480a and 480c.

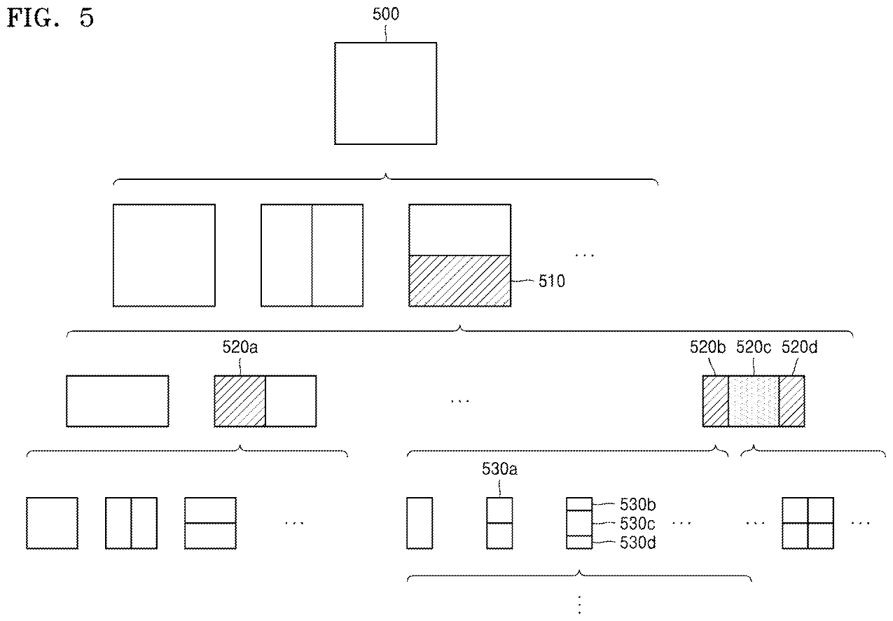

FIG. 5 illustrates a process, performed by the image decoding apparatus 100, of splitting a coding unit based on at least one of block shape information and split shape mode information, according to an embodiment.

According to an embodiment, the image decoding apparatus 100 may determine to split or not to split a square first coding unit 500 into coding units, based on at least one of the block shape information and the split shape mode information. According to an embodiment, when the split shape mode information indicates to split the first coding unit 500 in a horizontal direction, the image decoding apparatus 100 may determine a second coding unit 510 by splitting the first coding unit 500 in a horizontal direction. A first coding unit, a second coding unit, and a third coding unit used according to an embodiment are terms used to understand a relation before and after splitting a coding unit. For example, a second coding unit may be determined by splitting a first coding unit, and a third coding unit may be determined by splitting the second coding unit. It will be understood that the structure of the first coding unit, the second coding unit, and the third coding unit follows the above descriptions.

According to an embodiment, the image decoding apparatus 100 may determine to split or not to split the determined second coding unit 510 into coding units, based on the split shape mode information. Referring to FIG. 5, the image decoding apparatus 100 may or may not split the non-square second coding unit 510, which is determined by splitting the first coding unit 500, into one or more third coding units 520a, or 520b, 520c, and 520d based on the split shape mode information. The image decoding apparatus 100 may obtain the split shape mode information, and may obtain a plurality of various-shaped second coding units (e.g., 510) by splitting the first coding unit 500, based on the obtained split shape mode information, and the second coding unit 510 may be split by using a splitting method of the first coding unit 500 based on the split shape mode information. According to an embodiment, when the first coding unit 500 is split into the second coding units 510 based on the split shape mode information of the first coding unit 500, the second coding unit 510 may also be split into the third coding units 520a, or 520b, 520c, and 520d based on the split shape mode information of the second coding unit 510. That is, a coding unit may be recursively split based on the split shape mode information of each coding unit. Therefore, a square coding unit may be determined by splitting a non-square coding unit, and a non-square coding unit may be determined by recursively splitting the square coding unit.

Referring to FIG. 5, a predetermined coding unit from among the odd number of third coding units 520b, 520c, and 520d determined by splitting the non-square second coding unit 510 (e.g., a coding unit at a center location or a square coding unit) may be recursively split. According to an embodiment, the non-square third coding unit 520b from among the odd number of third coding units 520b, 520c, and 520d may be split in a horizontal direction into a plurality of fourth coding units. A non-square fourth coding unit 530b or 530d from among a plurality of fourth coding units 530a, 530b, 530c, and 530d may be split into a plurality of coding units again. For example, the non-square fourth coding unit 530b or 530d may be split into the odd number of coding units again. A method that may be used to recursively split a coding unit will be described below in relation to various embodiments.

According to an embodiment, the image decoding apparatus 100 may split each of the third coding units 520a, or 520b, 520c, and 520d into coding units, based on the split shape mode information. Also, the image decoding apparatus 100 may determine not to split the second coding unit 510 based on the split shape mode information. According to an embodiment, the image decoding apparatus 100 may split the non-square second coding unit 510 into the odd number of third coding units 520b, 520c, and 520d. The image decoding apparatus 100 may put a predetermined restriction on a predetermined third coding unit from among the odd number of third coding units 520b, 520c, and 520d. For example, the image decoding apparatus 100 may restrict the third coding unit 520c at a center location from among the odd number of third coding units 520b, 520c, and 520d to be no longer split or to be split a settable number of times.

Referring to FIG. 5, the image decoding apparatus 100 may restrict the third coding unit 520c, which is at the center location from among the odd number of third coding units 520b, 520c, and 520d included in the non-square second coding unit 510, to be no longer split, to be split by using a predetermined splitting method (e.g., split into only four coding units or split by using a splitting method of the second coding unit 510), or to be split only a predetermined number of times (e.g., split only n times (where n>0)). However, the restrictions on the third coding unit 520c at the center location are not limited to the above-described examples, and may include various restrictions for decoding the third coding unit 520c at the center location differently from the other third coding units 520b and 520d.

According to an embodiment, the image decoding apparatus 100 may obtain the split shape mode information, which is used to split a current coding unit, from a predetermined location in the current coding unit.

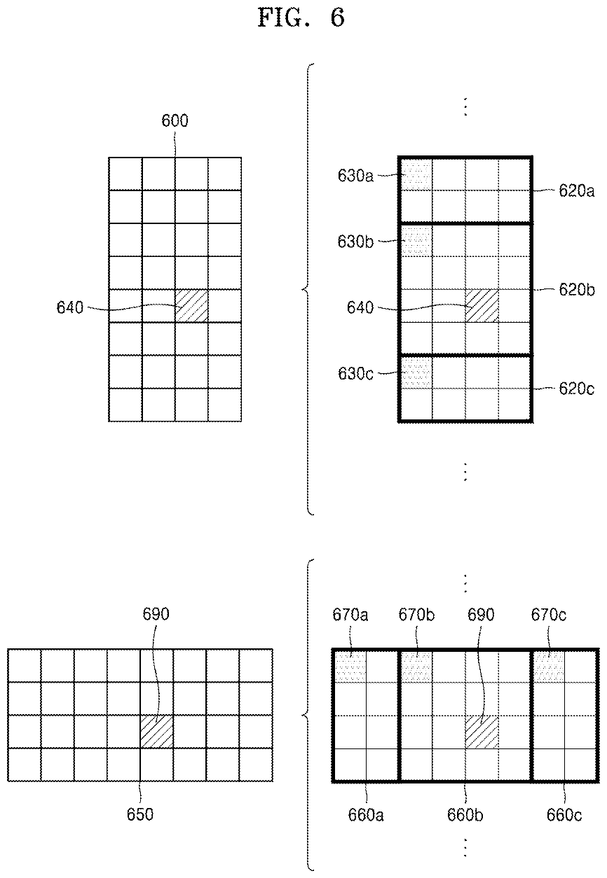

FIG. 6 illustrates a method, performed by the image decoding apparatus 100, of determining a predetermined coding unit from among an odd number of coding units, according to an embodiment.

Referring to FIG. 6, split shape mode information of a current coding unit 600 or 650 may be obtained from a sample of a predetermined location (e.g., a sample 640 or 690 of a center location) from among a plurality of samples included in the current coding unit 600 or 650. However, the predetermined location in the current coding unit 600, from which at least one piece of the split shape mode information may be obtained, is not limited to the center location in FIG. 6, and may include various locations included in the current coding unit 600 (e.g., top, bottom, left, right, upper left, lower left, upper right, and lower right locations). The image decoding apparatus 100 may obtain the split shape mode information from the predetermined location and may determine to split or not to split the current coding unit into various-shaped and various-sized coding units.

According to an embodiment, when the current coding unit is split into a predetermined number of coding units, the image decoding apparatus 100 may select one of the coding units. Various methods may be used to select one of a plurality of coding units, as will be described below in relation to various embodiments.

According to an embodiment, the image decoding apparatus 100 may split the current coding unit into a plurality of coding units, and may determine a coding unit at a predetermined location.

According to an embodiment, image decoding apparatus 100 may use information indicating locations of the odd number of coding units, to determine a coding unit at a center location from among the odd number of coding units. Referring to FIG. 6, the image decoding apparatus 100 may determine the odd number of coding units 620a, 620b, and 620c or the odd number of coding units 660a, 660b, and 660c by splitting the current coding unit 600 or the current coding unit 650. The image decoding apparatus 100 may determine the middle coding unit 620b or the middle coding unit 660b by using information about the locations of the odd number of coding units 620a, 620b, and 620c or the odd number of coding units 660a, 660b, and 660c. For example, the image decoding apparatus 100 may determine the coding unit 620b of the center location by determining the locations of the coding units 620a, 620b, and 620c based on information indicating locations of predetermined samples included in the coding units 620a, 620b, and 620c. In detail, the image decoding apparatus 100 may determine the coding unit 620b at the center location by determining the locations of the coding units 620a, 620b, and 620c based on information indicating locations of upper left samples 630a, 630b, and 630c of the coding units 620a, 620b, and 620c.

According to an embodiment, the information indicating the locations of the upper left samples 630a, 630b, and 630c, which are included in the coding units 620a, 620b, and 620c, respectively, may include information about locations or coordinates of the coding units 620a, 620b, and 620c in a picture. According to an embodiment, the information indicating the locations of the upper left samples 630a, 630b, and 630c, which are included in the coding units 620a, 620b, and 620c, respectively, may include information indicating widths or heights of the coding units 620a, 620b, and 620c included in the current coding unit 600, and the widths or heights may correspond to information indicating differences between the coordinates of the coding units 620a, 620b, and 620c in the picture. That is, the image decoding apparatus 100 may determine the coding unit 620b at the center location by directly using the information about the locations or coordinates of the coding units 620a, 620b, and 620c in the picture, or by using the information about the widths or heights of the coding units, which correspond to the difference values between the coordinates.

According to an embodiment, information indicating the location of the upper left sample 630a of the upper coding unit 620a may include coordinates (xa, ya), information indicating the location of the upper left sample 630b of the middle coding unit 620b may include coordinates (xb, yb), and information indicating the location of the upper left sample 630c of the lower coding unit 620c may include coordinates (xc, yc). The image decoding apparatus 100 may determine the middle coding unit 620b by using the coordinates of the upper left samples 630a, 630b, and 630c which are included in the coding units 620a, 620b, and 620c, respectively. For example, when the coordinates of the upper left samples 630a, 630b, and 630c are sorted in an ascending or descending order, the coding unit 620b including the coordinates (xb, yb) of the sample 630b at a center location may be determined as a coding unit at a center location from among the coding units 620a, 620b, and 620c determined by splitting the current coding unit 600. However, the coordinates indicating the locations of the upper left samples 630a, 630b, and 630c may include coordinates indicating absolute locations in the picture, or may use coordinates (dxb, dyb) indicating a relative location of the upper left sample 630b of the middle coding unit 620b and coordinates (dxc, dyc) indicating a relative location of the upper left sample 630c of the lower coding unit 620c with reference to the location of the upper left sample 630a of the upper coding unit 620a. A method of determining a coding unit at a predetermined location by using coordinates of a sample included in the coding unit, as information indicating a location of the sample, is not limited to the above-described method, and may include various arithmetic methods capable of using the coordinates of the sample.

According to an embodiment, the image decoding apparatus 100 may split the current coding unit 600 into a plurality of coding units 620a, 620b, and 620c, and may select one of the coding units 620a, 620b, and 620c based on a predetermined criterion. For example, the image decoding apparatus 100 may select the coding unit 620b, which has a size different from that of the others, from among the coding units 620a, 620b, and 620c.

According to an embodiment, the image decoding apparatus 100 may determine the width or height of each of the coding units 620a, 620b, and 620c by using the coordinates (xa, ya) that is the information indicating the location of the upper left sample 630a of the upper coding unit 620a, the coordinates (xb, yb) that is the information indicating the location of the upper left sample 630b of the middle coding unit 620b, and the coordinates (xc, yc) that is the information indicating the location of the upper left sample 630c of the lower coding unit 620c. The image decoding apparatus 100 may determine the respective sizes of the coding units 620a, 620b, and 620c by using the coordinates (xa, ya), (xb, yb), and (xc, yc) indicating the locations of the coding units 620a, 620b, and 620c. According to an embodiment, the image decoding apparatus 100 may determine the width of the upper coding unit 620a to be the width of the current coding unit 600. The image decoding apparatus 100 may determine the height of the upper coding unit 620a to be yb-ya. According to an embodiment, the image decoding apparatus 100 may determine the width of the middle coding unit 620b to be the width of the current coding unit 600. The image decoding apparatus 100 may determine the height of the middle coding unit 620b to be yc-yb. According to an embodiment, the image decoding apparatus 100 may determine the width or height of the lower coding unit 620c by using the width or height of the current coding unit 600 or the widths or heights of the upper and middle coding units 620a and 620b. The image decoding apparatus 100 may determine a coding unit, which has a size different from that of the others, based on the determined widths and heights of the coding units 620a to 620c. Referring to FIG. 6, the image decoding apparatus 100 may determine the middle coding unit 620b, which has a size different from the size of the upper and lower coding units 620a and 620c, as the coding unit of the predetermined location. However, the above-described method, performed by the image decoding apparatus 100, of determining a coding unit having a size different from the size of the other coding units merely corresponds to an example of determining a coding unit at a predetermined location by using the sizes of coding units, which are determined based on coordinates of samples, and thus various methods of determining a coding unit at a predetermined location by comparing the sizes of coding units, which are determined based on coordinates of predetermined samples, may be used.

The image decoding apparatus 100 may determine the width or height of each of the coding units 660a, 660b, and 660c by using the coordinates (xd, yd) that is information indicating the location of a upper left sample 670a of the left coding unit 660a, the coordinates (xe, ye) that is information indicating the location of a upper left sample 670b of the middle coding unit 660b, and the coordinates (xf, yf) that is information indicating a location of the upper left sample 670c of the right coding unit 660c. The image decoding apparatus 100 may determine the respective sizes of the coding units 660a, 660b, and 660c by using the coordinates (xd, yd), (xe, ye), and (xf, yf) indicating the locations of the coding units 660a, 660b, and 660c.

According to an embodiment, the image decoding apparatus 100 may determine the width of the left coding unit 660a to be xe-xd. The image decoding apparatus 100 may determine the height of the left coding unit 660a to be the height of the current coding unit 650. According to an embodiment, the image decoding apparatus 100 may determine the width of the middle coding unit 660b to be xf-xe. The image decoding apparatus 100 may determine the height of the middle coding unit 660b to be the height of the current coding unit 600 (650?). According to an embodiment, the image decoding apparatus 100 may determine the width or height of the right coding unit 660c by using the width or height of the current coding unit 650 or the widths or heights of the left and middle coding units 660a and 660b. The image decoding apparatus 100 may determine a coding unit, which has a size different from that of the others, based on the determined widths and heights of the coding units 660a to 660c. Referring to FIG. 6, the image decoding apparatus 100 may determine the middle coding unit 660b, which has a size different from the sizes of the left and right coding units 660a and 660c, as the coding unit of the predetermined location. However, the above-described method, performed by the image decoding apparatus 100, of determining a coding unit having a size different from the size of the other coding units merely corresponds to an example of determining a coding unit at a predetermined location by using the sizes of coding units, which are determined based on coordinates of samples, and thus various methods of determining a coding unit at a predetermined location by comparing the sizes of coding units, which are determined based on coordinates of predetermined samples, may be used.

However, locations of samples considered to determine locations of coding units are not limited to the above-described upper left locations, and information about arbitrary locations of samples included in the coding units may be used.

According to an embodiment, the image decoding apparatus 100 may select a coding unit at a predetermined location from among an odd number of coding units determined by splitting the current coding unit, considering the shape of the current coding unit. For example, when the current coding unit has a non-square shape, a width of which is longer than a height, the image decoding apparatus 100 may determine the coding unit at the predetermined location in a horizontal direction. That is, the image decoding apparatus 100 may determine one of coding units at different locations in a horizontal direction and put a restriction on the coding unit. When the current coding unit has a non-square shape, a height of which is longer than a width, the image decoding apparatus 100 may determine the coding unit at the predetermined location in a vertical direction. That is, the image decoding apparatus 100 may determine one of coding units at different locations in a vertical direction and may put a restriction on the coding unit.

According to an embodiment, the image decoding apparatus 100 may use information indicating respective locations of an even number of coding units, to determine the coding unit at the predetermined location from among the even number of coding units. The image decoding apparatus 100 may determine an even number of coding units by splitting (binary-splitting) the current coding unit, and may determine the coding unit at the predetermined location by using the information about the locations of the even number of coding units. An operation related thereto may correspond to the operation of determining a coding unit at a predetermined location (e.g., a center location) from among an odd number of coding units, which has been described in detail above in relation to FIG. 6, and thus detailed descriptions thereof are not provided here.

According to an embodiment, when a non-square current coding unit is split into a plurality of coding units, predetermined information about a coding unit at a predetermined location may be used in a splitting operation to determine the coding unit at the predetermined location from among the plurality of coding units. For example, the image decoding apparatus 100 may use at least one of block shape information and split shape mode information, which is stored in a sample included in a middle coding unit, in a splitting operation to determine a coding unit at a center location from among the plurality of coding units determined by splitting the current coding unit.

Referring to FIG. 6, the image decoding apparatus 100 may split the current coding unit 600 into the plurality of coding units 620a, 620b, and 620c based on the split shape mode information, and may determine the coding unit 620b at a center location from among the plurality of the coding units 620a, 620b, and 620c. Furthermore, the image decoding apparatus 100 may determine the coding unit 620b at the center location, in consideration of a location from which the split shape mode information is obtained. That is, the split shape mode information of the current coding unit 600 may be obtained from the sample 640 at a center location of the current coding unit 600 and, when the current coding unit 600 is split into the plurality of coding units 620a, 620b, and 620c based on the split shape mode information, the coding unit 620b including the sample 640 may be determined as the coding unit at the center location. However, information used to determine the coding unit at the center location is not limited to the split shape mode information, and various types of information may be used to determine the coding unit at the center location.

According to an embodiment, predetermined information for identifying the coding unit at the predetermined location may be obtained from a predetermined sample included in a coding unit to be determined. Referring to FIG. 6, the image decoding apparatus 100 may use the split shape mode information, which is obtained from a sample at a predetermined location in the current coding unit 600 (e.g., a sample at a center location of the current coding unit 600) to determine a coding unit at a predetermined location from among the plurality of the coding units 620a, 620b, and 620c determined by splitting the current coding unit 600 (e.g., a coding unit at a center location from among a plurality of split coding units). That is, the image decoding apparatus 100 may determine the sample at the predetermined location by considering a block shape of the current coding unit 600, determine the coding unit 620b including a sample, from which predetermined information (e.g., the split shape mode information) may be obtained, from among the plurality of coding units 620a, 620b, and 620c determined by splitting the current coding unit 600, and may put a predetermined restriction on the coding unit 620b. Referring to FIG. 6, according to an embodiment, the image decoding apparatus 100 may determine the sample 640 at the center location of the current coding unit 600 as the sample from which the predetermined information may be obtained, and may put a predetermined restriction on the coding unit 620b including the sample 640, in a decoding operation. However, the location of the sample from which the predetermined information may be obtained is not limited to the above-described location, and may include arbitrary locations of samples included in the coding unit 620b to be determined for a restriction.

According to an embodiment, the location of the sample from which the predetermined information may be obtained may be determined based on the shape of the current coding unit 600. According to an embodiment, the block shape information may indicate whether the current coding unit has a square or non-square shape, and the location of the sample from which the predetermined information may be obtained may be determined based on the shape. For example, the image decoding apparatus 100 may determine a sample located on a boundary for splitting at least one of a width and height of the current coding unit in half, as the sample from which the predetermined information may be obtained, by using at least one of information about the width of the current coding unit and information about the height of the current coding unit. As another example, when the block shape information of the current coding unit indicates a non-square shape, the image decoding apparatus 100 may determine one of samples adjacent to a boundary for splitting a long side of the current coding unit in half, as the sample from which the predetermined information may be obtained.

According to an embodiment, when the current coding unit is split into a plurality of coding units, the image decoding apparatus 100 may use the split shape mode information to determine a coding unit at a predetermined location from among the plurality of coding units. According to an embodiment, the image decoding apparatus 100 may obtain the split shape mode information from a sample at a predetermined location in a coding unit, and split the plurality of coding units, which are generated by splitting the current coding unit, by using the split shape mode information, which is obtained from the sample of the predetermined location in each of the plurality of coding units. That is, a coding unit may be recursively split based on the split shape mode information, which is obtained from the sample at the predetermined location in each coding unit. An operation of recursively splitting a coding unit has been described above in relation to FIG. 5, and thus detailed descriptions thereof will not be provided here.

According to an embodiment, the image decoding apparatus 100 may determine one or more coding units by splitting the current coding unit, and may determine an order of decoding the one or more coding units, based on a predetermined block (e.g., the current coding unit).

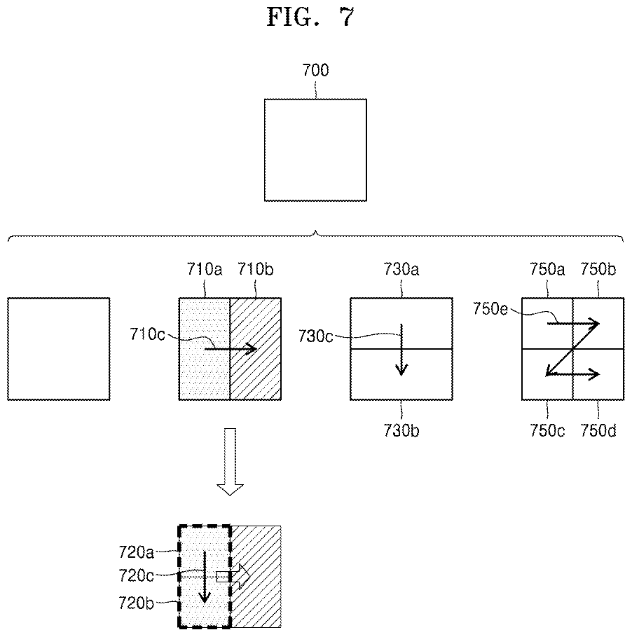

FIG. 7 illustrates an order of processing a plurality of coding units when the image decoding apparatus 100 determines the plurality of coding units by splitting a current coding unit, according to an embodiment.

According to an embodiment, the image decoding apparatus 100 may determine second coding units 710a and 710b by splitting a first coding unit 700 in a vertical direction, determine second coding units 730a and 730b by splitting the first coding unit 700 in a horizontal direction, or determine second coding units 750a to 750d by splitting the first coding unit 700 in vertical and horizontal directions, based on split shape mode information.

Referring to FIG. 7, the image decoding apparatus 100 may determine to process the second coding units 710a and 710b, which are determined by splitting the first coding unit 700 in a vertical direction, in a horizontal direction order 710c. The image decoding apparatus 100 may determine to process the second coding units 730a and 730b, which are determined by splitting the first coding unit 700 in a horizontal direction, in a vertical direction order 730c. The image decoding apparatus 100 may determine to process the second coding units 750a to 750d, which are determined by splitting the first coding unit 700 in vertical and horizontal directions, in a predetermined order for processing coding units in a row and then processing coding units in a next row (e.g., in a raster scan order or Z-scan order 750e).

According to an embodiment, the image decoding apparatus 100 may recursively split coding units. Referring to FIG. 7, the image decoding apparatus 100 may determine the plurality of coding units 710a and 710b, 730a and 730b, or 750a to 750d by splitting the first coding unit 700, and recursively split each of the determined plurality of coding units 710b, 730a and 730b, or 750a to 750d. A splitting method of the plurality of coding units 710b, 730a and 730b, or 750a to 750d may correspond to a splitting method of the first coding unit 700. As such, each of the plurality of coding units 710b, 730a and 730b, or 750a to 750d may be independently split into a plurality of coding units. Referring to FIG. 7, the image decoding apparatus 100 may determine the second coding units 710a and 710b by splitting the first coding unit 700 in a vertical direction, and may determine to independently split or not to split each of the second coding units 710a and 710b.

According to an embodiment, the image decoding apparatus 100 may determine third coding units 720a and 720b by splitting the left second coding unit 710a in a horizontal direction, and may not split the right second coding unit 710b.

According to an embodiment, a processing order of coding units may be determined based on an operation of splitting a coding unit. In other words, a processing order of split coding units may be determined based on a processing order of coding units immediately before being split. The image decoding apparatus 100 may determine a processing order of the third coding units 720a and 720b determined by splitting the left second coding unit 710a, independently of the right second coding unit 710b. Because the third coding units 720a and 720b are determined by splitting the left second coding unit 710a in a horizontal direction, the third coding units 720a and 720b may be processed in a vertical direction order 720c. Because the left and right second coding units 710a and 710b are processed in the horizontal direction order 710c, the right second coding unit 710b may be processed after the third coding units 720a and 720b included in the left second coding unit 710a are processed in the vertical direction order 720c. An operation of determining a processing order of coding units based on a coding unit before being split is not limited to the above-described example, and various methods may be used to independently process coding units, which are split and determined to various shapes, in a predetermined order.

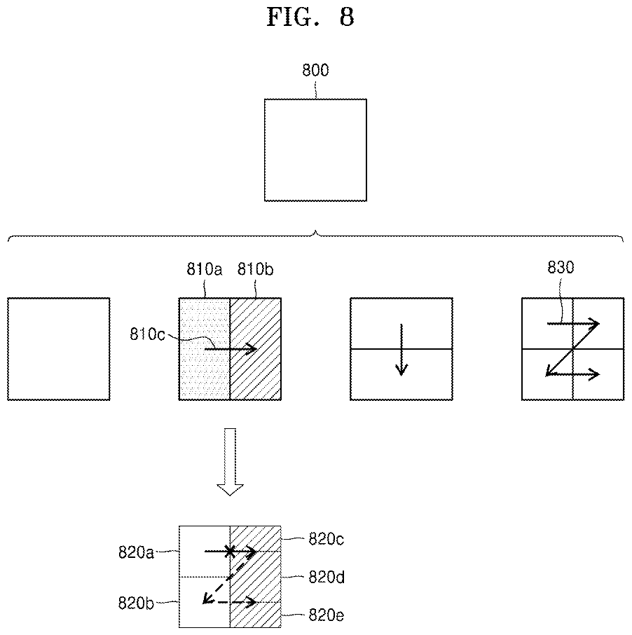

FIG. 8 illustrates a process, performed by the image decoding apparatus 100, of determining that a current coding unit is to be split into an odd number of coding units, when the coding units are not processable in a predetermined order, according to an embodiment.

According to an embodiment, the image decoding apparatus 100 may determine whether the current coding unit is split into an odd number of coding units, based on obtained split shape mode information. Referring to FIG. 8, a square first coding unit 800 may be split into non-square second coding units 810a and 810b, and the second coding units 810a and 810b may be independently split into third coding units 820a and 820b, and 820c to 820e. According to an embodiment, the image decoding apparatus 100 may determine the plurality of third coding units 820a and 820b by splitting the left second coding unit 810a in a horizontal direction, and may split the right second coding unit 810b into the odd number of third coding units 820c to 820e.

According to an embodiment, the image decoding apparatus 100 may determine whether any coding unit is split into an odd number of coding units, by determining whether the third coding units 820a and 820b, and 820c to 820e are processable in a predetermined order. Referring to FIG. 8, the image decoding apparatus 100 may determine the third coding units 820a and 820b, and 820c to 820e by recursively splitting the first coding unit 800. The image decoding apparatus 100 may determine whether any of the first coding unit 800, the second coding units 810a and 810b, and the third coding units 820a and 820b, and 820c to 820e are split into an odd number of coding units, based on at least one of the block shape information and the split shape mode information. For example, the right second coding unit 810b among the second coding units 810a and 810b may be split into an odd number of third coding units 820c, 820d, and 820e. A processing order of a plurality of coding units included in the first coding unit 800 may be a predetermined order (e.g., a Z-scan order 830), and the image decoding apparatus 100 may determine whether the third coding units 820c, 820d, and 820e, which are determined by splitting the right second coding unit 810b into an odd number of coding units, satisfy a condition for processing in the predetermined order.

According to an embodiment, the image decoding apparatus 100 may determine whether the third coding units 820a and 820b, and 820c to 820e included in the first coding unit 800 satisfy the condition for processing in the predetermined order, and the condition relates to whether at least one of a width and height of the second coding units 810a and 810b is split in half along a boundary of the third coding units 820a and 820b, and 820c to 820e. For example, the third coding units 820a and 820b determined when the height of the left second coding unit 810a of the non-square shape is split in half may satisfy the condition. It may be determined that the third coding units 820c to 820e do not satisfy the condition because the boundaries of the third coding units 820c to 820e determined when the right second coding unit 810b is split into three coding units are unable to split the width or height of the right second coding unit 810b in half. When the condition is not satisfied as described above, the image decoding apparatus 100 may determine disconnection of a scan order, and may determine that the right second coding unit 810b is split into an odd number of coding units, based on a result of the determination. According to an embodiment, when a coding unit is split into an odd number of coding units, the image decoding apparatus 100 may put a predetermined restriction on a coding unit at a predetermined location from among the split coding units. The restriction or the predetermined location has been described above in relation to various embodiments, and thus detailed descriptions thereof will not be provided herein.

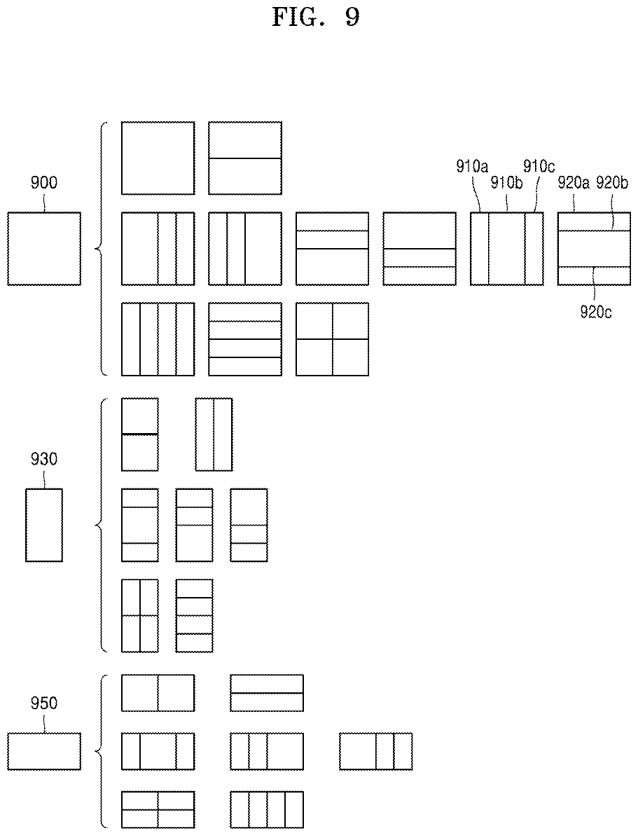

FIG. 9 illustrates a process, performed by the image decoding apparatus 100, of determining at least one coding unit by splitting a first coding unit 900, according to an embodiment.

According to an embodiment, the image decoding apparatus 100 may split the first coding unit 900, based on split shape mode information, which is obtained through the bitstream obtainer 110. The square first coding unit 900 may be split into four square coding units, or may be split into a plurality of non-square coding units. For example, referring to FIG. 9, when the split shape mode information indicates to split the first coding unit 900 into non-square coding units, the image decoding apparatus 100 may split the first coding unit 900 into a plurality of non-square coding units. In detail, when the split shape mode information indicates to determine an odd number of coding units by splitting the first coding unit 900 in a horizontal direction or a vertical direction, the image decoding apparatus 100 may split the square first coding unit 900 into an odd number of coding units, e.g., second coding units 910a, 910b, and 910c determined by splitting the square first coding unit 900 in a vertical direction or second coding units 920a, 920b, and 920c determined by splitting the square first coding unit 900 in a horizontal direction.

According to an embodiment, the image decoding apparatus 100 may determine whether the second coding units 910a, 910b, 910c, 920a, 920b, and 920c included in the first coding unit 900 satisfy a condition for processing in a predetermined order, and the condition relates to whether at least one of a width and height of the first coding unit 900 is split in half along a boundary of the second coding units 910a, 910b, 910c, 920a, 920b, and 920c. Referring to FIG. 9, because boundaries of the second coding units 910a, 910b, and 910c determined by splitting the square first coding unit 900 in a vertical direction do not split the width of the first coding unit 900 in half, it may be determined that the first coding unit 900 does not satisfy the condition for processing in the predetermined order. In addition, because boundaries of the second coding units 920a, 920b, and 920c determined by splitting the square first coding unit 900 in a horizontal direction do not split the height of the first coding unit 900 in half, it may be determined that the first coding unit 900 does not satisfy the condition for processing in the predetermined order. When the condition is not satisfied as described above, the image decoding apparatus 100 may decide disconnection of a scan order, and may determine that the first coding unit 900 is split into an odd number of coding units, based on a result of the decision. According to an embodiment, when a coding unit is split into an odd number of coding units, the image decoding apparatus 100 may put a predetermined restriction on a coding unit at a predetermined location from among the split coding units. The restriction or the predetermined location has been described above in relation to various embodiments, and thus detailed descriptions thereof will not be provided herein.

According to an embodiment, the image decoding apparatus 100 may determine various-shaped coding units by splitting a first coding unit.

Referring to FIG. 9, the image decoding apparatus 100 may split the square first coding unit 900 or a non-square first coding unit 930 or 950 into various-shaped coding units.

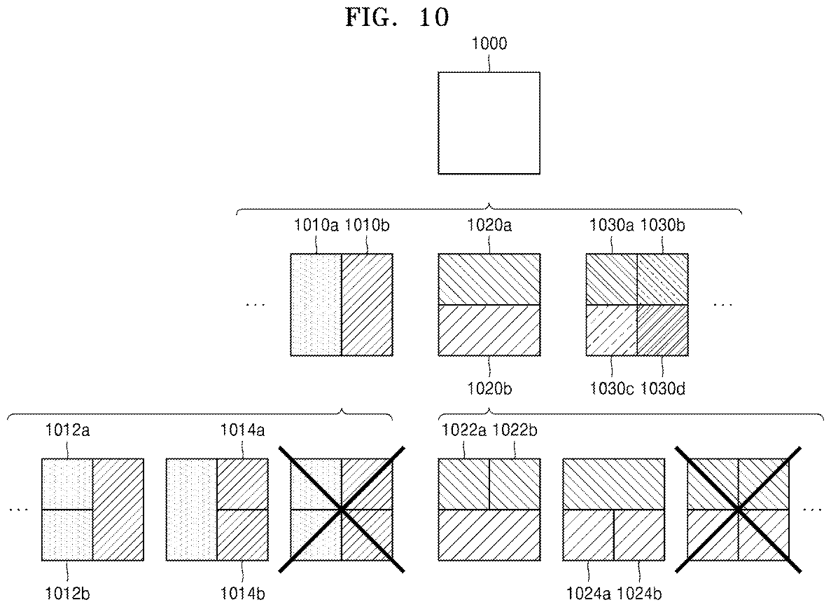

FIG. 10 illustrates that a shape into which a second coding unit is splittable is restricted when the second coding unit having a non-square shape, which is determined as the image decoding apparatus 100 splits a first coding unit 1000, satisfies a predetermined condition, according to an embodiment.

According to an embodiment, the image decoding apparatus 100 may determine to split the square first coding unit 1000 into non-square second coding units 1010a, and 1010b or 1020a and 1020b, based on split shape mode information, which is obtained by the bitstream obtainer 110. The second coding units 1010a and 1010b or 1020a and 1020b may be independently split. As such, the image decoding apparatus 100 may determine to split or not to split each of the second coding units 1010a and 1010b or 1020a and 1020b into a plurality of coding units, based on the split shape mode information of each of the second coding units 1010a and 1010b or 1020a and 1020b. According to an embodiment, the image decoding apparatus 100 may determine third coding units 1012a and 1012b by splitting the non-square left second coding unit 1010a, which is determined by splitting the first coding unit 1000 in a vertical direction, in a horizontal direction. However, when the left second coding unit 1010a is split in a horizontal direction, the image decoding apparatus 100 may restrict the right second coding unit 1010b to not be split in a horizontal direction in which the left second coding unit 1010a is split. When third coding units 1014a and 1014b are determined by splitting the right second coding unit 1010b in a same direction, because the left and right second coding units 1010a and 1010b are independently split in a horizontal direction, the third coding units 1012a and 1012b or 1014a and 1014b may be determined. However, this case serves equally as a case in which the image decoding apparatus 100 splits the first coding unit 1000 into four square second coding units 1030a, 1030b, 1030c, and 1030d, based on the split shape mode information, and may be inefficient in terms of image decoding.

According to an embodiment, the image decoding apparatus 100 may determine third coding units 1022a and 1022b or 1024a and 1024b by splitting the non-square second coding unit 1020a or 1020b, which is determined by splitting the first coding unit 1000 in a horizontal direction, in a vertical direction. However, when a second coding unit (e.g., the upper second coding unit 1020a) is split in a vertical direction, for the above-described reason, the image decoding apparatus 100 may restrict the other second coding unit (e.g., the lower second coding unit 1020b) to not be split in a vertical direction in which the upper second coding unit 1020a is split.

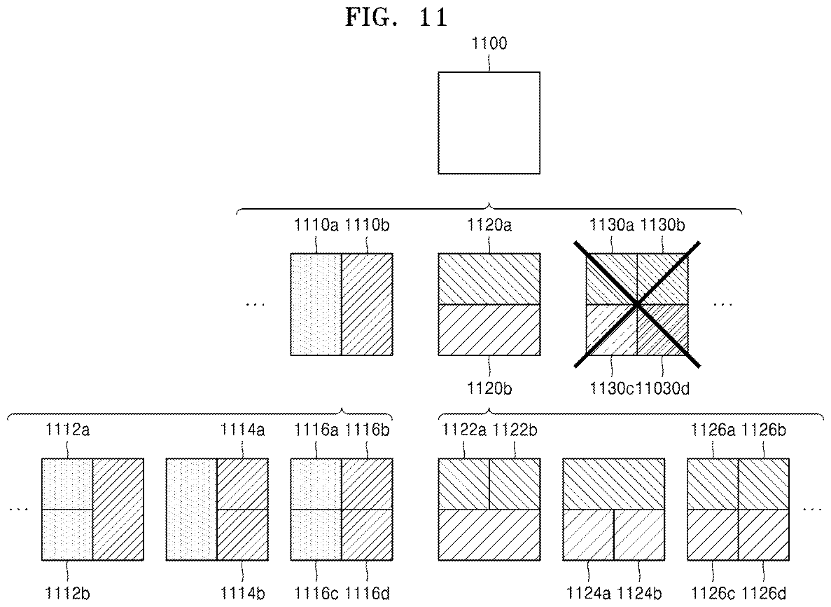

FIG. 11 illustrates a process, performed by the image decoding apparatus 100, of splitting a square coding unit when split shape mode information is unable to indicate that the square coding unit is split into four square coding units, according to an embodiment.

According to an embodiment, the image decoding apparatus 100 may determine second coding units 1110a and 1110b or 1120a and 1120b, etc. by splitting a first coding unit 1100, based on split shape mode information. The split shape mode information may include information about various methods of splitting a coding unit but, the information about various splitting methods may not include information for splitting a coding unit into four square coding units. According to such split shape mode information, the image decoding apparatus 100 may not split the square first coding unit 1100 into four square second coding units 1130a, 1130b, 1130c, and 1130d. The image decoding apparatus 100 may determine the non-square second coding units 1110a and 1110b or 1120a and 1120b, etc., based on the split shape mode information.

According to an embodiment, the image decoding apparatus 100 may independently split the non-square second coding units 1110a and 1110b or 1120a and 1120b, etc. Each of the second coding units 1110a and 1110b or 1120a and 1120b, etc. may be recursively split in a predetermined order, and this splitting method may correspond to a method of splitting the first coding unit 1100, based on the split shape mode information.

For example, the image decoding apparatus 100 may determine square third coding units 1112a and 1112b by splitting the left second coding unit 1110a in a horizontal direction, and may determine square third coding units 1114a and 1114b by splitting the right second coding unit 1110b in a horizontal direction. Furthermore, the image decoding apparatus 100 may determine square third coding units 1116a, 1116b, 1116c, and 1116d by splitting both of the left and right second coding units 1110a and 1110b in a horizontal direction. In this case, coding units having the same shape as the four square second coding units 1130a, 1130b, 1130c, and 1130d split from the first coding unit 1100 may be determined.

As another example, the image decoding apparatus 100 may determine square third coding units 1122a and 1122b by splitting the upper second coding unit 1120a in a vertical direction, and may determine square third coding units 1124a and 1124b by splitting the lower second coding unit 1120b in a vertical direction. Furthermore, the image decoding apparatus 100 may determine square third coding units 1126a, 1126b, 1126c, and 1126d by splitting both of the upper and lower second coding units 1120a and 1120b in a vertical direction. In this case, coding units having the same shape as the four square second coding units 1130a, 1130b, 1130c, and 1130d split from the first coding unit 1100 may be determined.

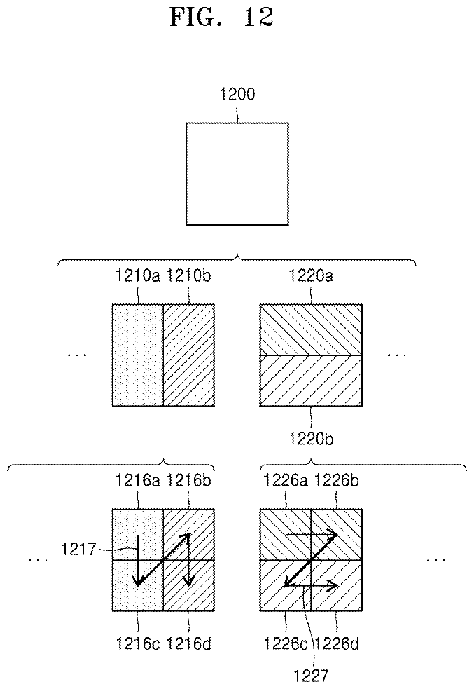

FIG. 12 illustrates that a processing order between a plurality of coding units may be changed depending on a process of splitting a coding unit, according to an embodiment.

According to an embodiment, the image decoding apparatus 100 may split a first coding unit 1200, based on split shape mode information. When a block shape indicates a square shape and the split shape mode information indicates to split the first coding unit 1200 in at least one of horizontal and vertical directions, the image decoding apparatus 100 may determine second coding units 1210a and 1210b or 1220a and 1220b, etc. by splitting the first coding unit 1200. Referring to FIG. 12, the non-square second coding units 1210a and 1210b or 1220a and 1220b determined by splitting the first coding unit 1200 in only a horizontal direction or vertical direction may be independently split based on the split shape mode information of each coding unit. For example, the image decoding apparatus 100 may determine third coding units 1216a, 1216b, 1216c, and 1216d by splitting the second coding units 1210a and 1210b, which are generated by splitting the first coding unit 1200 in a vertical direction, in a horizontal direction, and may determine third coding units 1226a, 1226b, 1226c, and 1226d by splitting the second coding units 1220a and 1220b, which are generated by splitting the first coding unit 1200 in a horizontal direction, in a vertical direction. An operation of splitting the second coding units 1210a and 1210b or 1220a and 1220b has been described above in relation to FIG. 11, and thus detailed descriptions thereof will not be provided herein.

According to an embodiment, the image decoding apparatus 100 may process coding units in a predetermined order. An operation of processing coding units in a predetermined order has been described above in relation to FIG. 7, and thus detailed descriptions thereof will not be provided herein. Referring to FIG. 12, the image decoding apparatus 100 may determine four square third coding units 1216a, 1216b, 1216c, and 1216d, and 1226a, 1226b, 1226c, and 1226d by splitting the square first coding unit 1200. According to an embodiment, the image decoding apparatus 100 may determine processing orders of the third coding units 1216a, 1216b, 1216c, and 1216d, and 1226a, 1226b, 1226c, and 1226d based on a splitting method of the first coding unit 1200.

According to an embodiment, the image decoding apparatus 100 may determine the third coding units 1216a, 1216b, 1216c, and 1216d by splitting the second coding units 1210a and 1210b generated by splitting the first coding unit 1200 in a vertical direction, in a horizontal direction, and may process the third coding units 1216a, 1216b, 1216c, and 1216d in a processing order 1217 for initially processing the third coding units 1216a and 1216c, which are included in the left second coding unit 1210a, in a vertical direction and then processing the third coding unit 1216b and 1216d, which are included in the right second coding unit 1210b, in a vertical direction.

According to an embodiment, the image decoding apparatus 100 may determine the third coding units 1226a, 1226b, 1226c, and 1226d by splitting the second coding units 1220a and 1220b generated by splitting the first coding unit 1200 in a horizontal direction, in a vertical direction, and may process the third coding units 1226a, 1226b, 1226c, and 1226d in a processing order 1227 for initially processing the third coding units 1226a and 1226b, which are included in the upper second coding unit 1220a, in a horizontal direction and then processing the third coding unit 1226c and 1226d, which are included in the lower second coding unit 1220b, in a horizontal direction.

Referring to FIG. 12, the square third coding units 1216a, 1216b, 1216c, and 1216d, and 1226a, 1226b, 1226c, and 1226d may be determined by splitting the second coding units 1210a and 1210b, and 1220a and 1220b, respectively. Although the second coding units 1210a and 1210b are determined by splitting the first coding unit 1200 in a vertical direction differently from the second coding units 1220a and 1220b which are determined by splitting the first coding unit 1200 in a horizontal direction, the third coding units 1216a, 1216b, 1216c, and 1216d, and 1226a, 1226b, 1226c, and 1226d split therefrom eventually show same-shaped coding units split from the first coding unit 1200. As such, by recursively splitting a coding unit in different manners based on the split shape mode information, the image decoding apparatus 100 may process a plurality of coding units in different orders even when the coding units are eventually determined to be the same shape.

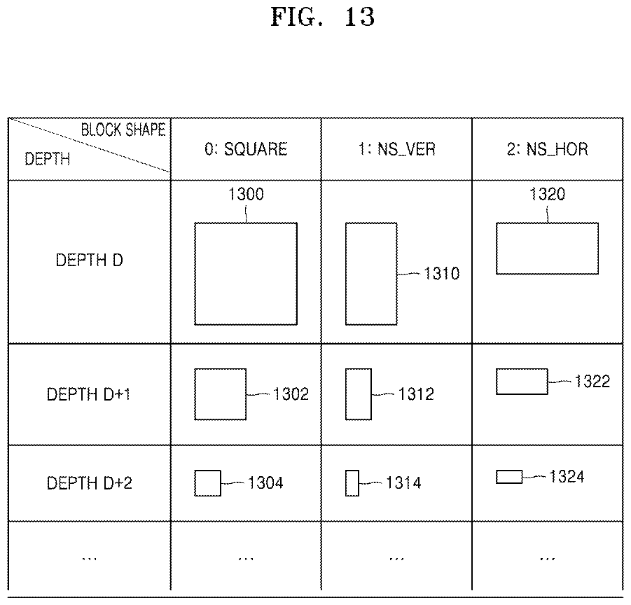

FIG. 13 illustrates a process of determining a depth of a coding unit as a shape and size of the coding unit change, when the coding unit is recursively split such that a plurality of coding units are determined, according to an embodiment.

According to an embodiment, the image decoding apparatus 100 may determine the depth of the coding unit, based on a predetermined criterion. For example, the predetermined criterion may be the length of a long side of the coding unit. When the length of a long side of a coding unit before being split is 2n times (n>0) the length of a long side of a split current coding unit, the image decoding apparatus 100 may determine that a depth of the current coding unit is increased from a depth of the coding unit before being split, by n. In the following description, a coding unit having an increased depth is expressed as a coding unit of a deeper depth.

Referring to FIG. 13, according to an embodiment, the image decoding apparatus 100 may determine a second coding unit 1302 and a third coding unit 1304 of deeper depths by splitting a square first coding unit 1300 based on block shape information indicating a square shape (for example, the block shape information may be expressed as ‘0: SQUARE’). Assuming that the size of the square first coding unit 1300 is 2N×2N, the second coding unit 1302 determined by splitting a width and height of the first coding unit 1300 in ½ may have a size of N×N. Furthermore, the third coding unit 1304 determined by splitting a width and height of the second coding unit 1302 in ½ may have a size of N/2×N/2. In this case, a width and height of the third coding unit 1304 are ¼ times those of the first coding unit 1300. When a depth of the first coding unit 1300 is D, a depth of the second coding unit 1302, the width and height of which are ½ times those of the first coding unit 1300, may be D+1, and a depth of the third coding unit 1304, the width and height of which are ¼ times those of the first coding unit 1300, may be D+2.

According to an embodiment, the image decoding apparatus 100 may determine a second coding unit 1312 or 1322 and a third coding unit 1314 or 1324 of deeper depths by splitting a non-square first coding unit 1310 or 1320 based on block shape information indicating a non-square shape (for example, the block shape information may be expressed as ‘1: NS_VER’ indicating a non-square shape, a height of which is longer than a width, or as ‘2: NS_HOR’ indicating a non-square shape, a width of which is longer than a height).

The image decoding apparatus 100 may determine a second coding unit 1302, 1312, or 1322 by splitting at least one of a width and height of the first coding unit 1310 having a size of N×2N. That is, the image decoding apparatus 100 may determine the second coding unit 1302 having a size of N×N or the second coding unit 1322 having a size of N×N/2 by splitting the first coding unit 1310 in a horizontal direction, or may determine the second coding unit 1312 having a size of N/2×N by splitting the first coding unit 1310 in horizontal and vertical directions.

According to an embodiment, the image decoding apparatus 100 may determine the second coding unit 1302, 1312, or 1322 by splitting at least one of a width and height of the first coding unit 1320 having a size of 2N×N. That is, the image decoding apparatus 100 may determine the second coding unit 1302 having a size of N×N or the second coding unit 1312 having a size of N/2×N by splitting the first coding unit 1320 in a vertical direction, or may determine the second coding unit 1322 having a size of N×N/2 by splitting the first coding unit 1320 in horizontal and vertical directions.

According to an embodiment, the image decoding apparatus 100 may determine a third coding unit 1304, 1314, or 1324 by splitting at least one of a width and height of the second coding unit 1302 having a size of N×N. That is, the image decoding apparatus 100 may determine the third coding unit 1304 having a size of N/2×N/2, the third coding unit 1314 having a size of N/4×N/2, or the third coding unit 1324 having a size of N/2×N/4 by splitting the second coding unit 1302 in vertical and horizontal directions.

According to an embodiment, the image decoding apparatus 100 may determine the third coding unit 1304, 1314, or 1324 by splitting at least one of a width and height of the second coding unit 1312 having a size of N/2×N. That is, the image decoding apparatus 100 may determine the third coding unit 1304 having a size of N/2×N/2 or the third coding unit 1324 having a size of N/2×N/4 by splitting the second coding unit 1312 in a horizontal direction, or may determine the third coding unit 1314 having a size of N/4×N/2 by splitting the second coding unit 1312 in vertical and horizontal directions.

According to an embodiment, the image decoding apparatus 100 may determine the third coding unit 1304, 1314, or 1324 by splitting at least one of a width and height of the second coding unit 1322 having a size of N×N/2. That is, the image decoding apparatus 100 may determine the third coding unit 1304 having a size of N/2×N/2 or the third coding unit 1314 having a size of N/4×N/2 by splitting the second coding unit 1322 in a vertical direction, or may determine the third coding unit 1324 having a size of N/2×N/4 by splitting the second coding unit 1322 in vertical and horizontal directions.

According to an embodiment, the image decoding apparatus 100 may split the square coding unit 1300, 1302, or 1304 in a horizontal or vertical direction. For example, the image decoding apparatus 100 may determine the first coding unit 1310 having a size of N×2N by splitting the first coding unit 1300 having a size of 2N×2N in a vertical direction, or may determine the first coding unit 1320 having a size of 2N×N by splitting the first coding unit 1300 in a horizontal direction. According to an embodiment, when a depth is determined based on the length of the longest side of a coding unit, a depth of a coding unit determined by splitting the first coding unit 1300 having a size of 2N×2N in a horizontal or vertical direction may be the same as the depth of the first coding unit 1300.

According to an embodiment, a width and height of the third coding unit 1314 or 1324 may be ¼ times those of the first coding unit 1310 or 1320. When a depth of the first coding unit 1310 or 1320 is D, a depth of the second coding unit 1312 or 1322, the width and height of which are ½ times those of the first coding unit 1310 or 1320, may be D+1, and a depth of the third coding unit 1314 or 1324, the width and height of which are ¼ times those of the first coding unit 1310 or 1320, may be D+2.

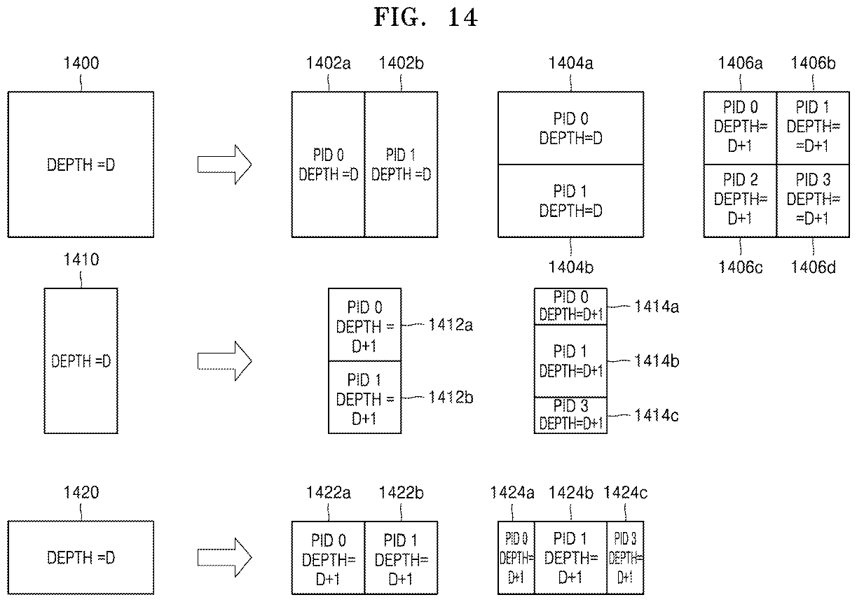

FIG. 14 illustrates depths that are determinable based on shapes and sizes of coding units, and part indexes (PIDs) that are for distinguishing the coding units, according to an embodiment.

According to an embodiment, the image decoding apparatus 100 may determine various-shape second coding units by splitting a square first coding unit 1400. Referring to FIG. 14, the image decoding apparatus 100 may determine second coding units 1402a and 1402b, 1404a and 1404b, and 1406a, 1406b, 1406c, and 1406d by splitting the first coding unit 1400 in at least one of vertical and horizontal directions based on split shape mode information. That is, the image decoding apparatus 100 may determine the second coding units 1402a and 1402b, 1404a and 1404b, and 1406a, 1406b, 1406c, and 1406d, based on the split shape mode information of the first coding unit 1400.

According to an embodiment, depths of the second coding units 1402a and 1402b, 1404a and 1404b, and 1406a, 1406b, 1406c, and 1406d that are determined based on the split shape mode information of the square first coding unit 1400 may be determined based on the length of a long side thereof. For example, because the length of a side of the square first coding unit 1400 equals the length of a long side of the non-square second coding units 1402a and 1402b, and 1404a and 1404b, the first coding unit 2100 and the non-square second coding units 1402a and 1402b, and 1404a and 1404b may have the same depth, e.g., D. However, when the image decoding apparatus 100 splits the first coding unit 1400 into the four square second coding units 1406a, 1406b, 1406c, and 1406d based on the split shape mode information, because the length of a side of the square second coding units 1406a, 1406b, 1406c, and 1406d is ½ times the length of a side of the first coding unit 1400, a depth of the second coding units 1406a, 1406b, 1406c, and 1406d may be D+1 which is deeper than the depth D of the first coding unit 1400 by 1.

According to an embodiment, the image decoding apparatus 100 may determine a plurality of second coding units 1412a and 1412b, and 1414a, 1414b, and 1414c by splitting a first coding unit 1410, a height of which is longer than a width, in a horizontal direction based on the split shape mode information. According to an embodiment, the image decoding apparatus 100 may determine a plurality of second coding units 1422a and 1422b, and 1424a, 1424b, and 1424c by splitting a first coding unit 1420, a width of which is longer than a height, in a vertical direction based on the split shape mode information.

According to an embodiment, a depth of the second coding units 1412a and 1412b, and 1414a, 1414b, and 1414c, or 1422a and 1422b, and 1424a, 1424b, and 1424c, which are determined based on the split shape mode information of the non-square first coding unit 1410 or 1420, may be determined based on the length of a long side thereof. For example, because the length of a side of the square second coding units 1412a and 1412b is ½ times the length of a long side of the first coding unit 1410 having a non-square shape, a height of which is longer than a width, a depth of the square second coding units 1412a and 1412b is D+1 which is deeper than the depth D of the non-square first coding unit 1410 by 1.

Furthermore, the image decoding apparatus 100 may split the non-square first coding unit 1410 into an odd number of second coding units 1414a, 1414b, and 1414c based on the split shape mode information. The odd number of second coding units 1414a, 1414b, and 1414c may include the non-square second coding units 1414a and 1414c and the square second coding unit 1414b. In this case, because the length of a long side of the non-square second coding units 1414a and 1414c and the length of a side of the square second coding unit 1414b are ½ times the length of a long side of the first coding unit 1410, a depth of the second coding units 1414a, 1414b, and 1414c may be D+1 which is deeper than the depth D of the non-square first coding unit 1410 by 1. The image decoding apparatus 100 may determine depths of coding units split from the first coding unit 1420 having a non-square shape, a width of which is longer than a height, by using the above-described method of determining depths of coding units split from the first coding unit 1410.

According to an embodiment, the image decoding apparatus 100 may determine PIDs for identifying split coding units, based on a size ratio between the coding units when an odd number of split coding units do not have equal sizes. Referring to FIG. 14, a coding unit 1414b of a center location among an odd number of split coding units 1414a, 1414b, and 1414c may have a width equal to that of the other coding units 1414a and 1414c and a height which is two times that of the other coding units 1414a and 1414c. That is, in this case, the coding unit 1414b at the center location may include two of the other coding unit 1414a or 1414c. Therefore, when a PID of the coding unit 1414b at the center location is 1 based on a scan order, a PID of the coding unit 1414c located next to the coding unit 1414b may be increased by 2 and thus may be 3. That is, discontinuity in PID values may be present. According to an embodiment, the image decoding apparatus 100 may determine whether an odd number of split coding units do not have equal sizes, based on whether discontinuity is present in PIDs for identifying the split coding units.

According to an embodiment, the image decoding apparatus 100 may determine whether to use a specific splitting method, based on PID values for identifying a plurality of coding units determined by splitting a current coding unit. Referring to FIG. 14, the image decoding apparatus 100 may determine an even number of coding units 1412a and 1412b or an odd number of coding units 1414a, 1414b, and 1414c by splitting the first coding unit 1410 having a rectangular shape, a height of which is longer than a width. The image decoding apparatus 100 may use PIDs indicating respective coding units so as to identify the respective coding units. According to an embodiment, the PID may be obtained from a sample of a predetermined location of each coding unit (e.g., an upper left sample).

According to an embodiment, the image decoding apparatus 100 may determine a coding unit at a predetermined location from among the split coding units, by using the PIDs for distinguishing the coding units. According to an embodiment, when the split shape mode information of the first coding unit 1410 having a rectangular shape, a height of which is longer than a width, indicates to split a coding unit into three coding units, the image decoding apparatus 100 may split the first coding unit 1410 into three coding units 1414a, 1414b, and 1414c. The image decoding apparatus 100 may assign a PID to each of the three coding units 1414a, 1414b, and 1414c. The image decoding apparatus 100 may compare PIDs of an odd number of split coding units to determine a coding unit at a center location from among the coding units. The image decoding apparatus 100 may determine the coding unit 1414b having a PID corresponding to a middle value among the PIDs of the coding units, as the coding unit at the center location from among the coding units determined by splitting the first coding unit 1410. According to an embodiment, the image decoding apparatus 100 may determine PIDs for distinguishing split coding units, based on a size ratio between the coding units when the split coding units do not have equal sizes. Referring to FIG. 14, the coding unit 1414b generated by splitting the first coding unit 1410 may have a width equal to that of the other coding units 1414a and 1414c and a height which is two times that of the other coding units 1414a and 1414c. In this case, when the PID of the coding unit 1414b at the center location is 1, the PID of the coding unit 1414c located next to the coding unit 1414b may be increased by 2 and thus may be 3. When the PID is not uniformly increased as described above, the image decoding apparatus 100 may determine that a coding unit is split into a plurality of coding units including a coding unit having a size different from that of the other coding units. According to an embodiment, when the split shape mode information indicates to split a coding unit into an odd number of coding units, the image decoding apparatus 100 may split a current coding unit in such a manner that a coding unit of a predetermined location among an odd number of coding units (e.g., a coding unit of a centre location) has a size different from that of the other coding units. In this case, the image decoding apparatus 100 may determine the coding unit of the centre location, which has a different size, by using PIDs of the coding units. However, the PIDs and the size or location of the coding unit of the predetermined location are not limited to the above-described examples, and various PIDs and various locations and sizes of coding units may be used.

According to an embodiment, the image decoding apparatus 100 may use a predetermined data unit where a coding unit starts to be recursively split.

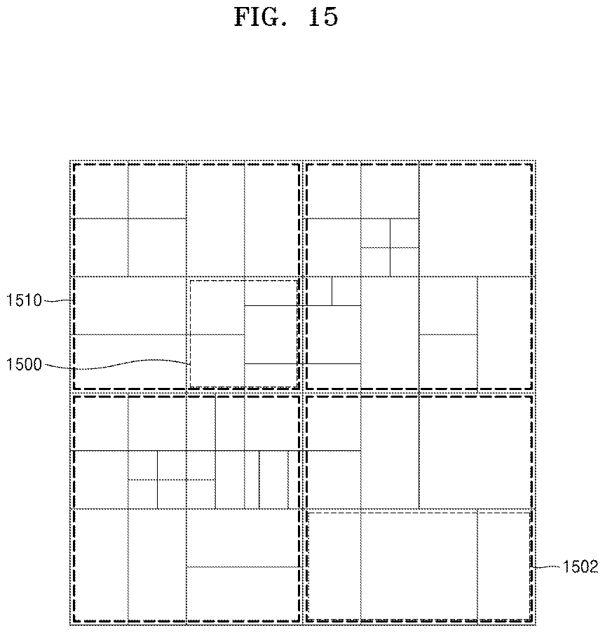

FIG. 15 illustrates that a plurality of coding units are determined based on a plurality of predetermined data units included in a picture, according to an embodiment.

According to an embodiment, a predetermined data unit may be defined as a data unit where a coding unit starts to be recursively split by using split shape mode information. That is, the predetermined data unit may correspond to a coding unit of an uppermost depth, which is used to determine a plurality of coding units split from a current picture. In the following descriptions, for convenience of explanation, the predetermined data unit is referred to as a reference data unit.

According to an embodiment, the reference data unit may have a predetermined size and a predetermined size shape. According to an embodiment, the reference data unit may include M×N samples. Herein, M and N may be equal to each other, and may be integers expressed as powers of 2. That is, the reference data unit may have a square or non-square shape, and may be split into an integer number of coding units.

According to an embodiment, the image decoding apparatus 100 may split the current picture into a plurality of reference data units. According to an embodiment, the image decoding apparatus 100 may split the plurality of reference data units, which are split from the current picture, by using the split shape mode information of each reference data unit. The operation of splitting the reference data unit may correspond to a splitting operation using a quadtree structure.

According to an embodiment, the image decoding apparatus 100 may previously determine the minimum size allowed for the reference data units included in the current picture. Accordingly, the image decoding apparatus 100 may determine various reference data units having sizes equal to or greater than the minimum size, and may determine one or more coding units by using the split shape mode information with reference to the determined reference data unit.

Referring to FIG. 15, the image decoding apparatus 100 may use a square reference coding unit 1500 or a non-square reference coding unit 1502. According to an embodiment, the shape and size of reference coding units may be determined based on various data units capable of including one or more reference coding units (e.g., sequences, pictures, slices, slice segments, largest coding units, or the like).

According to an embodiment, the bitstream obtainer 110 of the image decoding apparatus 100 may obtain, from a bitstream, at least one of reference coding unit shape information and reference coding unit size information with respect to each of the various data units. An operation of splitting the square reference coding unit 1500 into one or more coding units has been described above in relation to the operation of splitting the current coding unit 300 of FIG. 3, and an operation of splitting the non-square reference coding unit 1502 into one or more coding units has been described above in relation to the operation of splitting the current coding unit 400 or 450 of FIG. 4. Thus, detailed descriptions thereof will not be provided herein.

According to an embodiment, the image decoding apparatus 100 may use a PID for identifying the size and shape of reference coding units, to determine the size and shape of reference coding units according to some data units previously determined based on a predetermined condition. That is, the bitstream obtainer 110 may obtain, from the bitstream, only the PID for identifying the size and shape of reference coding units with respect to each slice, slice segment, or largest coding unit which is a data unit satisfying a predetermined condition (e.g., a data unit having a size equal to or smaller than a slice) among the various data units (e.g., sequences, pictures, slices, slice segments, largest coding units, or the like). The image decoding apparatus 100 may determine the size and shape of reference data units with respect to each data unit, which satisfies the predetermined condition, by using the PID. When the reference coding unit shape information and the reference coding unit size information are obtained and used from the bitstream according to each data unit having a relatively small size, efficiency of using the bitstream may not be high, and therefore, only the PID may be obtained and used instead of directly obtaining the reference coding unit shape information and the reference coding unit size information. In this case, at least one of the size and shape of reference coding units corresponding to the PID for identifying the size and shape of reference coding units may be previously determined. That is, the image decoding apparatus 100 may determine at least one of the size and shape of reference coding units included in a data unit serving as a unit for obtaining the PID, by selecting the previously determined at least one of the size and shape of reference coding units based on the PID.

According to an embodiment, the image decoding apparatus 100 may use one or more reference coding units included in a largest coding unit. That is, a largest coding unit split from a picture may include one or more reference coding units, and coding units may be determined by recursively splitting each reference coding unit. According to an embodiment, at least one of a width and height of the largest coding unit may be integer times at least one of the width and height of the reference coding units. According to an embodiment, the size of reference coding units may be obtained by splitting the largest coding unit n times based on a quadtree structure. That is, the image decoding apparatus 100 may determine the reference coding units by splitting the largest coding unit n times based on a quadtree structure, and may split the reference coding unit based on at least one of the block shape information and the split shape mode information according to various embodiments.

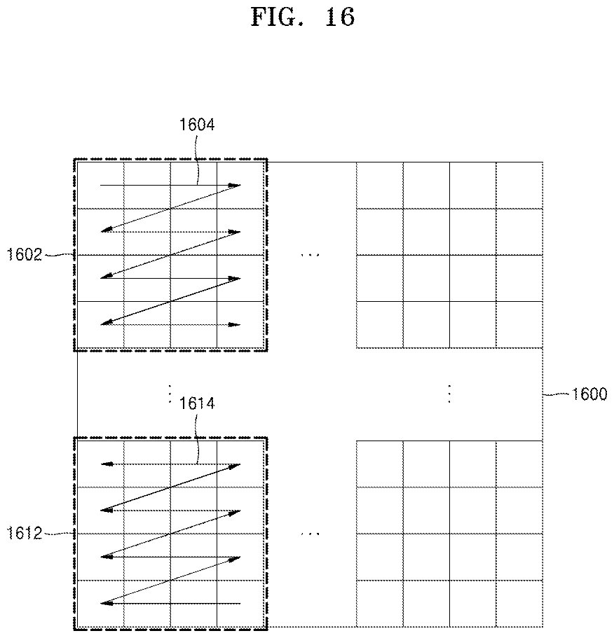

FIG. 16 illustrates a processing block serving as a criterion for determining a determination order of reference coding units included in a picture 1600, according to an embodiment.

According to an embodiment, the image decoding apparatus 100 may determine one or more processing blocks split from a picture. The processing block is a data unit including one or more reference coding units split from a picture, and the one or more reference coding units included in the processing block may be determined according to a specific order. That is, a determination order of one or more reference coding units determined in each processing block may correspond to one of various types of orders for determining reference coding units, and may vary depending on the processing block. The determination order of reference coding units, which is determined with respect to each processing block, may be one of various orders, e.g., raster scan order, Z-scan, N-scan, up-right diagonal scan, horizontal scan, and vertical scan, but is not limited to the above-mentioned scan orders.

According to an embodiment, the image decoding apparatus 100 may obtain processing block size information and may determine the size of one or more processing blocks included in the picture. The image decoding apparatus 100 may obtain the processing block size information from a bitstream and may determine the size of one or more processing blocks included in the picture. The size of processing blocks may be a predetermined size of data units, which is indicated by the processing block size information.

According to an embodiment, the bitstream obtainer 110 of the image decoding apparatus 100 may obtain the processing block size information from the bitstream according to each specific data unit. For example, the processing block size information may be obtained from the bitstream in a data unit such as an image, sequence, picture, slice, or slice segment. That is, the bitstream obtainer 110 may obtain the processing block size information from the bitstream according to each of the various data units, and the image decoding apparatus 100 may determine the size of one or more processing blocks, which are split from the picture, by using the obtained processing block size information. The size of the processing blocks may be integer times that of the reference coding units.

According to an embodiment, the image decoding apparatus 100 may determine the size of processing blocks 1602 and 1612 included in the picture 1600. For example, the image decoding apparatus 100 may determine the size of processing blocks based on the processing block size information obtained from the bitstream. Referring to FIG. 16, according to an embodiment, the image decoding apparatus 100 may determine a width of the processing blocks 1602 and 1612 to be four times the width of the reference coding units, and may determine a height of the processing blocks 1602 and 1612 to be four times the height of the reference coding units. The image decoding apparatus 100 may determine a determination order of one or more reference coding units in one or more processing blocks.

According to an embodiment, the image decoding apparatus 100 may determine the processing blocks 1602 and 1612, which are included in the picture 1600, based on the size of processing blocks, and may determine a determination order of one or more reference coding units in the processing blocks 1602 and 1612. According to an embodiment, determination of reference coding units may include determination of the size of the reference coding units.

According to an embodiment, the image decoding apparatus 100 may obtain, from the bitstream, determination order information of one or more reference coding units included in one or more processing blocks, and may determine a determination order with respect to one or more reference coding units based on the obtained determination order information. The determination order information may be defined as an order or direction for determining the reference coding units in the processing block. That is, the determination order of reference coding units may be independently determined with respect to each processing block.

According to an embodiment, the image decoding apparatus 100 may obtain, from the bitstream, the determination order information of reference coding units according to each specific data unit. For example, the bitstream obtainer 110 may obtain the determination order information of reference coding units from the bitstream according to each data unit such as an image, sequence, picture, slice, slice segment, or processing block. Because the determination order information of reference coding units indicates an order for determining reference coding units in a processing block, the determination order information may be obtained with respect to each specific data unit including an integer number of processing blocks.

According to an embodiment, the image decoding apparatus 100 may determine one or more reference coding units based on the determined determination order.

According to an embodiment, the bitstream obtainer 110 may obtain the determination order information of reference coding units from the bitstream as information related to the processing blocks 1602 and 1612, and the image decoding apparatus 100 may determine a determination order of one or more reference coding units included in the processing blocks 1602 and 1612 and determine one or more reference coding units, which are included in the picture 1600, based on the determination order. Referring to FIG. 16, the image decoding apparatus 100 may determine determination orders 1604 and 1614 of one or more reference coding units in the processing blocks 1602 and 1612, respectively. For example, when the determination order information of reference coding units is obtained with respect to each processing block, different types of the determination order information of reference coding units may be obtained for the processing blocks 1602 and 1612. When the determination order 1604 of reference coding units in the processing block 1602 is a raster scan order, reference coding units included in the processing block 1602 may be determined according to a raster scan order. On the contrary, when the determination order 1614 of reference coding units in the other processing block 1612 is a backward raster scan order, reference coding units included in the processing block 1612 may be determined according to the backward raster scan order.

According to an embodiment, the image decoding apparatus 100 may decode the determined one or more reference coding units. The image decoding apparatus 100 may decode an image, based on the reference coding units determined as described above. A method of decoding the reference coding units may include various image decoding methods.

According to an embodiment, the image decoding apparatus 100 may obtain block shape information indicating the shape of a current coding unit or split shape mode information indicating a splitting method of the current coding unit, from the bitstream, and may use the obtained information. The split shape mode information may be included in the bitstream related to various data units. For example, the image decoding apparatus 100 may use the split shape mode information included in a sequence parameter set, a picture parameter set, a video parameter set, a slice header, or a slice segment header. Furthermore, the image decoding apparatus 100 may obtain, from the bitstream, a syntax element corresponding to the block shape information or the split shape mode information according to each largest coding unit, each reference coding unit, or each processing block, and may use the obtained syntax element.

Hereinafter, a method of determining a split rule, according to an embodiment of the disclosure will be described in detail.

The image decoding apparatus 100 may determine a split rule of an image. The split rule may be pre-determined between the image decoding apparatus 100 and the image encoding apparatus 200. The image decoding apparatus 100 may determine the split rule of the image, based on information obtained from a bitstream. The image decoding apparatus 100 may determine the split rule based on the information obtained from at least one of a sequence parameter set, a picture parameter set, a video parameter set, a slice header, and a slice segment header. The image decoding apparatus 100 may determine the split rule differently according to frames, slices, temporal layers, largest coding units, or coding units.

The image decoding apparatus 100 may determine the split rule based on a block shape of a coding unit. The block shape may include a size, shape, a ratio of width and height, and a direction of the coding unit. The image encoding apparatus 200 and the image decoding apparatus 100 may pre-determine to determine the split rule based on the block shape of the coding unit. However, an embodiment is not limited thereto. The image decoding apparatus 100 may determine the split rule based on the information obtained from the bitstream received from the image encoding apparatus 200.

The shape of the coding unit may include a square and a non-square. When the lengths of the width and height of the coding unit are the same, the image decoding apparatus 100 may determine the shape of the coding unit to be a square. Also, when the lengths of the width and height of the coding unit are not the same, the image decoding apparatus 100 may determine the shape of the coding unit to be a non-square.

The size of the coding unit may include various sizes, such as 4×4, 8×4, 4×8, 8×8, 16×4, 16×8, and to 256×256. The size of the coding unit may be classified based on the length of a long side of the coding unit, the length of a short side, or the area. The image decoding apparatus 100 may apply the same split rule to coding units classified as the same group. For example, the image decoding apparatus 100 may classify coding units having the same lengths of the long sides as having the same size. Also, the image decoding apparatus 100 may apply the same split rule to coding units having the same lengths of long sides.

The ratio of the width and height of the coding unit may include 1:2, 2:1, 1:4, 4:1, 1:8, 8:1, 1:16, 16:1, 32:1, 1:32, or the like. Also, a direction of the coding unit may include a horizontal direction and a vertical direction. The horizontal direction may indicate a case in which the length of the width of the coding unit is longer than the length of the height thereof. The vertical direction may indicate a case in which the length of the width of the coding unit is shorter than the length of the height thereof.

The image decoding apparatus 100 may adaptively determine the split rule based on the size of the coding unit. The image decoding apparatus 100 may differently determine an allowable split shape mode based on the size of the coding unit. For example, the image decoding apparatus 100 may determine whether splitting is allowed based on the size of the coding unit. The image decoding apparatus 100 may determine a split direction according to the size of the coding unit. The image decoding apparatus 100 may determine an allowable split type according to the size of the coding unit.

The split rule determined based on the size of the coding unit may be a split rule pre-determined between the image encoding apparatus 200 and the image decoding apparatus 100. Also, the image decoding apparatus 100 may determine the split rule based on the information obtained from the bitstream.

The image decoding apparatus 100 may adaptively determine the split rule based on a location of the coding unit. The image decoding apparatus 100 may adaptively determine the split rule based on the location of the coding unit in the image.

Also, the image decoding apparatus 100 may determine the split rule such that coding units generated via different splitting paths do not have the same block shape. However, an embodiment is not limited thereto, and the coding units generated via different splitting paths have the same block shape. The coding units generated via the different splitting paths may have different decoding processing orders. Because the decoding processing orders have been described above with reference to FIG. 12, details thereof are not provided again.

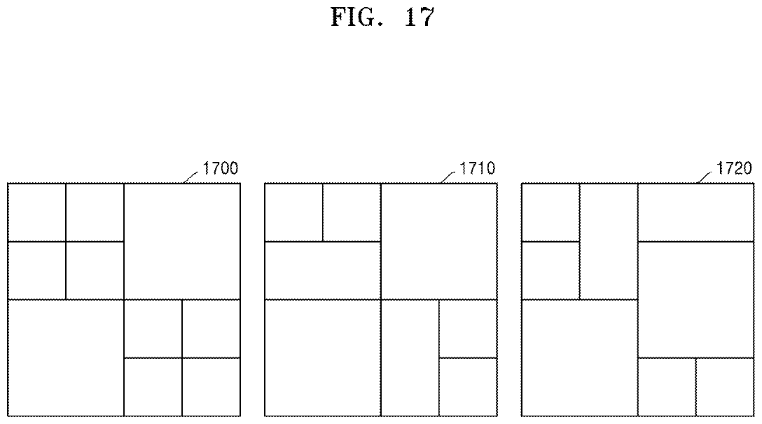

FIG. 17 illustrates coding units that may be determined for each picture when a combination of shapes into which a coding unit is splittable is different for each picture, according to an embodiment.

Referring to FIG. 17, the image decoding apparatus 100 may determine a combination of split shapes into which a coding unit is splittable to be different for each picture. For example, the image decoding apparatus 100 may decode an image by using a picture 1700 splittable into 4 coding units, a picture 1710 splittable into 2 or 4 coding units, and a picture 1720 splittable into 2, 3, or 4 coding units, among at least one picture included in the image. The image decoding apparatus 100 may only use split shape information indicating a split into 4 square coding units so as to split the picture 1700 into a plurality of coding units. The image decoding apparatus 100 may only use split shape information indicating a split into 2 or 4 coding units so as to split the picture 1710. The image decoding apparatus 100 may only use split shape information indicating a split into 2, 3, or 4 coding units so as to split the picture 1720. Because the above combinations of split shapes are only embodiments for describing operations of the image decoding apparatus 100, the combinations of split shapes should not be interpreted limitedly to the embodiments and it should be interpreted that various types of combinations of split shapes may be used for each of certain data units.

According to an embodiment, the bitstream obtainer 110 of the image decoding apparatus 100 may obtain a bitstream including an index indicating a combination of split shape information for each of certain data units (for example, a sequence, a picture, or slice). For example, the bitstream obtainer 110 may obtain an index indicating a combination of split shape information from a sequence parameter set, a picture parameter set, or a slice header. The image decoding apparatus 100 may determine a combination of split shapes of coding units into which a certain data unit is splittable by using the obtained index, and accordingly, different combinations of split shapes may be used for each of certain data units.

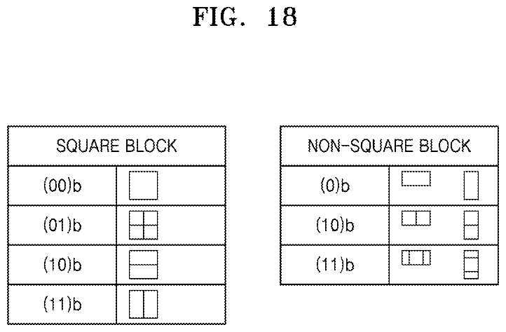

FIG. 18 illustrates various shapes of a coding unit that may be determined based on split shape mode information representable in a binary code, according to an embodiment.

According to an embodiment, the image decoding apparatus 100 may split a coding unit into various shapes by using block shape information and split shape mode information obtained via the bitstream obtainer 110. Splittable shapes of a coding unit may correspond to various shapes including shapes described through above embodiments.

Referring to FIG. 18, the image decoding apparatus 100 may split a square coding unit in at least one of a horizontal direction and a vertical direction, based on split shape mode information, and split a non-square coding unit in a horizontal direction or a vertical direction.

According to an embodiment, when the image decoding apparatus 100 is capable of splitting a square coding unit in a horizontal direction and a vertical direction to obtain 4 square coding units, 4 split shapes may be indicated by split shape mode information for the square coding unit. According to an embodiment, the split shape mode information may be represented as a 2-digit binary code and a binary code may be assigned for each split shape. For example, when a coding unit is not split, split shape mode information may be represented as (00)b, when a coding unit is split in a horizontal direction and a vertical direction, split shape mode information may be represented as (01)b, when a coding unit is split in a horizontal direction, split shape mode information may be represented as (10)b, and when a coding unit is split in a vertical direction, split shape mode information may be represented as (11)b.

According to an embodiment of the image decoding apparatus 100, when a non-square coding unit is split in a horizontal direction or a vertical direction, a type of split shape indicated by split shape mode information may be determined based on the split number of coding units. Referring to FIG. 18, the image decoding apparatus 100 may split the non-square coding unit up to 3 coding units, according to an embodiment. The image decoding apparatus 100 may split a coding unit into two coding units and in this case, split shape mode information may be represented as (10)b. The image decoding apparatus 100 may split a coding unit into three coding units and in this case, split shape mode information may be represented as (11)b. The image decoding apparatus 100 may determine not to split a coding unit and in this case, split shape mode information may be represented as (0)b. In other words, the image decoding apparatus 100 may use variable length coding (VLC) instead of fixed length coding (FLC) so as to use a binary code indicating split shape mode information.

According to an embodiment, referring to FIG. 18, a binary code of split shape mode information indicating that a coding unit is not split may be represented as (0)b. When a binary code of split shape mode information indicating that a coding unit is not split is set to (00)b, binary codes of split shape mode information of 2-bit are all used despite that there is no split shape mode information set as (01)b. However, as shown in FIG. 18, when 3 types of split shapes are used for a non-square coding unit, the image decoding apparatus 100 is able to determine that a coding unit is not split even by using one-bit binary code (0)b as split shape mode information, and thus a bitstream may be efficiently used. However, split shapes of a non-square coding unit indicated by split shape mode information should not be interpreted limitedly to 3 shapes described with reference to FIG. 18, and should be interpreted as various shapes including the above-described embodiments.

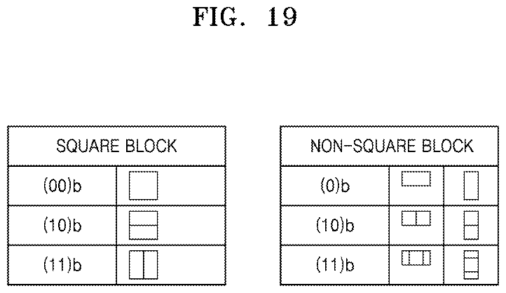

FIG. 19 illustrates other shapes of a coding unit that may be determined based on split shape mode information representable in a binary code, according to an embodiment.

Referring to FIG. 19, the image decoding apparatus 100 may split a square coding unit in a horizontal direction or a vertical direction, based on split shape mode information, and split a non-square coding unit in a horizontal direction or a vertical direction. In other words, split shape mode information may indicate that a square coding unit is split in one direction. In this case, a binary code of split shape mode information indicating that a square coding unit is not split may be represented as (0)b. When a binary code of split shape mode information indicating that a coding unit is not split is set to (00)b, binary codes of split shape mode information of 2-bit are all used despite that there is no split shape mode information set as (01)b. However, as shown in FIG. 19, when 3 types of split shapes are used for a square coding unit, the image decoding apparatus 100 is able to determine that a coding unit is not split even by using one-bit binary code (0)b as split shape mode information, and thus a bitstream may be efficiently used. However, split shapes of a square coding unit indicated by split shape mode information should not be interpreted limitedly to 3 shapes described with reference to FIG. 19, and should be interpreted as various shapes including the above-described embodiments.

According to an embodiment, block shape information or split shape mode information may be represented by using a binary code, and such information may be immediately generated as a bitstream. Alternatively, the block shape information or split shape mode information represented in a binary code may be used as a binary code input during context adaptive binary arithmetic coding (CABAC) without being immediately generated as a bitstream.

According to an embodiment, a process in which the image decoding apparatus 100 obtains syntax regarding block shape information or split shape mode information via CABAC will be described. A bitstream including a binary code of the syntax may be obtained via the bitstream obtainer 110. The image decoding apparatus 100 may detect a syntax element indicating block shape information or split shape mode information by inverse-binarizing a bin string included in the obtained bitstream. According to an embodiment, the image decoding apparatus 100 may obtain a set of binary bin strings corresponding to a syntax element to be decoded and decode each bin by using probability information, and may repeat such operations until a bin string including the decoded bins becomes the same as one of previously obtained bin strings. The image decoding apparatus 100 may determine the syntax element by performing inverse binarization on the bin string.

According to an embodiment, the image decoding apparatus 100 may determine the syntax for the bin string by performing a decoding process of adaptive binary arithmetic coding, and update a probability model for the bins obtained via the bitstream obtainer 110. Referring to FIG. 18, the bitstream obtainer 110 of the image decoding apparatus 100 may obtain the bitstream indicating the binary code indicating the split shape mode information, according to an embodiment. The image decoding apparatus 100 may determine the syntax for the split shape mode information by using the binary code having a size of 1 bit or 2 bits. The image decoding apparatus 100 may update a probability for each bit among the 2-bit binary code so as to determine the syntax for the split shape mode information. In other words, the image decoding apparatus 100 may update a probability of having a value of 0 or 1 when decoding a next bin, based on whether a value of a first bin among the 2-bit binary code is 0 or 1.

According to an embodiment, the image decoding apparatus 100 may update, while determining syntax, a probability for bins used while decoding bins of a bin string for the syntax, and may determine that certain bits of the bin string have the same probability without updating the probability.

Referring to FIG. 18, while determining syntax by using a bin string indicating split shape mode information for a non-square coding unit, the image decoding apparatus 100 may determine the syntax for the split shape mode information by using one bin having a value of 0 when the non-square coding unit is not split. In other words, when block shape information indicates that a current coding unit has a non-square shape, a first bin of a bin string for split shape mode information may be 0 when a non-square coding unit is not split and may be 1 when the non-square coding unit is split into 2 or 3 coding units. Accordingly, a probability in which the first bin of the bin string of the split shape mode information for the non-square coding unit is 0 is ⅓, and a probability in which the first bin of the bin string of the split shape mode information for the non-square coding unit is 1 is ⅔. As described above, because split shape mode information indicating that a non-square coding unit is not split is represents only a 1-bit bin string having a value of 0, the image decoding apparatus 100 may determine syntax for the split shape mode information by determining whether a second bin is 0 only when a first bin of the split shape mode information is 1. According to an embodiment, when the first bin of the split shape mode information is 1, the image decoding apparatus 100 may decode bins considering that probabilities of the second bin being 0 and 1 are the same.

According to an embodiment, the image decoding apparatus 100 may use various probabilities for each bin while determining the bins of the bin string for the split shape mode information. According to an embodiment, the image decoding apparatus 100 may differently determine the probabilities of the bins for the split shape mode information, based on a direction of a non-square block. According to an embodiment, the image decoding apparatus 100 may differently determine the probabilities of the bins for the split shape mode information, based on an area or a length of long side of a current coding unit. According to an embodiment, the image decoding apparatus 100 may differently determine the probabilities of the bins for the split shape mode information, based on at least one of the area or the length of long side of the current coding unit.

According to an embodiment, the image decoding apparatus 100 may determine that probabilities of bins for split shape mode information are the same with respect to coding units of a certain size or greater. For example, it may be determined that the probabilities of the bins for the split shape mode information are the same for coding units of a size of 64 samples or greater, based on the length of long side of the coding unit.

According to an embodiment, the image decoding apparatus 100 may determine initial probabilities of the bins included in the bin string of the split shape mode information, based on a slice type (for example, an I-slice, a P-slice, or a B-slice).

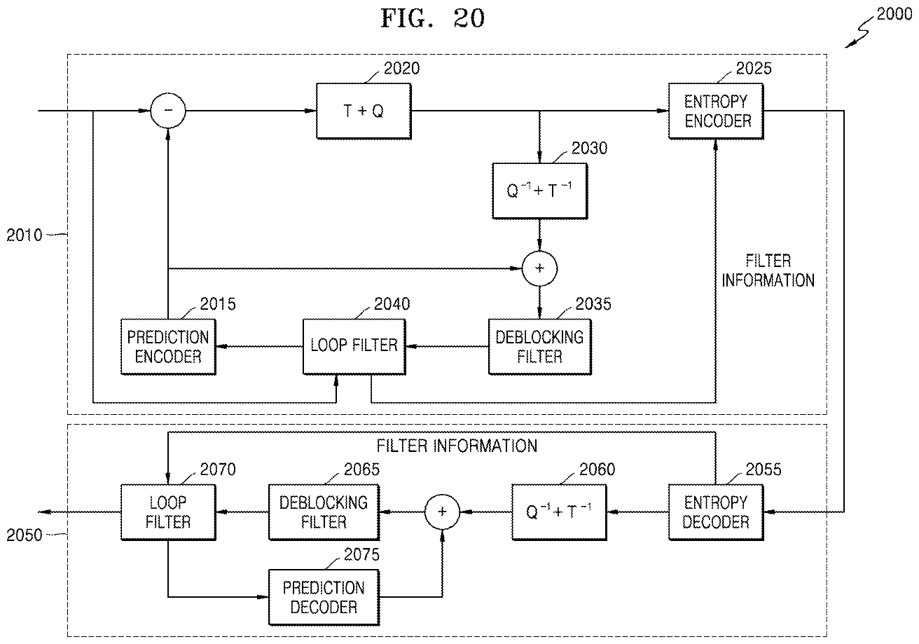

FIG. 20 is a block diagram of an image encoding and decoding system.

An encoding end 2010 of an image encoding and decoding system 2000 transmits an encoded bitstream of an image and a decoding end 2050 outputs a reconstructed image by receiving and decoding the bitstream. Here, the encoding end 2010 may have a similar configuration to the image encoding apparatus 200 described later, and the decoding end 2050 may have a similar configuration to the image decoding apparatus 100.

At the encoding end 2010, a prediction encoder 2015 outputs a reference image via inter prediction and intra prediction, and a transformer and quantizer 2020 transforms and quantizes residual data between the reference picture and a current input image to a quantized transform coefficient and outputs the quantized transform coefficient. An entropy encoder 2025 encodes the quantized transform coefficient, and outputs the encoded quantized transform coefficient as a bitstream. The quantized transform coefficient is reconstructed as data of a spatial domain via an inverse quantizer and inverse transformer 2030, and the data of the spatial domain is output as a reconstructed image via a deblocking filter 2035 and a loop filter 2040. The reconstructed image may be used as a reference image of a next input image via the prediction encoder 2015.

Encoded image data among the bitstream received by the decoding end 2050 is reconstructed as residual data of a spatial domain via an entropy decoder 2055 and an inverse quantizer and inverse transformer 2060. Image data of a spatial domain is configured when a reference image and residual data output from a prediction decoder 2075 are combined, and a deblocking filter 2065 and a loop filter 2070 may output a reconstructed image regarding a current original image by performing filtering on the image data of the spatial domain. The reconstructed image may be used by the prediction decoder 2075 as a reference image for a next original image.

The loop filter 2040 of the encoding end 2010 performs loop filtering by using filter information input according to a user input or system setting. The filter information used by the loop filter 2040 is output to the encoding end 2010 and transmitted to the decoding end 2050 together with the encoded image data. The loop filter 2070 of the decoding end 2050 may perform loop filtering based on the filter information input from the decoding end 2050.

The above-described various embodiments describe operations related to an image decoding method performed by the image decoding apparatus 100. Hereinafter, operations of the image encoding apparatus 200 performing an image encoding method corresponding to an inverse procedure of the image decoding method will be described via various embodiments.

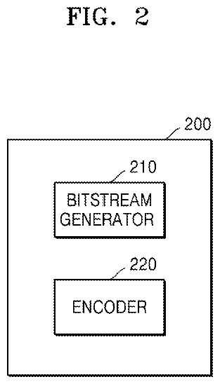

FIG. 2 is a block diagram of the image encoding apparatus 200 capable of encoding an image based on at least one of block shape information and split shape mode information, according to an embodiment.

The image encoding apparatus 200 may include an encoder 220 and a bitstream generator 210. The encoder 220 may receive an input image and encode the input image. The encoder 220 may obtain at least one syntax element by encoding the input image. The syntax element may include at least one of a skip flag, a prediction mode, a motion vector difference, a motion vector prediction method (or index), a transform quantized coefficient, a coded block pattern, a coded block flag, an intra prediction mode, a direct flag, a merge flag, a delta QP, a reference index, a prediction direction, and a transform index. The encoder 220 may determine a context model based on block shape information including at least one of a shape, direction, ratio of width and height, or size of a coding unit.

The bitstream generator 210 may generate a bitstream based on the encoded input image. For example, the bitstream generator 210 may generate the bitstream by entropy-encoding the syntax element, based on the context model. Also, the image encoding apparatus 200 may transmit the bitstream to the image decoding apparatus 100.

According to an embodiment, the encoder 220 of the image encoding apparatus 200 may determine a shape of a coding unit. For example, the coding unit may have a square shape or a non-share shape, and information indicating such a shape may be included in block shape information.

According to an embodiment, the encoder 220 may determine in which shape a coding unit is to be split. The encoder 220 may determine a shape of at least one coding unit included in the coding unit, and the bitstream generator 210 may generate a bitstream including split shape mode information including information about such a shape of the coding unit.

According to an embodiment, the encoder 220 may determine whether a coding unit is to be split or not to be split. When the encoder 220 determines that only one coding unit is included in the coding unit or that the coding unit is not split, the bitstream generator 210 may generate a bitstream including split shape mode information indicating that the coding unit is not split. Also, the encoder 220 may split the coding unit into a plurality of coding units, and the bitstream generator 210 may generate the bitstream including split shape mode information indicating that the coding unit is split into the plurality of coding units.

According to an embodiment, information indicating the number of coding units into which the coding unit is to be split or a direction of splitting the coding unit may be included in the split shape mode information. For example, the split shape mode information may indicate that the coding unit is split in at least one of a vertical direction and a horizontal direction or is not split.

The image encoding apparatus 200 determines information about a split shape mode, based on a split shape mode of a coding unit. The image encoding apparatus 200 may determine a context model based on at least one of a shape, direction, ratio of width and height, or size of a coding unit. Also, the image encoding apparatus 200 generates a bitstream including information about the split shape mode for splitting the coding unit based on the context model.

The image encoding apparatus 200 may obtain an array for mapping an index for the context model and at least one of the shape, direction, ratio of width and height, or size of the coding unit to determine the context model. The image encoding apparatus 200 may obtain, from the array, the index for the context model, based on at least one of the shape, direction, ratio of width and height, or size of the coding unit. The image encoding apparatus 200 may determine the context model, based on the index for the context model.

The image encoding apparatus 200 may determine the context model further based on block shape information including at least one of a shape, direction, ratio of width and height, or size of a neighboring coding unit adjacent to the coding unit, to determine the context model. Here, the neighboring coding unit may include at least one of a coding unit located at bottom left, left, top left, top, right, top right, or bottom right of the coding unit.

Also, the image encoding apparatus 200 may compare the length of width of the top neighboring coding unit and the length of width of the coding unit to determine the context model. Also, the image encoding apparatus 200 may compare the lengths of heights of the left and right neighboring coding units and the length of height of the coding unit. Also, the image encoding apparatus 200 may determine the context model, based on comparison results.

Because operations of the image encoding apparatus 200 include similar content to operations of the image decoding apparatus 100 described above, detailed descriptions will be omitted.

Hereinafter, the image decoding apparatus 2100 and the image encoding apparatus 3700 according to an embodiment will be described with reference to FIGS. 21 through 38.

FIG. 21 is a block diagram of the image decoding apparatus 2100 according to an embodiment.

Referring to FIG. 21, the image decoding apparatus 2100 according to an embodiment may include an obtainer 2110 and a motion information decoder 2130.

The image decoding apparatus 2100 may obtain a bitstream generated as a result of encoding an image and decode motion information for inter prediction based on information included in the bitstream.

The image decoding apparatus 2100 according to an embodiment may include a central processor (not shown) for controlling the obtainer 2110 and the motion information decoder 2130. Alternatively, the obtainer 2110 and the motion information decoder 2130 may operate respectively by their own processors (not shown), and the processors may operate systematically such that the image decoding apparatus 2100 operates as a whole. Alternatively, the obtainer 2110 and the motion information decoder 2130 may be controlled under control of an external processor (not shown) of the image decoding apparatus 2100.

The image decoding apparatus 2100 may include at least one data storage (not shown) storing input and output data of the obtainer 2110 and motion information decoder 2130. The image decoding apparatus 2100 may include a memory controller (not shown) for controlling data input and output of the data storage.

The image decoding apparatus 2100 may perform an image decoding operation including prediction by connectively operating with an internal video decoding processor or an external video decoding processor so as to reconstruct an image via image decoding. The internal video decoding processor of the image decoding apparatus 2100 according an embodiment may perform a basic image decoding operation as a separate processor, or a central processing unit or a graphics processing unit may include an image decoding processing module and may perform a basic image decoding operation.

The image decoding apparatus 2100 may be included in the image decoding apparatus 100 described above. For example, the obtainer 2110 may be included in the bitstream obtainer 110 of the image decoding apparatus 100 of FIG. 1, and the motion information decoder 2130 may be included in the decoder 120 of the image decoding apparatus 100.

The obtainer 2110 receives a bitstream generated as a result of encoding an image. The bitstream may include information for determining a motion vector used for inter prediction of a current block. The current block is a block generated when an image is split according to a tree structure, and for example, may correspond to a largest coding unit, a coding unit, or a transform unit.

The motion information decoder 2130 may determine the current block based on block shape information and/or information about a split shape mode, which are included in at least one of a sequence parameter set, a picture parameter set, a video parameter set, a slice header, and a slice segment header. In addition, the obtainer 2110 may obtain, from the bitstream, a syntax element corresponding to the block shape information or the information about split shape mode for each largest coding unit, reference coding unit, or processing block, and the motion information decoder 2130 may use the obtained information to determine the current block.

The bitstream may include information indicating a prediction mode of the current block, and the prediction mode of the current block may include at least one of an intra mode, an inter mode, a merge mode, a direct mode, a skip mode, and a pre-set mode according to the present disclosure. The pre-set mode may be a mode determining a motion vector of the current block by changing a base motion vector of the current block according to a variation distance and a variation direction.

According to an embodiment, the bitstream may include at least one of information indicating whether the pre-set mode is applied to the current block, information indicating the base motion vector of the current block, information indicating a usage direction of the base motion vector of the current block, information indicating whether a refine process is performed on the motion vector of the current block, information indicating the variation distance, information indicating the variation direction, information indicating a priority of base motion vector candidates, information indicating a priority of variation distance candidates, and information indicating a priority of variation direction candidates.

The obtainer 2110 may obtain the information included in the bitstream from a level corresponding to at least one unit among a coding unit, a transform unit, a largest coding unit, a slice unit, and a picture unit.

The motion information decoder 2130 determines the motion vector of the current block based on the information included in the bitstream.

The motion information decoder 2130 may verify whether the pre-set mode is applied to the current block, based on the information included in the bitstream. The information indicating whether the pre-set mode is applied may include a flag or an index.

According to an embodiment, when it is verified that a prediction mode different from the pre-set mode is applied to the current block, the obtainer 2110 may obtain the information indicating whether the pre-set mode is applied to the current block. For example, when a skip mode or a merge mode is applied to the current block, the information indicating whether the pre-set mode is applied may be extracted from the bitstream.

According to an embodiment, the obtainer 2110 may not extract, from the bitstream, the information indicating whether the pre-set mode is applied, and the motion information decoder 2130 may determine whether the pre-set mode is applied to the current block, based on information related to at least one of a current block, a pre-decoded block, a current slice, a pre-decoded slice, a current picture, and a pre-decoded picture. In this case, the motion information decoder 2130 may determine whether the pre-set mode is applied in the same criterion as the image encoding apparatus 3700.

When the pre-set mode is applied to the current block, the motion information decoder 2130 may determine a second group (or a second list) including base motion vector candidates, based on a first group (or a first list) including motion vector candidates. Then, the motion information decoder 2130 may determine the base motion vector of the current block from the second group, based on the information obtained from the bitstream.

The first group including the motion vector candidate may be determined based on at least one motion vector among a spatial neighboring block and temporal neighboring block related to the current block.

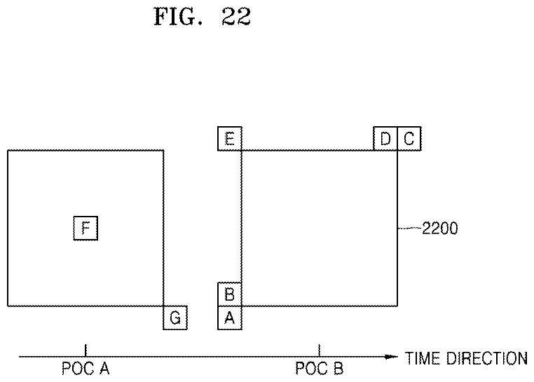

FIG. 22 is a diagram for describing a spatial neighboring block and a temporal neighboring block related to a current block 2200. Referring to FIG. 22, the temporal neighboring block may include at least one of a block F located at a same point as the current block 2200 in a reference image having a different picture order count (POC) from that of the current image, and a block G spatially adjacent to the block F. The spatial neighboring block spatially related to the current block 2200 may include a lower left outer block A, a lower left block B, an upper right outer block C, an upper right block D, and an upper left outer block E. However, locations of neighboring blocks shown in FIG. 22 are only examples, and locations of temporal neighboring blocks and spatial neighboring blocks may vary according to an embodiment.

According to an embodiment, the first group may correspond to a merge candidate list determined under a merge mode. In the merge mode, a motion vector of a neighboring block available when a spatial neighboring block and/or a temporal neighboring block related to a current block are scanned according to a certain order.

According to an embodiment, the motion information decoder 2130 may combine motion vectors of neighboring blocks related to a current block according to a certain equation and determine the first group including a result of the combination.

According to an embodiment, the motion information decoder 2130 may use the first group itself as the second group of the base motion vector candidates. In this case, the motion information decoder 2130 may determine the base motion vector of the current block among the motion vector candidates included in the first group.

According to another embodiment, the motion information decoder 2130 may determine the second group by removing or changing some of the motion vector candidates in the first group, and determine the base motion vector of the current block among the base motion vector candidates included in the second group.

The motion information decoder 2130 may apply template matching or bilateral matching to the motion vector candidates included in the first group so as to determine the second group. The motion information decoder 2130 may apply the template matching to a motion vector candidate in a uni-direction and apply the bilateral matching to a motion vector candidate in a bi-direction among the motion vector candidates included in the first group.

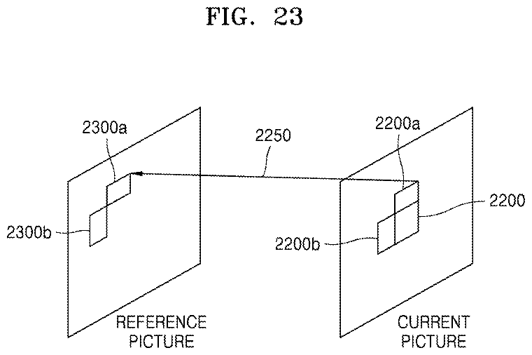

Referring to FIG. 23, when one motion vector candidate included in a first group is a motion vector in a uni-direction, the motion information decoder 2130 may determine, from a current picture, reference blocks 2300a and 2300b indicated by a motion vector candidate 2250 by using, as templates 2200a and 2200b, neighboring blocks decoded before decoding of the current block 2200. Then, the motion information decoder 2130 may calculate a distortion value corresponding to the motion vector candidate 2250 based on a difference between the reference blocks 2300a and 2300b and the templates 2200a and 2200b. The distortion value may be high when the difference between pixel values of the reference blocks 2300a and 2300b and the templates 2200a and 2200b are large.

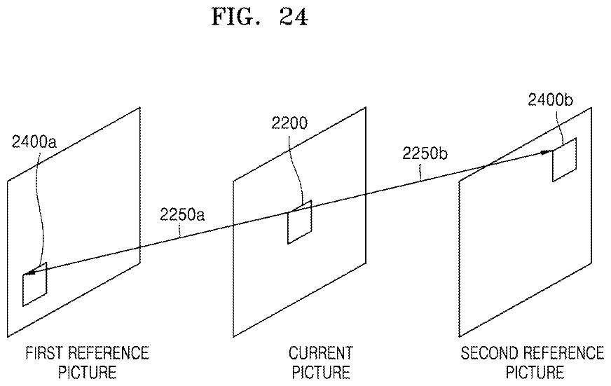

Also, referring to FIG. 24, when one motion vector candidate included in the first group is a motion vector in a bi-direction, the motion information decoder 2130 may calculate a distortion value corresponding to motion vector candidates 2250a and 2250b in a bi-direction, based on a difference between a first reference block 2400a indicated by the motion vector candidate 2250a in a list 0 direction and a second reference block 2400b indicated by the motion vector candidate 2250b in a list 1 direction.

When the distortion value of each of the motion vector candidates included in the first group is calculated, the motion information decoder 2130 may determine the second group including at least some of the motion vector candidates included in the first group, based on the distortion value. For example, the motion information decoder 2130 may add motion vector candidates having a distortion value equal to or less than a pre-set value to the second group. Also, for example, the motion information decoder 2130 may determine the second group by excluding, from the first group, motion vector candidates having a distortion value greater than the pre-set value.

According to an embodiment, the motion information decoder 2130 may refine (or change) each of the motion vector candidates included in the first group according to template matching or bilateral matching, and determine the second group including the refined motion vector candidates.

According to an embodiment, when one motion vector candidate included in the first group is a motion vector in a uni-direction, the motion information decoder 2130 may determine a reference block indicated by the motion vector candidate by using a neighboring block decoded before decoding of a current block in a current picture as a template. Then, the motion information decoder 2130 may search a certain search range based on the reference block for a block of which a difference with the template is the smallest, and refine the motion vector candidate in the first group to a motion vector indicated by a searched block.

According to another embodiment, when one motion vector candidate included in the first group is a motion vector in a bi-direction, the motion information decoder 2130 may determine an average block of a first reference block indicated by a motion vector candidate in a list 0 direction and a second reference block indicated by a motion vector candidate in a list 1 direction as a template. The average block may include an average value of pixel values of the first reference block and pixel values of the second reference block. Then, the motion information decoder 2130 may search a certain search range based on each of the first reference block and the second reference block in a first reference picture and a second reference picture for blocks of which a difference from the template is the smallest, and refine the motion vector candidate in the first group to a motion vector indicating searched blocks.

According to another embodiment, the motion information decoder 2130 may refine the motion vector candidates included in the first group as described above, and then determine the second group including refined motion vector candidates having the distortion value equal to or less than the pre-set value among the refined motion vector candidates.

According to another embodiment, the motion information decoder 2130 may generate the second group via template matching and/or bilateral matching without considering the first group. In other words, the motion information decoder 2130 may determine the second group including the base motion vector candidates of the current block via decoder side motion vector derivation (DSMVD). According to an embodiment, the motion information decoder 2130 may search for blocks of which a difference from the template is the smallest in at least some of reference pictures included in a list 0 and reference pictures included in list 1 corresponding to the current block, and add motion vectors indicating the searched blocks to the second group. When template matching is performed on one reference picture of list 0 or list 1, the template may be a neighboring block decoded before decoding of the current block in a current picture. When bilateral matching is performed on the reference picture of list 0 and the reference picture of list 1, the template may be an average block of the reference block in the reference picture of list 0 and the reference block in the reference picture of list 1.

According to an embodiment, the motion information decoder 2130 may add a zero vector to the second group. Also, the motion information decoder 2130 may combine two base motion vector candidates in a uni-direction included in the second group to generate one new base motion vector candidate in a bi-direction, and add the new base motion vector candidate in the bi-direction to the second group. In this case, the motion information decoder 2130 may combine a motion vector candidate in the list 0 direction and a motion vector candidate in the list 1 direction, of which a distortion value is the smallest, among the base motion vector candidates included in the second group.

According to an embodiment, the motion information decoder 2130 may exclude a second base motion vector candidate from the second group when a difference between a first base motion vector candidate and the second base motion vector candidate among the base motion vector candidates included in the second group is equal to or less than a pre-set value. For example, the second base motion vector candidate may be excluded from the second group when a distance between the first base motion vector candidate and the second base motion vector candidate is equal to or less than the pre-set value. Alternatively, the second base motion vector candidate may be excluded from the second group when a value obtained by combining a difference between an x-component value of the first base motion vector candidate and an x-component value of the second base motion vector candidate and a difference between a y-component value of the first base motion vector candidate and a y-component value of the second base motion vector candidate is equal to or less than a pre-set value. In the pre-set mode according to an embodiment of the present disclosure, because the base motion vector is adjusted via the variation distance and the variation direction when the base motion vector is determined, by excluding not only the same base motion vector candidate but also a similar base motin vector candidate from the second group, motion vector search at various points is enabled.

According to an embodiment, when a difference between one motion vector candidate and a base motion vector candidate already included in the second group is equal to or less than a pre-set value while configuring the second group, the motion information decoder 2130 may not add the corresponding motion vector candidate to the second group.

When the second group is determined, the motion information decoder 2130 may determine the base motion vector of the current block based on the information included in the bitstream among the base motion vector candidates included in the second group.

Information indicating the base motion vector of the current block may be encoded via a fixed length coding (FLC) method, a unary coding method, or a truncated unary coding method, and then included in the bitstream.

According to an embodiment, when the number of base motion vector candidates included in the second group is 1, the obtainer 2110 may not extract, from the bitstream, information for determining the base motion vector of the current block. In this case, the motion information decoder 2130 may determine the one base motion vector candidate as the base motion vector of the current block.

According to an embodiment, an index may be assigned to each of the base motion vector candidates included in the second group. The number of bits representing an index is increased from a base motion vector candidate having an index of 0 to a base motion vector candidate having an index of n (n is a natural number greater than 0), and a priority between the base motion vector candidates for assigning indexes may be determined in the same criterion as the image encoding apparatus 3700. According to an embodiment, the motion information decoder 2130 may assign an index having a small value in an order from a small distortion value among distortion values corresponding to base motion vector candidates included in the second group.

According to an embodiment, information indicating the priority between the base motion vector candidates for assigning an index may be included in the bitstream. In this case, the motion information decoder 2130 may assign an index to each of the base motion vector candidates according to the information indicating the priority obtained from the bitstream.

The information indicating the priority between the base motion vector candidates obtained from the bitstream may include information about a priority that is changed in comparison with a priority between the base motion vector candidates, which are determined from a previous block, a previous slice, or a previous picture. For example, when a priority of one base motion vector candidate (for example, a motion vector of the block A of FIG. 22 or a refined motion vector of the block A) was a first priority in a previous block, a previous slice, or a previous picture, but is changed to a third priority in relation to a current block, a current slice, or a current picture, the bitstream may include information indicating that the priority of the one base motion vector candidate is changed to the third priority. Also, the bitstream may include information indicating that the priority between the base motion vector candidates is not changed in the current block, the current slice, or the current picture in comparison with the priority between the base motion vector candidates determined in the previous block, the previous slice, or the previous picture.

According to an embodiment, the motion information decoder 2130 may not parse the information indicating the base motion vector from the bitstream, but may determine the base motion vector of the current block among the at least one base motion vector candidate, based on information related to at least one of the current block, the pre-decoded block, the current slice, the pre-decoded slice, the current picture, and the pre-decoded picture. In this case, the motion information decoder 2130 may determine the base motion vector in the same criterion as the image encoding apparatus 3700.

When the base motion vector of the current block is determined, the motion information decoder 2130 may determine the variation distance and the variation direction for changing the base motion vector. The variation distance may be a value determined based on a certain pixel unit (for example, a ¼ pixel unit). For example, a 1 variation distance may correspond to a ¼ pixel unit.

The obtainer 2110 may obtain information indicating the variation distance and the variation direction from the bitstream, and the motion information decoder 2130 may determine the variation distance and the variation direction for changing the base motion vector, based on the information indicating the variation distance and the variation direction.

The information indicating the variation distance and the variation direction may be obtained from the bitstream in a transform unit level, a coding unit level, a largest coding unit level, a slice level, or a picture level. The information indicating the variation distance and the variation direction may be encoded via a FLC method, a unary coding method, or a truncated unary coding method, and included in the bitstream.

According to an embodiment, the motion information decoder 2130 may determine a variation distance candidate and a variation direction candidate corresponding to the information indicating the variation distance and the variation direction obtained from the bitstream among a plurality of variation distance candidates and a plurality of variation direction candidates as the variation distance and the variation direction for changing the base motion vector.

According to an embodiment, the obtainer 2110 may not parse at least one of the information indicating the variation distance and the information indicating the variation direction from the bitstream, and the motion information decoder 2130 may determine at least one of the variation distance and the variation direction for changing the base motion vector, based on the information related to at least one of the current block, the pre-decoded block, the current slice, the pre-decoded slice, the current picture, and the pre-decoded picture. In this case, the motion information decoder 2130 may determine the variation distance and/or the variation direction in the same criterion as the image encoding apparatus 3700.

When the base motion vector, the variation distance, and the variation direction of the current block are determined, the motion information decoder 2130 may determine the motion vector of the current block by changing the base motion vector of the current block according to the variation distance and the variation direction. According to an embodiment, the motion information decoder 2130 may determine the base motion vector changed according to the variation distance and the variation direction as the motion vector of the current block.

When the bitstream includes information indicating a residual motion vector, the motion information decoder 2130 may determine the motion vector of the current block based on the information indicating the residual motion vector. According to an embodiment, the information indicating the residual motion vector may be encoded via an exponential Golomb method and included in the bitstream. The obtainer 2110 may obtain the information indicating the residual motion vector from the bitstream of the transform unit level, the coding unit level, the largest coding unit level, the slice level, or the picture level.

The motion information decoder 2130 may determine the motion vector of the current block by applying the residual motion vector to the base motion vector changed according to the variation distance and the variation direction. The motion information decoder 2130 may determine the motion vector of the current block by adding the residual motion vector to the base motion vector changed according to the variation distance and the variation direction.

The motion information decoder 2130 may reconstruct the current block via inter prediction using the motion vector when the motion vector of the current block is determined.

According to an embodiment, the motion information decoder 2130 may refine the motion vector of the current block by applying template matching or bilateral matching to the motion vector of the current block and reconstruct the current block based on the refined motion vector.

For a refine process of the motion vector, the obtainer 2110 may obtain information indicating whether the refine process is performed on the current block from the bitstream.

When it is determined that the refine process is performed on the current block, the motion information decoder 2130 may perform template matching or bilateral matching based on whether the motion vector of the current block is in uni-direction or bi-direction.

As described above, when the motion vector of the current block is in the uni-direction, the motion information decoder 2130 may determine a reference block indicated by the motion vector of the current block by using, as a template, a neighboring block decoded before decoding of the current block in the current picture. Then, the motion information decoder 2130 may search a certain search range based on the reference block for a block of which a difference with the template is the smallest, and refine the motion vector of the current block to a motion vector indicating the searched found block.

When the motion vector of the current block is in the bi-directional, the motion information decoder 2130 may determine an average block of a first reference block indicated by a motion vector of a list 0 direction and a second reference block indicated by a motion vector of a list 1 direction as a template. The average block may include an average value of pixel values of the first reference block and pixel values of the second reference block. Then, the motion information decoder 2130 may search a certain search range based on each of the first reference block and the second reference block in a first reference picture and a second reference picture for blocks of which a difference from the template is the smallest, and refine the motion vector of the current block to a motion vector indicating the searched blocks.

Because an embodiment of the disclosure relates to a method of representing a motion vector, the embodiment of the disclosure may be used with respect to types of all motion vectors or types of residual motion vectors used in a current encoder. In other words, a motion vector (or a residual motion vector) (for example, a residual motion vector in an advanced motion vector prediction (AMVP) mode or a residual motion vector in an affine mode) was encoded and transmitted via an existing method, but in the present disclosure, a location representation method simplified in a concept of distance and direction is applied to obtain high encoding efficiency.

Also, according to an embodiment of the disclosure, a large number of motion vectors (or residual motion vectors) to be considered by being additionally applied to an existing mode may be represented. All algorithms used in inter prediction may perform motion compensation only when an accurate location of a block is verified. Here, by applying a method according to an embodiment of the present disclosure, a reference possibility of neighboring blocks may be examined and encoded by using a minimum number of bits. Accordingly, efficiency of an encoding performance may be largely increased. Because whether to apply the method according to an embodiment of the present disclosure may be determined in a high level syntax, a burden of a signaling bit may also be reduced.

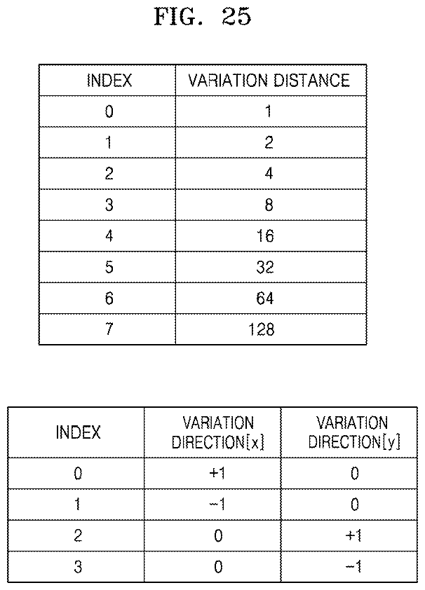

Hereinafter, the plurality of variation distance candidates and the plurality of variation direction candidates will be described with reference to FIGS. 25 through 31.

The motion information decoder 2130 may determine the variation distance and the variation direction for changing the basic motion vector among the plurality of variation distance candidates and the plurality of variation direction candidates, based on the information indicating the variation distance and variation direction.

According to an embodiment, the information indicating the variation distance and/or the information indicating the variation direction may include an index. The motion information decoder 2130 may determine the variation distance and the variation direction respectively corresponding to an index indicating the variation distance and an index indicating the variation direction among the plurality of variation distance candidates and the plurality of variation direction candidates.

As shown in FIG. 25, the plurality of variation distance candidates may be sequentially increased by twp times, such as 1, 2, 4, 8, and 16. The motion information decoder 2130 may determine the variation distance of 1 when the index indicating the variation distance is 0. The variation distance may be a value determined based on a certain pixel unit (for example, a ¼ pixel unit). For example, the variation distance of 1 may correspond to a length of ¼ pixel unit, a length of ⅛ pixel unit, or a length of 1/16 pixel unit.

The plurality of variation direction candidates denote in which direction the base motion vector is to be changed. In particular, the plurality of variation direction candidates may indicate whether to change the base motion vector in a +direction or a—direction along an x-axis direction (i.e., a horizontal direction) or a y-axis direction (i.e., a vertical direction). When the index indicating the variation direction is 0, the motion information decoder 2130 may determine to change the base motion vector in the +x-axis direction.

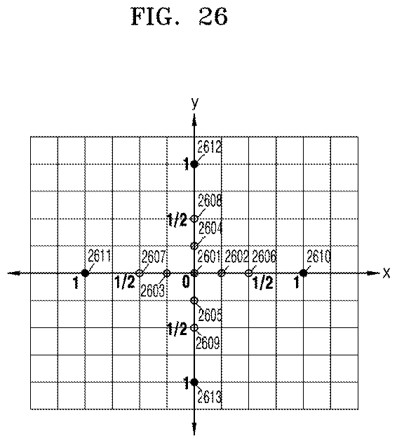

FIG. 26 is a diagram illustrating some of points corresponding to the plurality of variation distance candidates and the plurality of variation direction candidates of FIG. 25 when a base motion vector 2601 corresponds to an origin (0,0).

For example, when the index indicating the variation distance is 0 and the index indicating the variation direction is 0, the base motion vector 2601 is changed to a motion vector 2602 obtained by moving the base motion vector 2601 by the variation distance of 1 in the +x-axis direction. Also, when the index indicating the variation distance is 2 and the index indicating the variation direction is 1, the base motion vector 2601 is changed to a motion vector 2611 obtained by moving the base motion vector 2601 by the variation distance of 4 in the −x-axis direction.

Referring to FIGS. 25 and 26, total 4 points are arranged in a diamond shape accordingly to one variation distance candidate. For example, total four points 2602, 2603, 2604, and 2605 are arranged in a diamond shape accordingly to a variation distance candidate of 1. According to an embodiment, points corresponding to one variation distance candidate may be arranged in a square shape.

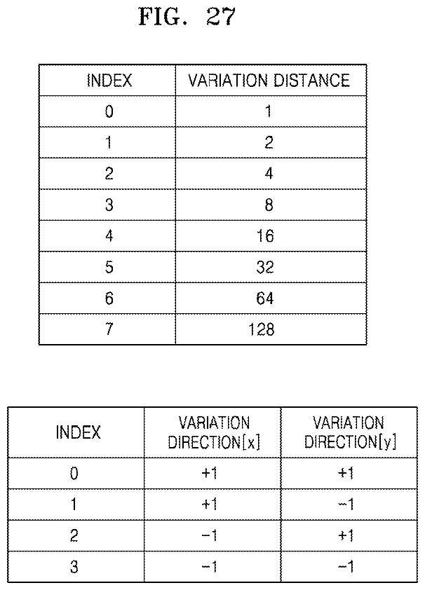

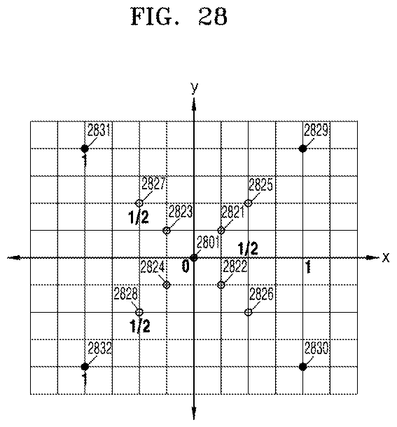

Referring to FIG. 27, a plurality of variation distance candidates are the same as the plurality of variation distance candidates of FIG. 25, but a plurality of variation direction candidates of FIG. 27 are different from the plurality of variation direction candidates of FIG. 25. In other words, when the index indicating the variation direction indicates 0 in FIG. 25, the base motion vector is changed in the +x-axis direction, but when an index indicating a variation direction indicates 0 in FIG. 27, a base motion vector is changed in a +x-axis direction and a +y-axis direction. Referring to FIG. 28, points 2821, 2822, 2823, and 2824 corresponding to a variation distance candidate of 1, points 2825, 2826, 2827, and 2828 corresponding to a variation distance candidate of 2, and points 2829, 2830, 2831, and 2832 corresponding to a variation distance candidate of 4 are arranged in square shapes.

In FIGS. 25 through 28, there are four points corresponding to each variation distance candidate. This indicates that four variation direction candidates are selectable with respect to one variation distance candidate. However, according to an embodiment, the number of points corresponding to one variation distance candidate may vary, or the number of points corresponding to one variation distance candidate and the number of points corresponding to another variation distance candidate may be different from each other.

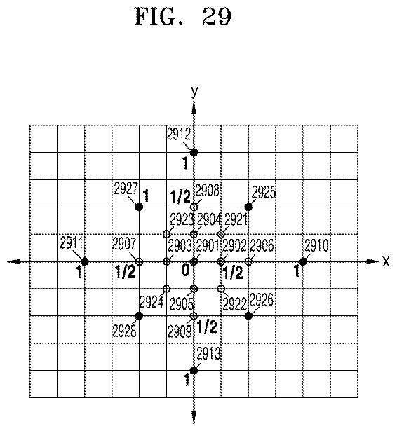

Referring to FIG. 29, there are 8 points 2902, 2903, 2904, 2905, 2921, 2922, 2923, and 2924 corresponding to a variation distance candidate of 1 and 8 points 2906, 2907, 2908, 2909, 2925, 2926, 2927, and 2928 corresponding to a variation distance candidate of 2, and there may be 4 points 2910, 2911, 2912, and 2913 corresponding to a variation distance candidate of 4.

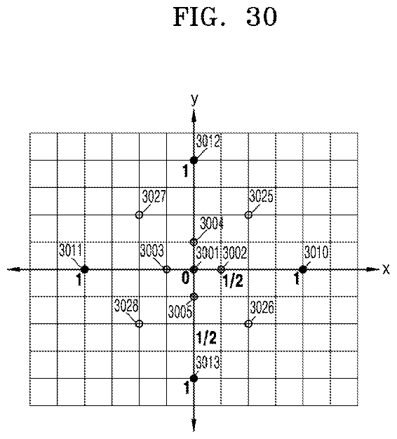

Also, according to an embodiment, a shape in which points corresponding to each variation distance candidate are arranged may be different for each variation distance candidate. As shown in FIG. 30, points 3002, 3003, 3004, and 3005, and 3010, 3011, 3012, and 3013 respectively corresponding to variation distance candidates of 1 and 4 are arranged in a diamond shape, and points 3025, 3026, 3027, and 3028 corresponding to a variation distance candidate of 2 may be arranged in a square shape.

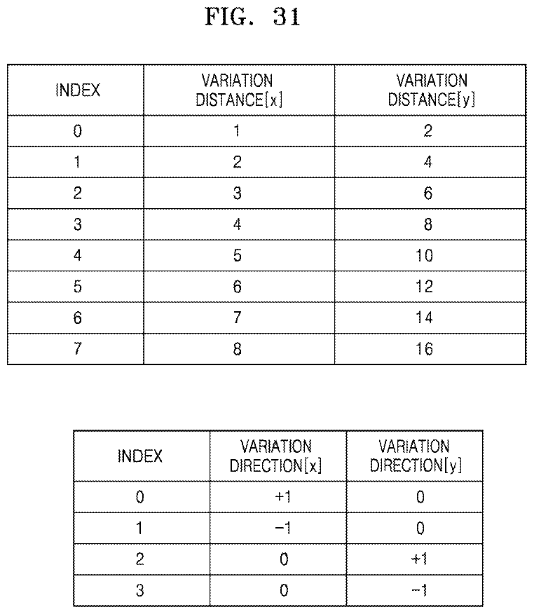

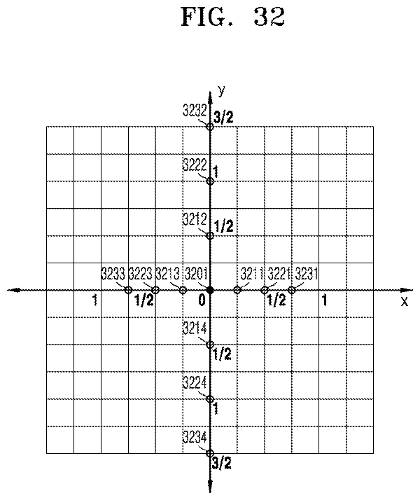

According to an embodiment, a variation distance in an x-axis direction and a variation distance in a y-axis direction of each of a plurality of variation distance candidates may be different from each other. For example, as shown in FIGS. 31 and 32, points 3211 and 3213 arranged along an x-axis direction among points 3211, 3212, 3213, and 3214 corresponding to an index 0 indicating a variation distance have a variation distance of 1 based on a base motion vector 3201, while the points 3212 and 3214 arranged along a y-axis direction may have a variation distance of 2 based on the base motion vector 3201. For example, a variation distance of 1 in an x-axis direction and a variation distance of 2 in a y-axis direction are selected according to an index indicating a variation distance, and when a +x-axis direction is selected according to an index indicating a variation direction, the base motion vector 3201 may be changed to a point 3211 moved by a distance of 1 along the +x-axis direction. Also, when a variation distance of 1 in an x-axis direction and a variation distance of 2 in a y-axis direction are selected according to an index indicating a variation distance, and a +y-axis direction is selected according to an index indicating a variation direction, the base motion vector 3201 may be changed to a point 3212 moved by a distance of 2 along the +y-axis direction.

Also, according to an embodiment, points corresponding to a plurality of variation distance candidates may be densely arranged at narrow intervals along an x-axis direction, but may be arranged at relatively wide intervals along a y-axis direction. In other words, a difference between a variation distance in an x-axis direction of one variation distance candidate and a variation distance in an x-axis direction of another variation distance candidate among a plurality of variation distance candidates and a difference between a variation distance in a y-axis direction of the one variation distance candidate and a variation distance in a y-axis direction of the other variation distance candidate may be different from each other.

Referring to FIGS. 31 and 32, intervals between points 3233, 3223, 3213, 3211, 3221, and 3231 arranged along the x-axis direction among points corresponding to the plurality of variation distance candidates may be smaller than intervals between points 3232, 3222, 3212, 3214, 3224, and 3234 arranged along the y-axis direction. On the other hand, intervals between the points 3232, 3222, 3212, 3214, 3224, and 3234 arranged along the y-axis direction among the points corresponding to the plurality of variation distance candidates may be smaller than the intervals between the points 3233, 3223, 3213, 3211, 3221, and 3231 arranged along the x-axis direction.

According to an embodiment, the motion information decoder 2130 may equally determine the plurality of variation distance candidates and the plurality of variation direction candidates for all pictures. In other words, the plurality of variation distance candidates and the plurality of variation direction candidates may be pre-determined as a default.

According to an embodiment, the motion information decoder 2130 may newly determine the plurality of variation distance candidates and the plurality of variation direction candidates for each picture unit, slice unit, or block unit. In this case, a plurality of variation distance candidates and a plurality of variation direction candidates corresponding to a current block may be determined differently from a plurality of variation distance candidates and a plurality of variation direction candidates corresponding to a previous block.

The motion information decoder 2130 may determine a plurality of variation distance candidates and a plurality of variation direction candidates corresponding to a current picture, current slice, or current block, based on statistics of points largely selected from previous blocks. According to an embodiment, when points arranged along an x-axis direction are largely selected among points corresponding to a plurality of variation distance candidates from previous pictures, previous slices, or previous blocks, the motion information decoder 2130 may determine the plurality of variation distance candidates such that the points corresponding to the plurality of variation distance candidates are further densely arranged along the x-axis direction.

According to an embodiment, the obtainer 2110 may obtain information indicating whether a refine process is performed on the current block from a bitstream. When it is determined that the refine process is performed on the current block, the motion information decoder 2130 may exclude some of variation distance candidates among the plurality of variation distance candidates corresponding to the current block and select a variation distance for changing a base motion vector among the remaining variation distance candidates. Because the accuracy of a motion vector of the current block is enhanced via the refine process, the accuracy of inter prediction is not largely reduced even when the number of points for changing the base motion vector is reduced. When some of the variation distance candidates are excluded among the plurality of variation distance candidates, the number of bits for representing the remaining variation distance candidates may be reduced.

According to an embodiment, an index is assigned correspondingly to each of the plurality of variation distance candidates, and the motion information decoder 2130 may assign a large value when the size of a variation distance candidate is large.

According to an embodiment, the motion information decoder 2130 may determine an index to be assigned to each of the plurality of variation distance candidates corresponding to the current picture, the current slice, or the current block, based on statistics of the variation distance candidates selected from the previous blocks. According to an embodiment, an index of a smallest value in the current picture, the current slice, or the current block may be assigned for a variation distance candidate selected the most in previous pictures, previous slices, or previous blocks.

According to an embodiment, information indicating a priority between the variation distance candidates for assigning an index to each of the plurality of variation distance candidates may be included in a bitstream. The motion information decoder 2130 may assign an index to each variation distance candidate according to the information indicating the priority obtained from the bitstream. The information indicating the priority between the variation distance candidates obtained from the bitstream may include information about a priority that is changed in comparison with a priority determined in a previous block, a previous slice, or a previous picture. For example, when a priority of one variation distance candidate in a previous block, a previous slice, or a previous picture was a first priority but is changed to a third priority in relation to a current block, a current slice, or a current picture, the bitstream may include information indicating that the priority of the variation distance candidate is changed to the third priority. Also, the bitstream may include information indicating that the priority between the variation distance candidates is not changed in the current block, the current slice, or the current picture in comparison with the priority between the variation distance candidates determined in the previous block, the previous slice, or the previous picture.

According to an embodiment, an index may be assigned correspondingly to each of a plurality of variation direction candidates. According to an embodiment, the motion information decoder 2130 may determine an index to be assigned to each of the plurality of variation direction candidates corresponding to the current picture, the current slice, or the current block, based on statistics of the variation direction candidates selected from the previous blocks. According to an embodiment, an index of a smallest value in the current picture, the current slice, or the current block may be assigned for a variation direction candidate selected the most in previous pictures, previous slices, or previous blocks.

According to an embodiment, information indicating a priority between the variation direction candidates for assigning an index to each of the plurality of variation direction candidates may be included in the bitstream, and in this case, the motion information decoder 2130 may assign the index to each of the variation direction candidates according to the information indicating the priority obtained from the bitstream. The information indicating the priority between the variation direction candidates obtained from the bitstream may include information about a priority that is changed in comparison with a priority determined in a previous block, a previous slice, or a previous picture. For example, when a priority of one variation direction candidate in a previous block, a previous slice, or a previous picture was a first priority but is changed to a third priority in relation to a current block, a current slice, or a current picture, the bitstream may include information indicating that the priority of the variation direction candidate is changed to the third priority. Also, the bitstream may include information indicating that the priority between the variation direction candidates is not changed in the current block, the current slice, or the current picture in comparison with the priority between the variation direction candidates determined in the previous block, the previous slice, or the previous picture.

Hereinafter, a method of determining a motion vector of a current block in consideration of a prediction direction of the current block and a direction of a base motion vector will be described.

According to an embodiment, the obtainer 2110 may extract information indicating a usage direction of a base motion vector, for example, an index, from a bitstream. The information indicating the usage direction of the base motion vector may correspond to a prediction information of a current block.

According to an embodiment, when the usage direction of the base motion vector is in a list 0 direction, uni-directional prediction in the list 0 direction may be performed on the current block and when the usage direction of the base motion vector is in a list 1 direction, uni-directional prediction in the list 1 direction may be performed on the current block. Also, when the usage direction of the base motion vector is in bi-direction, bi-directional prediction may be performed on the current bock.

For example, when the base motion vector is in the bi-direction, an index 0 indicates that the usage direction of the base motion vector is the bi-direction, an index 1 indicates that the usage direction of the base motion vector is the list 0 direction, and an index 2 indicates that the usage direction of the base motion vector is in the list 1 direction.

Also, for example, when the base motion vector is in a first uni-direction of the list 0 direction or the list 1 direction, the index 0 indicates that the usage direction of the base motion vector is the first uni-direction, the index 2 indicates that the usage direction of the base motion vector is in a second uni-direction different from the first uni-direction, and an index 3 indicates that the usage direction of the base motion vector is the bi-direction.

According to an embodiment, the motion information decoder 2130 may newly assign an index according to picture units, slice units, or block units for each usage direction of the base motion vector.

According to an embodiment, the motion information decoder 2130 may newly assign the index for each usage direction of the base motion vector from a current picture, a current slice, or a current block, based on statistics information of the usage direction of the base motion vector selected from a previous picture, a previous slice, or a previous block. According to an embodiment, the motion information decoder 2130 may assign an index of a smallest size in the current picture, the current slice, or the current block with respect to the usage direction of the base motion vector, which is mostly selected in the previous picture, the previous slice, or the previous block.

When the base motion vector is a bi-direction and the usage direction of the base motion vector is the bi-direction

The motion information decoder 2130 may determine a motion vector in a list 0 direction of the current block, based on a base motion vector in a list 0 direction changed according to a variation distance and a variation direction. Also, the motion information decoder 2130 may determine a motion vector in a list 1 direction of the current block, based on a base motion vector in a list 1 direction changed according to the variation distance and the variation direction (or a changed variation distance and a changed variation direction).

According to an embodiment, the motion information decoder 2130 may not change any one of the base motion vector in the list 0 direction and the base motion vector in the list 1 direction according to the variation distance and the variation direction, based on information obtained from a bitstream. The bitstream may include information (for example, a flag and/or an index) indicating a direction of a base motion vector to be changed. The information indicating the direction of the base motion vector to be changed may be encoded via an FLC method, a unary coding method, or a truncated unary coding method, and then included in the bitstream.

According to an embodiment, the motion information decoder 2130 may pre-determine not to change a base motion vector corresponding to a closer reference picture (i.e., a reference picture of which a POC difference is smaller) among a reference picture indicated by the base motion vector in the list 0 direction and a reference picture indicated by the base motion vector in the list 1 direction, based on a POC of the current picture. Alternatively, the motion information decoder 2130 may pre-determine not to change a base motion vector corresponding to a farther reference picture (i.e., a reference picture of which a POC difference is larger) among the reference picture indicated by the base motion vector in the list 0 direction and the reference picture indicated by the base motion vector in the list 1 direction, based on the POC of the current picture.

According to an embodiment, the motion information decoder 2130 may change a variation distance (hereinafter, a first variation distance) and/or a variation direction (hereinafter, a first variation direction) determined based on the information indicating the variation distance and the variation direction included in the bitstream, and then change the base motion vector in the list 0 direction or the base motion vector in the list 1 direction according to the changed variation distance (hereinafter, a second variation distance) and/or the changed variation direction (hereinafter, a second variation direction).

The motion information decoder 2130 may change a base motion vector indicating a reference picture located close to the current picture according to the first variation distance and the first variation direction, and change a base motion vector indicating a reference picture located far from the current picture according to the second variation distance and the second variation direction.

The second variation distance and the second variation direction may be determined based on a POC difference between the current picture and the reference picture indicated by the base motion vector in the list 0 direction and a POC difference between the current picture and the reference picture indicated by the base motion vector in the list 1 direction.

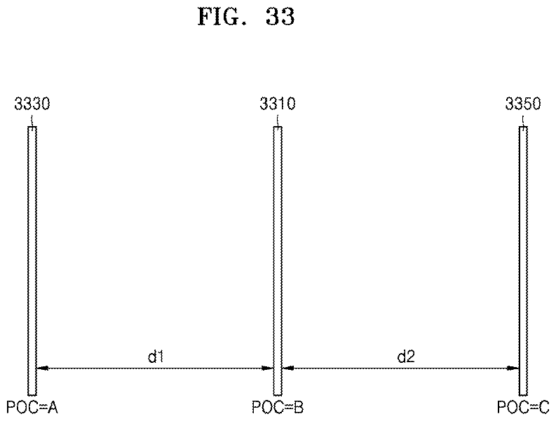

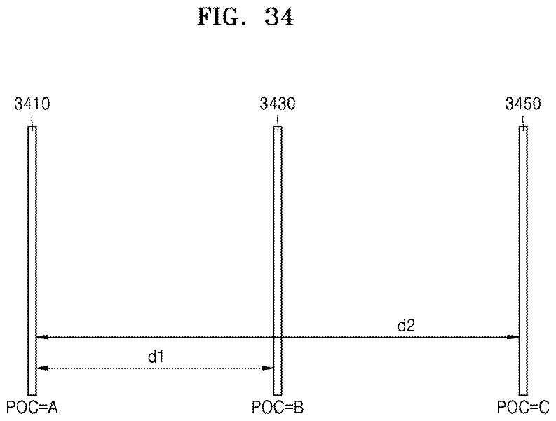

A method of determining the second variation distance and the second variation direction will be described with reference to FIGS. 33 and 34.

FIG. 33 illustrates location relationships between a first reference picture 3330 indicated by a base motion vector candidate in a first uni-direction (list 0 direction or list 1 direction), a second reference picture 3350 indicated by a base motion vector candidate in a second uni-direction (list 1 direction or list 1 direction), and a current picture 3310 including a current block, when a base motion vector corresponds to a motion vector in a bi-direction. In FIG. 33, a POC difference between the current picture 3310 and the first reference picture 3330 is referred to as d1 and a POC difference between the current picture 3310 and the second reference picture 3350 is referred to as d2.

Referring to FIG. 33, the current picture 3310 has POC B, and the first reference picture 3330 and the second reference picture 3350 respectively have POC A and POC C. When POC B has a value between POC A and POC C, an absolute value of d1 is smaller than an absolute value of d2, a base motion vector indicating the first reference picture 3330 may be changed according to a first variation distance and a first variation direction, and a base motion vector indicating the second reference picture 3350 may be changed according to a second variation distance and a second variation direction. Alternatively, the base motion vector indicating the first reference picture 3330 may be changed according to the second variation distance and the second variation direction, and the base motion vector indicated by the second reference picture 3350 may be changed according to the first variation distance and the first variation direction.

In an example of FIG. 33, the second variation direction and the first variation direction may be opposite directions. For example, when the first variation direction is a +x-axis direction, the second variation direction may be a −x-axis direction. Also, when the first variation direction is a +x-axis direction and a +y-axis direction, the second variation direction may be a −x-axis direction and a −y-axis direction.

The second variation distance may be determined by scaling the first variation distance according to a ratio between d1 and 2. When n denotes a scaling factor, the second variation distance may be determined by first variation distance x n. Here, n may be d2/d1. n may be calculated as in integer type or may be calculated as a double type or a float type according to an embodiment. Alternatively, according to an embodiment, n may be converted via a bit shift operator (<<,>>) and the converted n may be rounded and then calculated by applying the bit shift operator again. According to an embodiment, n may be d1/d2.

FIG. 34 illustrates location relationships between a first reference picture 3430 indicated by a base motion vector in a first uni-direction, a second reference picture 3450 indicated by a base motion vector in a second uni-direction, and a current picture 3410 including a current block. In FIG. 34, a POC difference between the current picture 3410 and the first reference picture 3430 is referred to as d1 and a POC difference between the current picture 3410 and the second reference picture 3450 is referred to as d2.

As shown in FIG. 34, a second variation direction may be the same as a first variation direction when the current picture 3410 is located before the first reference picture 3430 and the second reference picture 3450 based on POC or located after the first reference picture 3430 and the second reference picture 3450.

A second variation distance may be determined by scaling a first variation distance according to a ratio between d1 and 2. When n denotes a scaling factor, the second variation distance may be determined by first variation distance x n. Here, n may be d2/d1. n may be calculated as in integer type or may be calculated as a double type or a float type according to an embodiment. Alternatively, according to an embodiment, n may be converted via a bit shift operator (<<,>>) and the converted n may be rounded and then calculated by applying the bit shift operator again. According to an embodiment, n may be d1/d2.

According to an embodiment, the motion information decoder 2130 may determine a first offset for changing the base motion vector in the first uni-direction and a second offset for changing the base motion vector in the second uni-direction, by referring to a variation distance and a variation direction determined based on information indicating a variation distance and information indicating a variation direction, which are obtained from a bitstream.

According to an embodiment, the first offset and the second offset may be determined according to Equations 1 and 2 below.

First Offset=(Variation Distance×n)×Variation Direction

Second Offset=−(Variation Distance×n)×Variation Direction [Equation 1]

First Offset=(Variation Distance×n)×Variation Direction

Second Offset(Variation Distance×n)×Variation Direction [Equation 2]

Equation 1 is an equation for determining a first offset and a second offset when a current picture is located between a first reference picture and a second reference picture, and Equation 2 is an equation for determining a first offset and a second offset when a current picture is located before or after a first reference picture and a second reference picture.

In Equations 1 and 2, n is a value corresponding to a smallest pixel unit supported by the image decoding apparatus 2100 and the image encoding apparatus 3700. When the smallest pixel unit supported by the image decoding apparatus 2100 and the image encoding apparatus 3700 is a ¼ pixel unit, n is ¼ and bit-shifted, and when the smallest pixel unit supported by the image decoding apparatus 2100 and the image encoding apparatus 3700 is a ⅛ pixel unit, n may be ⅛. When the smallest pixel unit supported by the image decoding apparatus 2100 and the image encoding apparatus 3700 is a 1/16 pixel unit, n may be 1/16.

The motion information decoder 2130 may scale the first offset or the second offset based on the POC difference between the current picture and the first reference picture and the POC difference between the current picture and the second reference picture. According to an embodiment, when the POC difference between the current picture and the first reference picture is greater than the POC difference between the current picture and the second reference picture, the motion information decoder 2130 may scale the second offset. In this case, scaling for increasing the size of the second offset may be applied. Also, when the POC difference between the current picture and the first reference picture is smaller than the POC difference between the current picture and the second reference picture, the motion information decoder 2130 may scale the second offset. In this case, scaling for decreasing the size of the second offset may be applied.

The motion information decoder 2130 may determine a motion vector in a first uni-direction of the current block by applying the first offset to a base motion vector in the first uni-direction, and determine a motion vector in a second uni-direction of the current block by applying the second offset (or scaled second offset) to a base motion vector in the second uni-direction.

When the base motion vector is a bi-direction and the usage direction of the base motion vector is a uni-direction

When the base motion vector is in the bi-direction and the usage direction of the base motion vector is in the first uni-direction of the list 0 direction or the list 1 direction, the motion information decoder 2130 may change the base motion vector in the first uni-direction according to a variation distance and a variation direction and determine the motion vector of the current block based on the changed base motion vector.

According to an embodiment, the motion information decoder 2130 may determine an offset for changing the base motion vector in the first uni-direction, by referring to a variation distance and a variation direction determined based on information indicating a variation distance and information indicating a variation direction, which are obtained from a bitstream. The offset may be determined according to Equation 3 below.

Offset=(Variation Distance×n)×Variation Direction [Equation 3]

In Equation 3, n is a value corresponding to a smallest pixel unit supported by the image decoding apparatus 2100 and the image encoding apparatus 3700.

The motion information decoder 2130 may determine the motion vector in the first uni-direction of the current bock by applying the offset to the base motion vector in the first uni-direction.

When the base motion vector and the usage direction of the base motion vector are uni-directions

When the base motion vector is in the first uni-direction of the list 0 direction or the list 1 direction and the usage direction of the base motion vector is also the first usage direction, the motion information decoder 2130 may change the base motion vector according to the variation distance and the variation direction and determine the motion vector in the first uni-direction of the current block based on the changed base motion vector.

According to an embodiment, the motion information decoder 2130 may determine an offset for changing the base motion vector in the first uni-direction, by referring to the variation distance and the variation direction determined based on the information indicating the variation distance and the information indicating the variation direction, which are obtained from the bitstream. The offset may be determined according to Equation 3 above. The motion information decoder 2130 may determine the motion vector in the first uni-direction of the current bock by applying the offset to the base motion vector in the first uni-direction.

When the base motion vector is in the first uni-direction of the list 0 direction or the list 1 direction and the usage direction of the base motion vector is the second uni-direction different from the first uni-direction, the motion information decoder 2130 may determine the base motion vector in the second uni-direction by using the base motion vector in the first uni-direction.

The motion information decoder 2130 may determine the second reference picture located in an opposite direction from the first reference picture based on the current picture in consideration of d1 (the POC difference between the current picture and the first reference picture indicated by the base motion vector in the first uni-direction).

According to an embodiment, the second reference picture in the opposite direction spaced apart by a distance equal to d1 may be determined. In this case, because d1 and d2 (the POC difference between the current picture and the second reference picture) are the same and the current picture is located between the first reference picture and the second reference picture, the motion information decoder 2130 may reverse a sign of the base motion vector in the first uni-direction to generate the base motion vector in the second uni-direction.

When a picture spaced by the same distance as d1 based on the current picture is not present, a picture located closest to the current picture while being located in an opposite direction from the first reference picture based on the current picture may be determined as the second reference picture. In this case, the current picture is located between the first reference picture and the second reference picture but d1 and d2 are different from each other. The motion information decoder 2130 may reverse the sign of the base motion vector in the first uni-direction and generate the base motion vector in the second uni-direction by scaling the base motion vector in the first uni-direction according to a ratio between d1 and d2.

When the current picture corresponds to a last picture of a group of pictures (GOP), the motion information decoder 2130 may determine, as the second reference picture, one of pictures located in the same direction as the first reference picture based on the current picture. A picture located closest to the first reference picture or the current picture may be determined as the second reference picture. In this case, because the current picture is located after the first reference picture and the second reference picture, the motion information decoder 2130 may generate the base motion vector in the second uni-direction by scaling (without reversing a sign) a value of the base motion vector in the first uni-direction according to the ratio between d1 and d2.

According to an embodiment, when the current picture corresponds to the last picture of GOP and the first reference picture itself is determined as the second reference picture, the motion information decoder 2130 may determine the base motion vector in the first uni-direction as the base motion vector in the second uni-direction.

According to an embodiment, the obtainer 2110 may obtain information indicating the second reference picture from the bitstream and the motion information decoder 2130 may determine the second reference picture based on the information obtained from the bitstream. The information indicating the second reference picture may be encoded via a unary coding method or a truncated unary coding method in an order close to the current picture and then included in the bitstream. Also, when required, the motion information decoder 2130 may determine the base motion vector for the second uni-direction by scaling the base motion vector in the first uni-direction or reversing the sign thereof, based on POC of the current picture, POC of the first reference picture, and POC of the second reference picture.

When the base motion vector for the second uni-direction is determined, the motion information decoder 2130 may determine the motion vector in the second uni-direction of the current block by using the base motion vector in the second uni-direction changed according to the variation distance and the variation direction.

According to an embodiment, the motion information decoder 2130 may determine an offset for changing the base motion vector in the second uni-direction, by referring to the variation distance and the variation direction determined based on the information indicating the variation distance and the information indicating the variation direction, which are obtained from the bitstream. The offset may be determined according to Equation 3 above. The motion information decoder 2130 may determine the motion vector in the second uni-direction of the current bock by applying the offset to the base motion vector in the second uni-direction.

When the base motion vector is a uni-direction and the usage direction of the base motion vector is the bi-direction

When the base motion vector is in the first uni-direction of the list 0 direction or the list 1 direction and the usage direction of the base motion vector is the bi-direction, the motion information decoder 2130 may generate the base motion vector in the second uni-direction based on the base motion vector in the first uni-direction. Because a method of determining the base motion vector in the second uni-direction is the same as “when the base motion vector and the usage direction of the base motion vector are uni-direction”, detailed descriptions thereof will be omitted.

The motion information decoder 2130 may determine the motion vector in a list 0 direction of the current block, based on the base motion vector in the list 0 direction changed according to the variation distance and the variation direction. Also, the motion information decoder 2130 may determine the motion vector in a list 1 direction of the current block, based on the base motion vector in the list 1 direction changed according to the variation distance and the variation direction (or the changed variation distance and the changed variation direction).

According to an embodiment, the motion information decoder 2130 may not change any one of the base motion vector in the list 0 direction and the base motion vector in the list 1 direction according to the variation distance and the variation direction, based on the information obtained from the bitstream. According to an embodiment, the motion information decoder 2130 may pre-determine not to change the base motion vector corresponding to the closer reference picture (i.e., the reference picture of which the POC difference is smaller) among the reference picture indicated by the base motion vector in the list 0 direction and the reference picture indicated by the base motion vector in the list 1 direction, based on the POC of the current picture. Alternatively, the motion information decoder 2130 may pre-determine not to change the base motion vector corresponding to the farther reference picture (i.e., the reference picture of which the POC difference is larger) among the reference picture indicated by the base motion vector in the list 0 direction and the reference picture indicated by the base motion vector in the list 1 direction, based on the POC of the current picture.

According to an embodiment, the motion information decoder 2130 may change the variation distance (hereinafter, the first variation distance) and/or the variation direction (hereinafter, the first variation direction) determined based on the information indicating the variation distance and the variation direction included in the bitstream, and then change the base motion vector in the list 0 direction or the base motion vector in the list 1 direction according to the changed variation distance (hereinafter, the second variation distance) and/or the changed variation direction (hereinafter, the second variation direction).

The motion information decoder 2130 may change the base motion vector indicating the reference picture located close to the current picture according to the first variation distance and the first variation direction, and change the base motion vector indicating the reference picture located far from the current picture according to the second variation distance and the second variation direction. Alternatively, the motion information decoder 2130 may change the base motion vector indicating the reference picture located close to the current picture according to the second variation distance and the second variation direction, and change the base motion vector indicating the reference picture located far from the current picture according to the first variation distance and the first variation direction.

The second variation distance and the second variation direction may be determined based on the POC difference between the current picture and the reference picture indicated by the base motion vector in the list 0 direction and the POC difference between the current picture and the reference picture indicated by the base motion vector in the list 1 direction.

Because a method of determining the second variation distance and the second variation direction is the same as “when the base motion vector is in the bi-direction and the usage direction of the base motion vector is the bi-direction”, detailed descriptions thereof will be omitted.

According to an embodiment, the motion information decoder 2130 may determine the first offset for changing the base motion vector in the first uni-direction and the second offset for changing the base motion vector in the second uni-direction, by referring to the variation distance and the variation direction determined based on the information indicating the variation distance and the information indicating the variation direction, which are obtained from the bitstream.

According to an embodiment, the first offset and the second offset may be determined according to Equations 1 and 2 above.

The motion information decoder 2130 may scale the first offset or the second offset based on the POC difference between the current picture and the first reference picture and the POC difference between the current picture and the second reference picture. According to an embodiment, when the POC difference between the current picture and the first reference picture is greater than the POC difference between the current picture and the second reference picture, the motion information decoder 2130 may scale the second offset. In this case, scaling for increasing the size of the second offset may be applied. Also, when the POC difference between the current picture and the first reference picture is smaller than the POC difference between the current picture and the second reference picture, the motion information decoder 2130 may scale the second offset. In this case, scaling for decreasing the size of the second offset may be applied.

The motion information decoder 2130 may determine the motion vector in the first uni-direction of the current block by applying the first offset to the base motion vector in the first uni-direction, and determine the motion vector in the second uni-direction of the current block by applying the second offset (or scaled second offset) to the base motion vector in the second uni-direction.

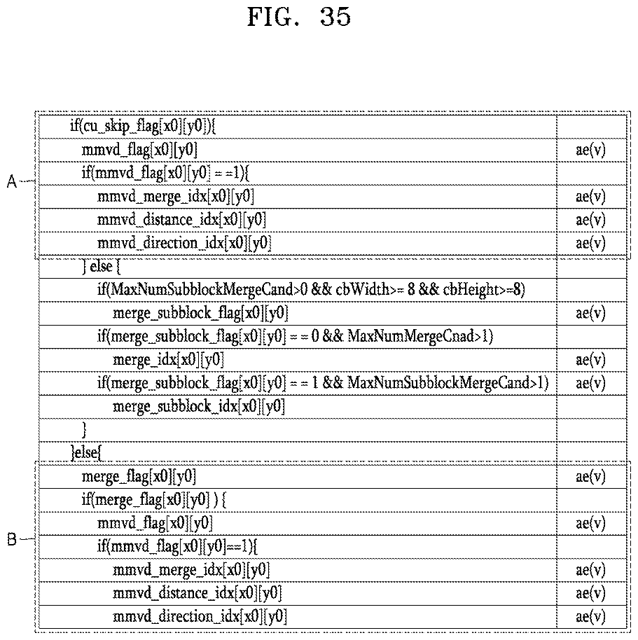

FIG. 35 illustrates a process by which the image decoding apparatus 2100 parses a bitstream, according to an embodiment.

First, when a skip flag (cu_skip_flag) indicating whether a skip mode is applied to a current block indicates 1 in a portion A, the image decoding apparatus 2100 parses, from a bitstream, a flag (mmvd_flag) indicating whether a pre-set mode according to the present disclosure is applied to the current block. When the flag (mmvd_flag) indicating whether the pre-set mode is applied indicates 1, mmvd_merge_idx, mmvd_distance_idx, and mmvd_direction_idx are extracted from the bitstream. mmvd_merge_idx is an index indicating a candidate to be used as a base motion vector of the current block among a merge candidate list. Also, mmvd_distance_idx is an index indicating a variation distance and mmvd_direction_idx is an index indicating a variation direction.

Also, when a merge flag (merge_flag) indicating whether a merge mode is applied to the current block indicates 1 in a portion B, the image decoding apparatus 2100 parses, from the bitstream, the flag (mmvd_flag) indicating whether the pre-set mode according to the present disclosure is applied to the current block. When the flag (mmvd_flag) indicating whether the pre-set mode is applied indicates 1, mmvd_merge_idx, mmvd_distance_idx, and mmvd_direction_idx are extracted.

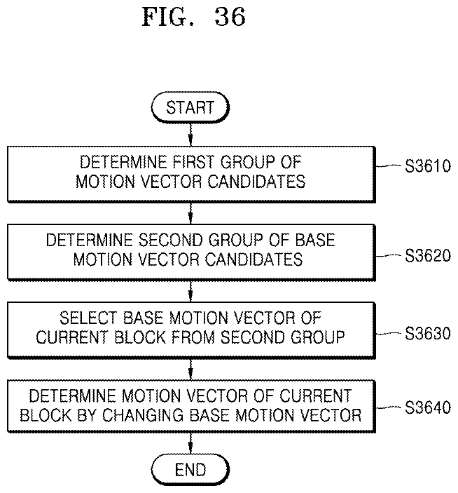

FIG. 36 is a flowchart of an image decoding method according to an embodiment.

In operation S3610, the image decoding apparatus 2100 determines a first group of motion vector candidates by using at least one motion vector among a spatial neighboring block and a temporal neighboring block related to a current block. According to an embodiment, the first group may correspond to a merge candidate list of a merge mode. Because the merge candidate list is used in the video standard such as HEVC, detailed descriptions thereof will be omitted.

In operation S3620, the image decoding apparatus 2100 determines a second group of base motion vector candidates according to a result of template matching or bilateral matching based on each motion vector candidate included in the first group.

According to an embodiment, the image decoding apparatus 2100 calculate a distortion value of each of the motion vector candidates included in the first group as the result of template matching or bilateral matching, and determine the second group including at least some motion vector candidates selected based on the distortion value among the motion vector candidates included in the first group.

According to an embodiment, the image decoding apparatus 2100 may change (or refine) each of the motion vector candidates included in the first group according to template matching or bilateral matching, and determine the second group including the changed motion vector candidates.

According to an embodiment, the image decoding apparatus 2100 may exclude a second base motion vector candidate from the second group when a difference between a first base motion vector candidate and the second base motion vector candidate among the base motion vector candidates included in the second group is equal to or less than a pre-set value.

In operation S3630, the image decoding apparatus 2100 selects a base motion vector of the current block from the second group.

The image decoding apparatus 2100 may select the base motion vector of the current block from the second group, based on information indicating the base motion vector obtained from a bitstream.

In operation S3640, the image decoding apparatus 2100 determines a motion vector of the current block by changing the base motion vector according to a variation distance and a variation direction.

When the bitstream includes information indicating a residual motion vector, the image decoding apparatus 2100 may determine the motion vector of the current block by applying the residual motion vector to the base motion vector changed according to the variation distance and the variation direction.

The image decoding apparatus 2100 may reconstruct the current block via inter prediction using the motion vector when the motion vector of the current block is determined. According to an embodiment, the image decoding apparatus 2100 may reconstruct the current block by determining a prediction block generated via the inter prediction as the current block or applying a residual block to the prediction block.

According to an embodiment, the image decoding apparatus 2100 may change the motion vector of the current block according to a refine process and reconstruct the current block based on the changed motion vector.

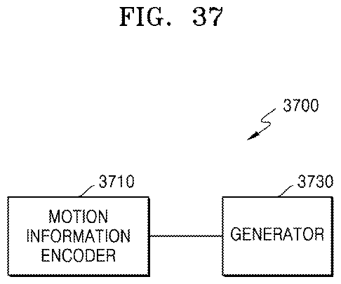

FIG. 37 is a block diagram of the image encoding apparatus 3700 according to an embodiment.

Referring to FIG. 37, the image encoding apparatus 3700 according to an embodiment may include a motion information encoder 3710 and a generator 3730.

The image encoding apparatus 3700 may encode an image and generate a bitstream including information generated as a result of the encoding.

The image encoding apparatus 3700 according to an embodiment may include a central processor (not shown) for controlling the motion information encoder 3710 and the generator 3730. Alternatively, the motion information encoder 3710 and the generator 3730 may operate respectively by their own processors (not shown), and the processors may operate systematically such that the image encoding apparatus 3700 operates as a whole. Alternatively, the motion information encoder 3710 and the generator 3730 may be controlled according to control of an external processor (not shown).

The image encoding apparatus 3700 may include at least one data storage (not shown) where input and output data of the motion information encoder 3710 and the generator 3730 is stored. The image encoding apparatus 3700 may include a memory controller (not shown) for controlling data input and output of the data storage.

The image encoding apparatus 3700 may perform an image encoding operation including prediction by connectively operating with an internal video encoding processor or an external video encoding processor so as to encode an image. The internal video encoding processor of the image encoding apparatus 3700 according to an embodiment may perform a basic image encoding operation as a separate processor, or a central processing unit or a graphics processing unit may include an image encoding processing module and may perform a basic image encoding operation.

The image encoding apparatus 3700 may be included in the image encoding apparatus 200 described above. For example, the generator 3730 may be included in the bitstream generator 210 of the image encoding apparatus 200 of FIG. 2, and the motion information encoder 3710 may be included in the encoder 220 of the image encoding apparatus 200.

The motion information encoder 3710 encodes a motion vector of a current block. The current block is a block generated when an image is split according to a tree structure, and for example, may correspond to a largest coding unit, a coding unit, or a transform unit. The motion information encoder 3710 may determine a prediction mode to be applied to the current block. The prediction may include at least one of, for example, an intra mode, an inter mode, a merge mode, a direct mode, a skip mode, and a pre-set mode according to the present disclosure.

The generator 3730 generates a bitstream including information generated as a result of encoding a motion vector of the current block. According to an embodiment, the bitstream may include at least one of information indicating whether the pre-set mode is applied to the current block, information indicating a base motion vector of the current block, information indicating a usage direction of the base motion vector of the current block, information indicating whether a refine process is performed on the motion vector of the current block, information indicating a variation distance, information indicating a variation direction, information indicating a priority of base motion vector candidates, information indicating a priority of variation distance candidates, and information indicating a priority of variation direction candidates.

The generator 3730 may add the above information to a bitstream corresponding to at least one level among a coding unit level, a transform unit level, a largest coding unit level, a slice unit level, and a picture unit level.

The motion information encoder 3710 may determine whether to apply the pre-set mode to the current block.

The motion information encoder 3710 may determine whether to apply the pre-set mode to the current block, based on information related to at least one of a current block, a pre-encoded block, a current slice, a pre-encoded slice, a current picture, and a pre-encoded picture.

According to an embodiment, the motion information encoder 3710 may determine whether to apply the pre-set mode to the current block in consideration of statistics information regarding a prediction mode in a previous block, a previous slice, or a previous picture. The motion information encoder 3710 may determine not to apply the pre-set mode to the current block, based on the statistics information.

According to an embodiment, the motion information encoder 3710 may determine to apply the pre-set mode to the current block, based on a cost corresponding to each of several prediction modes applicable to the current block. A rate-distortion cost may be used to calculate the cost.

According to an embodiment, the motion information encoder 3710 may first determine that a prediction mode different from the pre-set mode is applied to the current block, and then determine whether to apply the pre-set mode to the current block. For example, whether to apply the pre-set mode may be determined after determining to apply a skip mode or a merge mode to the current block.

When the pre-set mode is applied to the current block, the motion information encoder 3710 may determine a second group (or a second list) including base motion vector candidates, based on a first group (or a first list) including motion vector candidates. Then, the motion information encoder 3710 may determine the base motion vector of the current block from the second group. Because the first and second groups are the same as those described with reference to the image decoding apparatus 2100, detailed descriptions thereof will be omitted.

According to an embodiment, the motion information encoder 3710 may determine the first group including the motion vector candidates as the second group. Here, the first group may correspond to a merge candidate list of a merge mode.

When the second group is determined, the motion information encoder 3710 may determine the base motion vector of the current block among the base motion vector candidates included in the second group.

The generator 3730 may encode information indicating the base motion vector of the current block via an FLC method, a unary coding method, or a truncated unary coding method, and then add the encoded information to the bitstream.

According to an embodiment, when the number of base motion vector candidates included in the second group is 1, the generator 3730 may not add, to the bitstream, information for determining the base motion vector of the current block. In this case, the motion information encoder 3710 may determine one base motion vector candidate as the base motion vector of the current block.

According to an embodiment, an index may be assigned to each of the base motion vector candidates included in the second group. The number of bits representing an index is increased from a base motion vector candidate having an index of 0 to a base motion vector candidate having an index of n (n is a natural number greater than 0), and a priority between the base motion vector candidates for assigning indexes may be determined according to a pre-set criterion. According to an embodiment, the motion information encoder 3710 may assign an index having a small value in an order from a small distortion value corresponding to each base motion vector candidate included in the second group.

According to an embodiment, the generator 3730 may add information indicating the priority between the base motion vector candidates for assigning an index to the bitstream.

When the base motion vector of the current block is determined, the motion information encoder 3710 may determine the variation distance and the variation direction for changing the base motion vector. The variation distance may be a value determined based on a certain pixel unit (for example, a ¼ pixel unit). For example, a 1 variation distance may correspond to a ¼ pixel unit.

The generator 3730 adds the information indicating the variation distance and the variation direction to the bitstream. The information indicating the variation distance and the variation direction may be included in the bitstream in a transform unit level, a coding unit level, a largest coding unit level, a slice level, or a picture level. The information indicating the variation distance and the variation direction may be encoded via a FLC method, a unary coding method, or a truncated unary coding method, and included in the bitstream.

According to an embodiment, the motion information encoder 3710 may determine the variation distance and the variation direction for changing the base motion vector of the current block among a plurality of variation distance candidates and a plurality of variation direction candidates.

According to an embodiment, the generator 3730 may not add, to the bitstream, at least one of the information indicating the variation distance and the information indicating the variation direction.

According to an embodiment, the generator 3730 may add information indicating a residual motion vector to the bitstream. The motion information encoder 3710 may determine the residual motion vector that is a difference between the motion vector of the current block and the base motion vector changed according to the variation distance and the variation direction. The generator 3730 may encode the information indicating the residual motion vector via an exponential Golomb method and add the encoded information to the bitstream. The generator 3730 may add the information indicating the residual motion vector to the bitstream of the transform unit level, the coding unit level, the largest coding unit level, the slice level, or the picture level.

According to an embodiment, the motion information encoder 3710 may refine the motion vector of the current block by applying template matching or bilateral matching to the motion vector of the current block. Here, the residual motion vector may be determined based on the refined motion vector and the base motion vector changed according to the variation distance and the variation direction.

The generator 3730 may add information indicating whether a refine process is performed on the current block to the bitstream.

The motion information encoder 3710 may determine the variation distance and the variation direction for changing the base motion vector among the plurality of variation distance candidates and the plurality of variation direction candidates.

According to an embodiment, the generator 3730 may add indexes, as the information indicating the variation distance and/or the information indicating the variation direction, to the bitstream.

As shown in FIG. 25, the plurality of variation distance candidates may be sequentially increased by twp times, such as 1, 2, 4, 8, and 16. When the variation distance of 1 is determined, the generator 3730 may add an index of 0 indicating the variation distance to the bitstream. The variation distance may be a value determined based on a certain pixel unit (for example, a ¼ pixel unit). For example, the variation distance of 1 may correspond to a length of ¼ pixel unit, a length of ⅛ pixel unit, or a length of 1/16 pixel unit.

The plurality of variation direction candidates denote in which direction the base motion vector is to be changed. In particular, the plurality of variation direction candidates may indicate whether to change the base motion vector in a +direction or a −direction along an x-axis direction (i.e., a horizontal direction) or a y-axis direction (i.e., a vertical direction). When the base motion vector is determined to be changed in a +x-axis direction, the generator 3730 may add an index of 0 indicating the variation direction to the bitstream.

FIG. 26 is the diagram illustrating some of the points corresponding to the plurality of variation distance candidates and the plurality of variation direction candidates of FIG. 25 when the base motion vector 2601 corresponds to an origin (0,0).

For example, when the index indicating the variation distance is 0 and the index indicating the variation direction is 0, the base motion vector 2601 is changed to the motion vector 2602 obtained by moving the base motion vector 2601 by the variation distance of 1 in the +x-axis direction. Also, when the index indicating the variation distance is 2 and the index indicating the variation direction is 1, the base motion vector 2601 is changed to the motion vector 2611 obtained by moving the base motion vector 2601 by the variation distance of 4 in the −x-axis direction.

Referring to FIGS. 25 and 26, total 4 points are arranged in a diamond shape accordingly to one variation distance candidate. For example, the total four points 2602, 2603, 2604, and 2605 are arranged in a diamond shape accordingly to a variation distance candidate of 1. According to an embodiment, points corresponding to one variation distance candidate may be arranged in a square shape.

Referring to FIG. 27, the plurality of variation distance candidates are the same as the plurality of variation distance candidates of FIG. 25, but the plurality of variation direction candidates of FIG. 27 are different from the plurality of variation direction candidates of FIG. 25. In other words, when the index indicating the variation direction indicates 0 in FIG. 25, the base motion vector is changed in the +x-axis direction, but when the index indicating the variation direction indicates 0 in FIG. 27, the base motion vector is changed in the +x-axis direction and the +y-axis direction. Referring to FIG. 28, the points 2821, 2822, 2823, and 2824 corresponding to the variation distance candidate of 1, the points 2825, 2826, 2827, and 2828 corresponding to the variation distance candidate of 2, and the points 2829, 2830, 2831, and 2832 corresponding to the variation distance candidate of 4 are arranged in square shapes.

In FIGS. 25 through 28, there are four points corresponding to each variation distance candidate. This indicates that four variation direction candidates are selectable with respect to one variation distance candidate. However, according to an embodiment, the number of points corresponding to one variation distance candidate may vary, or the number of points corresponding to one variation distance candidate and the number of points corresponding to another variation distance candidate may be different from each other.

Referring to FIG. 29, there are the 8 points 2902, 2903, 2904, 2905, 2921, 2922, 2923, and 2924 corresponding to the variation distance candidate of 1 and the 8 points 2906, 2907, 2908, 2909, 2925, 2926, 2927, and 2928 corresponding to the variation distance candidate of 2, and there may be the 4 points 2910, 2911, 2912, and 2913 corresponding to the variation distance candidate of 4.

Also, according to an embodiment, a shape in which points corresponding to each variation distance candidate are arranged may be different for each variation distance candidate. As shown in FIG. 30, the points 3002, 3003, 3004, and 3005, and 3010, 3011, 3012, and 3013 respectively corresponding to the variation distance candidates of 1 and 4 are arranged in a diamond shape, and the points 3025, 3026, 3027, and 3028 corresponding to the variation distance candidate of 2 may be arranged in a square shape.

According to an embodiment, a variation distance in an x-axis direction and a variation distance in a y-axis direction of each of a plurality of variation distance candidates may be different from each other. For example, as shown in FIGS. 31 and 32, the points 3211 and 3213 arranged along the x-axis direction among the points 3211, 3212, 3213, and 3214 corresponding to the index 0 indicating the variation distance have the variation distance of 1 based on the base motion vector 3201, while the points 3212 and 3214 arranged along the y-axis direction may have the variation distance of 2 based on the base motion vector 3201. For example, a variation distance of 1 in an x-axis direction and a variation distance of 2 in a y-axis direction are selected according to an index indicating a variation distance, and when a +x-axis direction is selected according to an index indicating a variation direction, the base motion vector 3201 may be changed to the point 3211 moved by a distance of 1 along the +x-axis direction. Also, when a variation distance of 1 in an x-axis direction and a variation distance of 2 in a y-axis direction are selected according to an index indicating a variation distance, and a +y-axis direction is selected according to an index indicating a variation direction, the base motion vector 3201 may be changed to the point 3212 moved by a distance of 2 along the +y-axis direction.

Also, according to an embodiment, points corresponding to a plurality of variation distance candidates may be densely arranged at narrow intervals along an x-axis direction, but may be arranged at relatively wide intervals along a y-axis direction. In other words, a difference between a variation distance in an x-axis direction of one variation distance candidate and a variation distance in an x-axis direction of another variation distance candidate among a plurality of variation distance candidates and a difference between a variation distance in a y-axis direction of the one variation distance candidate and a variation distance in a y-axis direction of the other variation distance candidate may be different from each other.

Referring to FIGS. 31 and 32, the intervals between the points 3233, 3223, 3213, 3211, 3221, and 3231 arranged along the x-axis direction among the points corresponding to the plurality of variation distance candidates may be smaller than the intervals between the points 3232, 3222, 3212, 3214, 3224, and 3234 arranged along the y-axis direction. On the other hand, the intervals between the points 3232, 3222, 3212, 3214, 3224, and 3234 arranged along the y-axis direction among the points corresponding to the plurality of variation distance candidates may be smaller than the intervals between the points 3233, 3223, 3213, 3211, 3221, and 3231 arranged along the x-axis direction.

According to an embodiment, the motion information encoder 3710 may equally determine the plurality of variation distance candidates and the plurality of variation direction candidates for all pictures. According to an embodiment, the motion information encoder 3710 may newly determine the plurality of variation distance candidates and the plurality of variation direction candidates for each picture unit, slice unit, or block unit. In this case, the plurality of variation distance candidates and the plurality of variation direction candidates corresponding to the current block may be determined differently from the plurality of variation distance candidates and the plurality of variation direction candidates corresponding to the previous block.

The motion information encoder 3710 may determine the plurality of variation distance candidates and the plurality of variation direction candidates corresponding to the current picture, current slice, or current block, based on the statistics of the points largely selected from the previous blocks. According to an embodiment, when the points arranged along the x-axis direction are largely selected among the points corresponding to the plurality of variation distance candidates from the previous pictures, previous slices, or previous blocks, the motion information encoder 3710 may determine the plurality of variation distance candidates such that the points corresponding to the plurality of variation distance candidates are further densely arranged along the x-axis direction.

According to an embodiment, when it is determined that the refine process is performed on the current block, the motion information encoder 3710 may exclude some of variation distance candidates among the plurality of variation distance candidates corresponding to the current block and select the variation distance for changing the base motion vector among the remaining variation distance candidates.

According to an embodiment, an index is assigned correspondingly to each of the plurality of variation distance candidates, and the motion information encoder 3710 may assign a large value when the size of a variation distance candidate is large.

According to an embodiment, the motion information encoder 3710 may determine an index to be assigned to each of the plurality of variation distance candidates corresponding to the current picture, the current slice, or the current block, based on the statistics of the variation distance candidates selected from the previous blocks. According to an embodiment, an index of a smallest value in the current picture, the current slice, or the current block may be assigned for a variation distance candidate selected the most in the previous pictures, previous slices, or previous blocks.

According to an embodiment, information indicating a priority between the variation distance candidates for assigning an index to each of the plurality of variation distance candidates may be included in a bitstream.

According to an embodiment, an index may be assigned correspondingly to each of a plurality of variation direction candidates. According to an embodiment, the motion information encoder 3710 may determine an index to be assigned to each of the plurality of variation direction candidates corresponding to the current picture, the current slice, or the current block, based on the statistics of the variation direction candidates selected from the previous blocks. According to an embodiment, an index of a smallest value in the current picture, the current slice, or the current block may be assigned for the variation direction candidate selected the most in the previous pictures, previous slices, or previous blocks.

According to an embodiment, information indicating a priority between the variation direction candidates for assigning an index to each of the plurality of variation direction candidates may be included in a bitstream.

According to an embodiment, the generator 3730 may add information about a usage direction of the base motion vector of the current block to the bitstream. The information indicating the usage direction of the base motion vector, for example, an index, may correspond to a prediction information of the current block.

According to an embodiment, when the usage direction of the base motion vector is in a list 0 direction, uni-directional prediction in the list 0 direction may be performed on the current block and when the usage direction of the base motion vector is in a list 1 direction, uni-directional prediction in the list 1 direction may be performed on the current block. Also, when the usage direction of the base motion vector is in bi-direction, bi-directional prediction may be performed on the current bock.

For example, when the base motion vector is in the bi-direction, an index 0 indicates that the usage direction of the base motion vector is the bi-direction, an index 1 indicates that the usage direction of the base motion vector is the list 0 direction, and an index 2 indicates that the usage direction of the base motion vector is in the list 1 direction.

Also, for example, when the base motion vector is in a first uni-direction of the list 0 direction or the list 1 direction, the index 0 indicates that the usage direction of the base motion vector is the first uni-direction, the index 2 indicates that the usage direction of the base motion vector is in a second uni-direction different from the first uni-direction, and an index 3 indicates that the usage direction of the base motion vector is the bi-direction.

According to an embodiment, the motion information encoder 3710 may newly assign an index according to picture units, slice units, or block units for each usage direction of the base motion vector.

According to an embodiment, the motion information encoder 3710 may newly assign the index for each usage direction of the base motion vector from the current picture, the current slice, or the current block, based on statistics information of the usage direction of the base motion vector selected from the previous picture, the previous slice, or the previous block. According to an embodiment, the motion information encoder 3710 may assign an index of a smallest size in the current picture, the current slice, or the current block with respect to the usage direction of the base motion vector, which is mostly selected in the previous picture, the previous slice, or the previous block.

According to an embodiment, the image encoding apparatus 3700 may include the image decoding apparatus 2100, and in this case, the image encoding apparatus 3700 may consider the direction of the base motion vector and the usage direction of the base motion vector to reconstruct the current block. Because a method of determining the motion vector of the current block in consideration of the direction of the base motion vector and the usage direction of the base motion vector to construct the current block has been described above, detailed descriptions thereof will be omitted.

According to an embodiment, when a skip mode is applied to the current block, the image encoding apparatus 3700 may add, to the bitstream, the flag (mmvd_flag) indicating whether the pre-set mode according to the present disclosure is applied to the current block. Also, when it is determined that the pre-set mode is applied to the current block, mmvd_merge_idx, mmvd_distance_idx, and mmvd_direction_idx may be added to the bitstream. The mmvd_merge_idx is an index indicating a candidate to be used as a base motion vector of the current block among a merge candidate list. Also, the mmvd_distance_idx is an index indicating a variation distance and the mmvd_direction_idx is an index indicating a variation direction.

Also, according to an embodiment, when a merge mode is applied to the current block, the image encoding apparatus 3700 may add, to the bitstream, the flag (mmvd_flag) indicating whether the pre-set mode according to the present disclosure is applied to the current block. Also, when it is determined that the pre-set mode is applied to the current block, the mmvd_merge_idx, the mmvd_distance_idx, and the mmvd_direction_idx may be added to the bitstream.

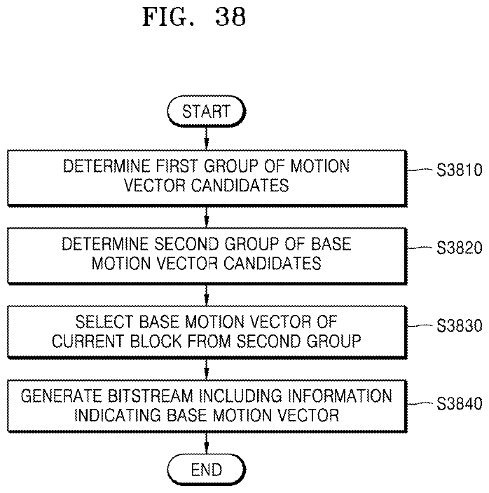

FIG. 38 is a flowchart of an image encoding method according to an embodiment.

In operation S3810, the image encoding apparatus 3700 determines a first group of motion vector candidates by using at least one motion vector among a spatial neighboring block and a temporal neighboring block related to a current block. According to an embodiment, the first group may correspond to a merge candidate list of a merge mode. Because the merge candidate list is used in the video standard such as HEVC, detailed descriptions thereof will be omitted.

In operation S3820, the image encoding apparatus 3700 determines a second group of base motion vector candidates according to a result of template matching or bilateral matching based on each motion vector candidate included in the first group.

According to an embodiment, the image encoding apparatus 3700 calculate a distortion value of each of the motion vector candidates included in the first group as the result of template matching or bilateral matching, and determine the second group including at least some motion vector candidates selected based on the distortion value among the motion vector candidates included in the first group.

According to an embodiment, the image encoding apparatus 3700 may change (or refine) each of the motion vector candidates included in the first group according to template matching or bilateral matching, and determine the second group including the changed motion vector candidates.

According to an embodiment, the image encoding apparatus 3700 may exclude a second base motion vector candidate from the second group when a difference between a first base motion vector candidate and the second base motion vector candidate among the base motion vector candidates included in the second group is equal to or less than a pre-set value.

In operation S3830, the image encoding apparatus 3700 selects a base motion vector of the current block from the second group. The image encoding apparatus 3700 may determine a variation distance and a variation direction for changing the base motion vector of the current block.

In operation S3840, the image encoding apparatus 3700 generates a bitstream including information indicating the base motion vector of the current block. The bitstream may include at least one of information indicating whether the pre-set mode is applied to the current block, information indicating the base motion vector of the current block, information indicating a usage direction of the base motion vector of the current block, information indicating whether a refine process is performed on the motion vector of the current block, information indicating the variation distance, information indicating the variation direction, information indicating a priority of base motion vector candidates, information indicating a priority of variation distance candidates, and information indicating a priority of variation direction candidates.

Meanwhile, the embodiments of the disclosure described above may be written as computer-executable programs that may be stored in a medium.

The medium may continuously store the computer-executable programs, or temporarily store the computer-executable programs or instructions for execution or downloading. Also, the medium may be any one of various recording media or storage media in which a single piece or plurality of pieces of hardware are combined, and the medium is not limited to a medium directly connected to a computer system, but may be distributed on a network. Examples of the medium include magnetic media, such as a hard disk, a floppy disk, and a magnetic tape, optical recording media, such as CD-ROM and DVD, magneto-optical media such as a floptical disk, and ROM, RAM, and a flash memory, which are configured to store program instructions. Other examples of the medium include recording media and storage media managed by application stores distributing applications or by websites, servers, and the like supplying or distributing other various types of software.

While one or more embodiments of the disclosure have been described with reference to the figures, it will be understood by those of ordinary skill in the art that various changes in form and details may be made therein without departing from the spirit and scope as defined by the following claims.

1. A method of decoding motion information, the method comprising:
determining a first group of motion vector candidates by using at least one motion vector among a spatial neighboring block and a temporal neighboring block related to a current block;
determining a second group of base motion vector candidates according to a result of template matching or bilateral matching based on each of the motion vector candidates included in the first group;
selecting a base motion vector corresponding to the current block from the second group; and
determining a motion vector of the current block by changing the base motion vector according to a variation distance and a variation direction.

2. The decoding method of claim 1, wherein the determining of the second group comprises:
calculating a distortion value of each of the motion vector candidates included in the first group, according to the result of template matching or bilateral matching; and
determining the second group including at least some of motion vector candidates selected based on the calculated distortion value among the motion vector candidates included in the first group.

3. The decoding method of claim 1, wherein the determining of the second group comprises determining the second group of the base motion vector candidates by changing each of the motion vector candidates included in the first group, according to the result of template matching or bilateral matching.

4. The decoding method of claim 1, further comprising, when a difference between a first base motion vector candidate and a second base motion vector candidate among the base motion vector candidates included in the second group is equal to or smaller than a pre-set value, excluding the second base motion vector candidate from the second group.

5. The decoding method of claim 1, further comprising:
changing the motion vector of the current block according to a result of template matching or bilateral matching; and
reconstructing the current block based on the changed motion vector of the current block.

6. The decoding method of claim 1, further comprising:
obtaining information indicating the variation distance and variation direction from a bitstream, and
determining the variation distance and variation direction for changing the base motion vector, based on the obtained information.

7. The decoding method of claim 6, wherein the determining of the variation distance and variation direction comprises determining a variation distance candidate and a variation direction candidate corresponding to the obtained information among a plurality of variation distance candidates and a plurality of variation direction candidates as the variation distance and the variation direction for changing the base motion vector.

8. The decoding method of claim 7, wherein the plurality of variation distance candidates and the plurality of variation direction candidates corresponding to the current block are determined differently from a plurality of variation distance candidates and a plurality of variation direction candidates corresponding to a previous block.

9. The decoding method of claim 7, wherein variation distances of at least one variation distance candidate in an x-axis direction and y-axis direction among the plurality of variation distance candidates are different from each other.

10. The decoding method of claim 9, wherein, among the plurality of variation distance candidates, an interval between a variation distance of a first variation distance candidate in an x-axis direction and a variation distance of a second variation distance candidate in an x-axis direction and an interval between a variation distance of the first variation distance candidate in a y-axis direction and a variation distance of the second variation distance candidate in a y-axis direction are different from each other.

11. The decoding method of claim 7, wherein the determining of the variation distance and variation direction comprises:
determining whether to change the motion vector of the current block;
when it is determined to change the motion vector of the current block, excluding at least some of variation distance candidates among the plurality of variation distance candidates; and
determining a variation distance candidate and a variation direction candidate corresponding to the obtained information among remaining variation distance candidates as the variation distance and the variation direction for changing the base motion vector.

12. The decoding method of claim 1, wherein the determining of the motion vector of the current block comprises:
obtaining information about a prediction direction of the current block;
when the prediction direction indicates bi-direction, changing one of a base motion vector in a first uni-direction and a base motion vector in a second uni-direction according to the variation distance and the variation direction; and
determining the motion vector of the current block, based on a base motion vector changed according to the variation distance and variation direction, and a base motion vector not changed according to the variation distance and variation direction.

13. The decoding method of claim 12, further comprising, when the base motion vector of the current block is the base motion vector in the first uni-direction, determining the base motion vector in the second uni-direction based on the base motion vector of the first uni-direction.

14. An apparatus for decoding motion information, the apparatus comprising a motion information decoder configured to:
determine a first group of motion vector candidates by using at least one motion vector among a spatial neighboring block and a temporal neighboring block related to a current block;
determine a second group of base motion vector candidates according to a result of template matching or bilateral matching based on each of the motion vector candidates included in the first group;
select a base motion vector corresponding to the current block from the second group; and
determine a motion vector of the current block by changing the base motion vector according to a variation distance and a variation direction.

15. A method of encoding motion information, the method comprising:
determining a first group of motion vector candidates by using at least one motion vector among a spatial neighboring block and a temporal neighboring block related to a current block;
determining a second group of base motion vector candidates according to a result of template matching or bilateral matching based on each of the motion vector candidates included in the first group;
selecting a base motion vector corresponding to the current block from the second group; and
generating a bitstream including information indicating the selected base motion vector and information indicating a variation distance and a variation direction for changing the base motion vector.
